(19) United States
(12) Patent Application Publication
(10) Pub. No.: US 2025/0334979 A1
(43) Pub. Date: Oct. 30, 2025

(54) SYSTEM AND METHOD FOR PRIORITY BASED MANAGEMENT OF AUTONOMOUS VEHICLE FLEET

(71) Applicant: Symbotic LLC, Wilmington, MA (US)

(72) Inventor: Jingkai CHEN, Wilmington, MA (US)

(21) Appl. No.: 19/172,078

(22) Filed: Apr. 7, 2025

Related U.S. Application Data
(60) Provisional application No. 63/631,176, filed on Apr. 8, 2024.

(51) Int. Cl. G05D 1/698; B65G 1/04; G05D 101/00; G05D 107/70; G06Q 10/08

(52) U.S. Cl. CPC G05D 1/6987; B65G 1/0492; G06Q 10/08; G05D 2101/22; G05D 2107/70

(57) ABSTRACT

An automated storage and retrieval system includes a storage array, a plurality of bots, and a controller. The controller is connected to each bot to assign a series of tasks, or goals, to each bot. The controller has a bot route planner that has a multi-agent path finding algorithm resolver that determines, for each bot route effecting at least one task, or goal, occurrence and type of a conflict between bots performing the series of tasks, or goals. From the determination of occurrence and type of conflict, the multi-agent path finding algorithm resolver resolves each conflict free bot route, that determines the bot route respectively for each bot performing the at least one task, or goal, based on bot priority and precedence constraint between route legs describing, at least in part, the respective bot route of a common bot performing the at least one task, or goal.

### CROSS-REFERENCE TO RELATED APPLICATION(S)

This application is a non-provisional of and claims the benefit of U.S. Provisional Patent Application No. 63/631,176 filed on Apr. 8, 2024, the disclosure of which is incorporated herein by reference in its entirety.

### BACKGROUND

### 1. Field

The exemplary embodiments generally relate to material handling systems, and more particularly, to transport of items within the material handling system.

### 2. Brief Description of Related Developments

Generally multi-agent pathfinding (MAPF) is employed in automated systems, such as logistics facilities and warehouses, to determine collision-free paths for groups of autonomous transport vehicles (i.e., agents) that transport items within the automated system. One example of multi-agent pathfinding is the prioritized planning (PP) technique where fixed priorities of planning goals are found and then plans for the autonomous transport vehicles are generated given these priorities. Another example, of multi-agent pathfinding is the priority-based search (PBS) technique, which does not assume a fixed priority. Rather, priority-based search specifies priorities only on demand. An extension of priority-based search, referred to as the priority-based search with precedence constraint (PBS-PC) technique, may be employed to handle cases where each autonomous transport vehicle has a sequence of goals (i.e., route legs). In the priority-based search techniques (PBS and PBS-PC), the priorities are specified automatically and systematically to resolve planning conflicts and optimize routing performance. However, the priority-based search techniques are centralized multi-agent processes having runtimes that are dominated by the number of conflicts between agents to resolve. In practice, the runtime of the process increases cubically as the number of conflicts to resolve increases. In practice, the number of conflicts to resolve can rapidly increase when the number of tasked autonomous transport vehicles increases or autonomous transport vehicle traffic within the automated system becomes severe (i.e., several autonomous transport vehicles are tasked to travel to or within a common/same region of the logistics facility or warehouse).

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is an exemplary block diagram of an automated storage and retrieval system in accordance with the present disclosure;

FIG. 1A is an exemplary schematic illustration of a portion of the automated storage and retrieval system of FIG. 1 in accordance with the present disclosure;

FIG. 1B is an exemplary schematic illustration of a portion of the automated storage and retrieval system of FIG. 1 in accordance with the present disclosure;

FIG. 1C is an exemplary schematic illustration of a portion of the automated storage and retrieval system of FIG. 1 in accordance with the present disclosure;

FIG. 1D is an exemplary schematic illustration of a goods processed by the automated storage and retrieval system of FIG. 1 in accordance with the present disclosure;

FIG. 2A is an exemplary schematic illustration of a portion of the automated storage and retrieval system of FIG. 1 in accordance with the present disclosure;

FIG. 2B is an exemplary schematic illustration of a portion of the automated storage and retrieval system of FIG. 1 in accordance with the present disclosure;

FIG. 2C is an exemplary schematic illustration of a portion of the automated storage and retrieval system of FIG. 1 in accordance with the present disclosure;

FIG. 2D is an exemplary schematic illustration of a portion of the automated storage and retrieval system of FIG. 1 in accordance with the present disclosure;

FIG. 3 is an exemplary schematic illustration of an autonomous guided bot of the automated storage and retrieval system of FIG. 1 in accordance with the present disclosure;

FIG. 4 is an exemplary schematic illustration of a portion of the automated storage and retrieval system of FIG. 1 in accordance with the present disclosure;

FIG. 4A is an exemplary schematic illustration of portions of trajectories of an autonomous guided bot of the automated storage and retrieval system of FIG. 1 in accordance with the present disclosure;

FIG. 5A illustrates convention autonomous guided bot routes;

FIG. 5B illustrates autonomous guided bot routes of the automated storage and retrieval system of FIG. 1 in accordance with the present disclosure;

FIG. 6 is an exemplary flow diagram in accordance with the present disclosure;

FIG. 7 is a schematic illustrate of an example of route planning in accordance with the present disclosure;

FIG. 8 is a schematic illustrate of an example of route planning in accordance with the present disclosure;

FIGS. 9A and 9B are schematic exemplary illustrations of route planning dead-end checking in accordance with the present disclosure;

FIGS. 10A and 10B are schematic exemplary illustrations of route planning deadlock breaking in accordance with the present disclosure;

FIG. 11 is a schematic illustrate of an example of route planning in accordance with the present disclosure;

FIG. 12 is a schematic illustrate of an example of route planning in accordance with the present disclosure;

FIG. 13 is a schematic illustrate of an example of route planning in accordance with the present disclosure;

FIG. 14 is a schematic illustrate of an example of route planning in accordance with the present disclosure;

FIG. 15 is an exemplary schematic illustration of adaptive time padding for route planning in accordance with the present disclosure;

FIG. 16 is a schematic illustrate of an example of route planning in accordance with the present disclosure;

FIG. 17 is an exemplary schematic illustration of an occupancy determination of route planning in accordance with the present disclosure;

FIGS. 18A and 18B are respectively exemplary schematic illustrations of an occupancy determination and conflict determination of route planning in accordance with the present disclosure;

FIG. 19 is an exemplary flow diagram in accordance with the present disclosure;

FIG. 20 is an exemplary flow diagram in accordance with the present disclosure;

FIG. 21 is an exemplary flow diagram in accordance with aspects of the present disclosure;

FIGS. 22A and 22B are exemplary illustrations of risk-aware routing in accordance with the present disclosure; and

FIG. 23 is an exemplary block diagram of heuristic evaluation for priority decisions in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

The terms “top,” “bottom,” “upper,” “lower,” “front,” “back,” “vertical,” and “horizontal” as may be used herein are by way of example and illustration only are not meant to limit the description and may be exchanged in position and orientation.

The terms “substantially” and “about” as may be used herein refer to a feature that may be varied within an acceptable manufacturing tolerance for a given application.

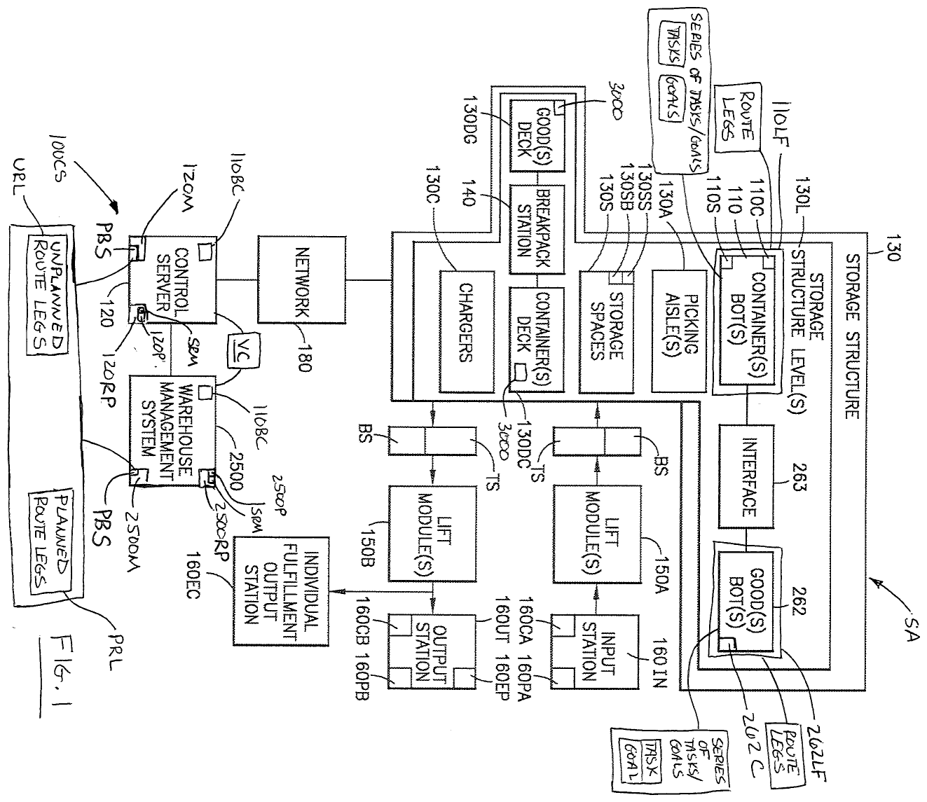

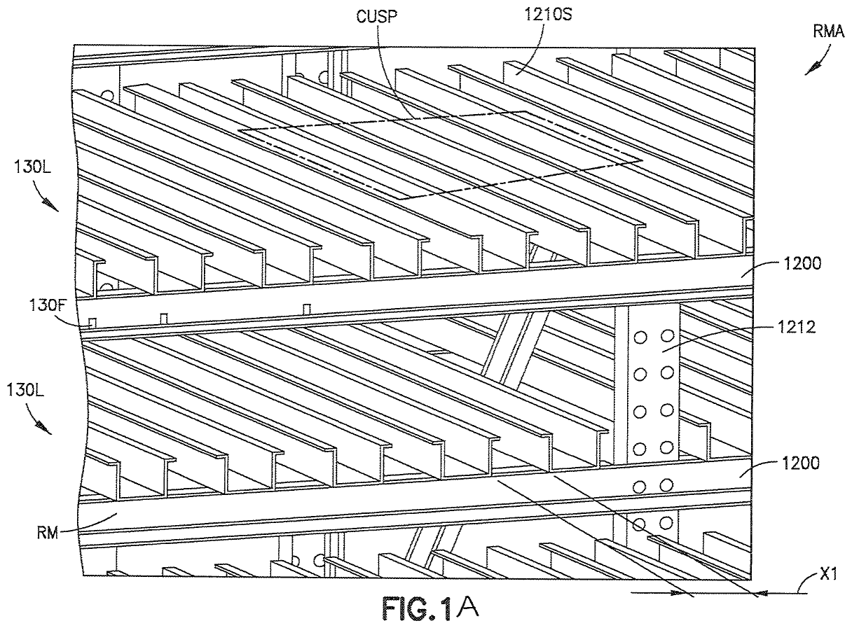

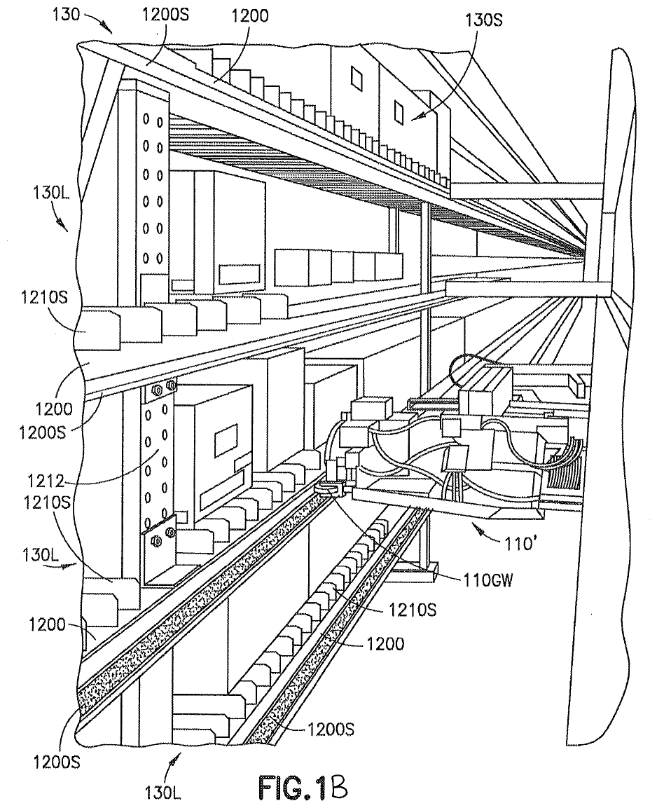

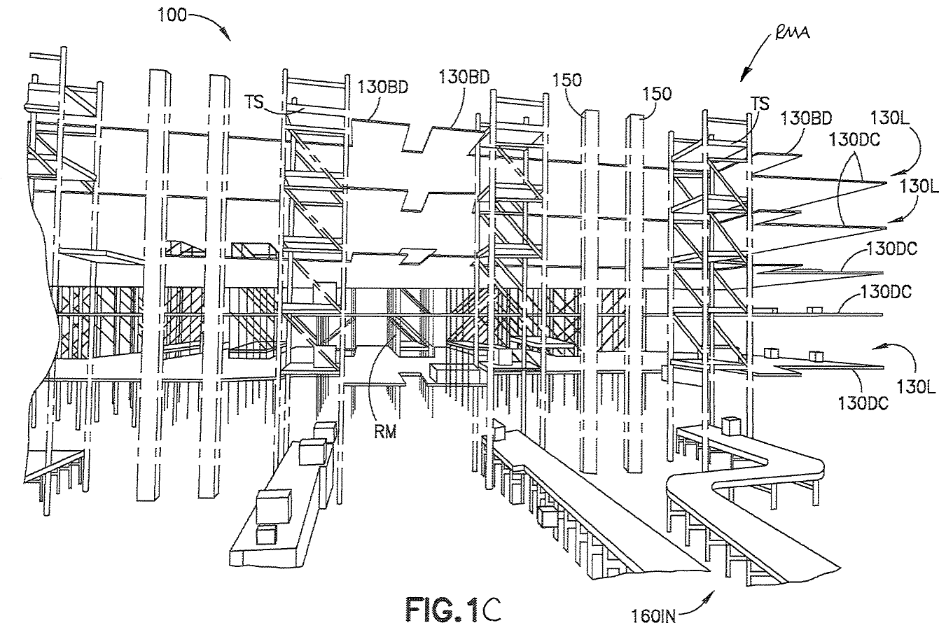

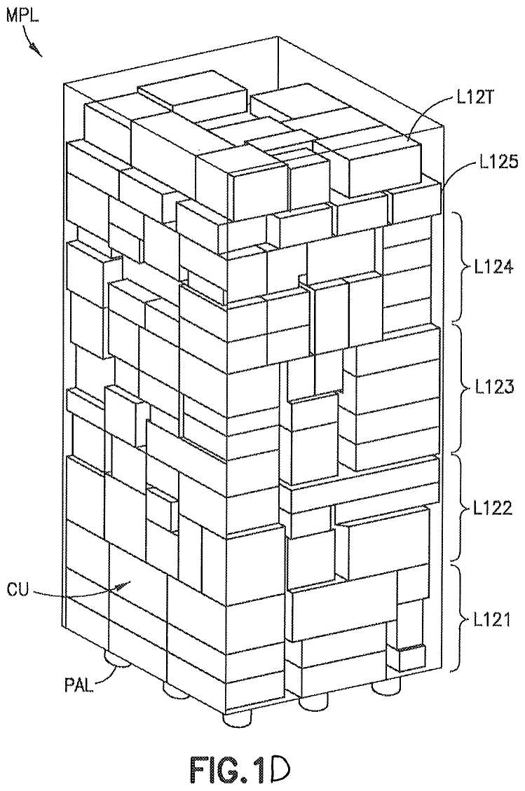

FIG. 1 illustrates an exemplary automated storage and retrieval system 100, such as of a logistics facility or warehouse, in accordance with the present disclosure. Although the present disclosure will be described with reference to the drawings, it should be understood that the present disclosure can be embodied in many forms. In addition, any suitable size, shape or type of elements or materials could be used.

The present disclosure provides for the automated storage and retrieval system 100 including a storage array SA with storage locations 130S arrayed along aisles 130A and a static (i.e., non-moving) non-deterministic (container) transfer deck or floor 130DC (collectively referred to herein for convenience as container transfer deck 130DC or transfer deck 130DC) communicating with each aisle 130A. The storage array SA includes one or more of the storage array features described herein.

As also described herein, the storage locations may form breakpack goods interface locations 263L disposed along aisles formed on or in communication with a static (i.e., non-moving) non-deterministic (goods) transfer deck or floor 130DG (collectively referred to herein for convenience as goods transfer deck 130DG or transfer deck 130DG). The storage locations formed by the breakpack goods interface locations 263L may form a part of the storage array SA or be considered another storage array BSA (with respect to path planning of autonomous guided goods bots 262) of the automated storage and retrieval system 100 to which the present disclosure is applied independent of path planning of autonomous guided container bots 110 although, path planning of the autonomous guided goods bots 262 and autonomous guided container bots 110 may be performed in conjunction with each other.

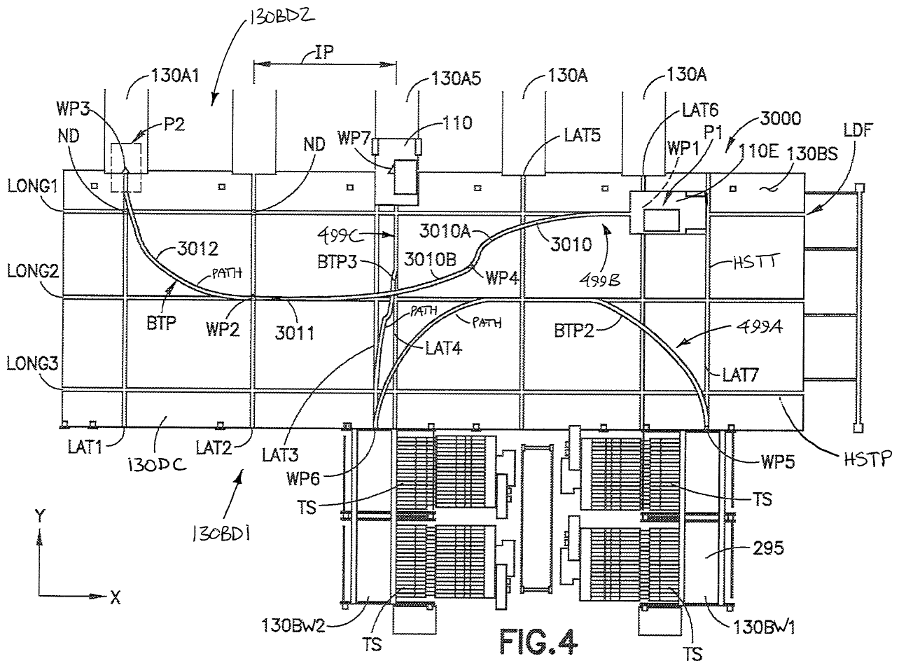

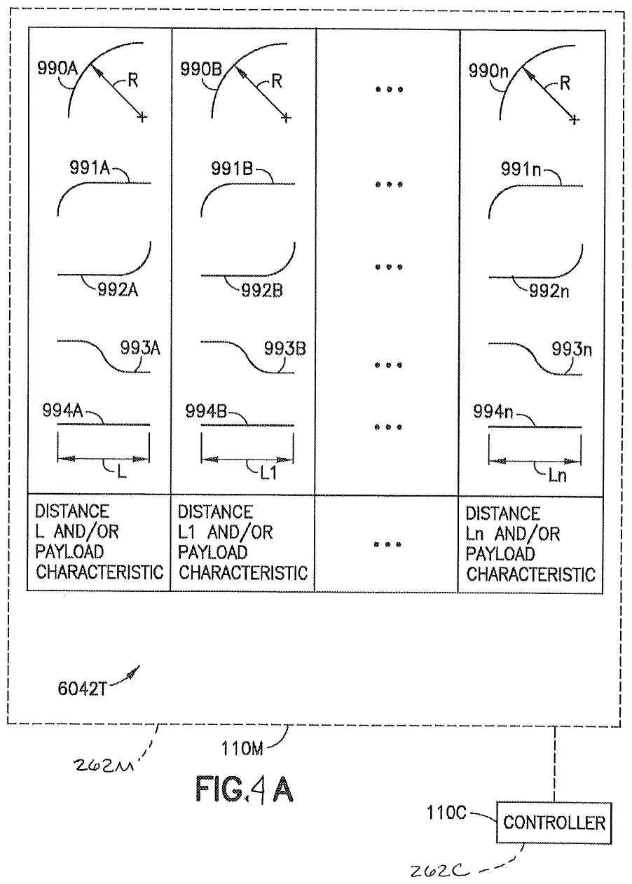

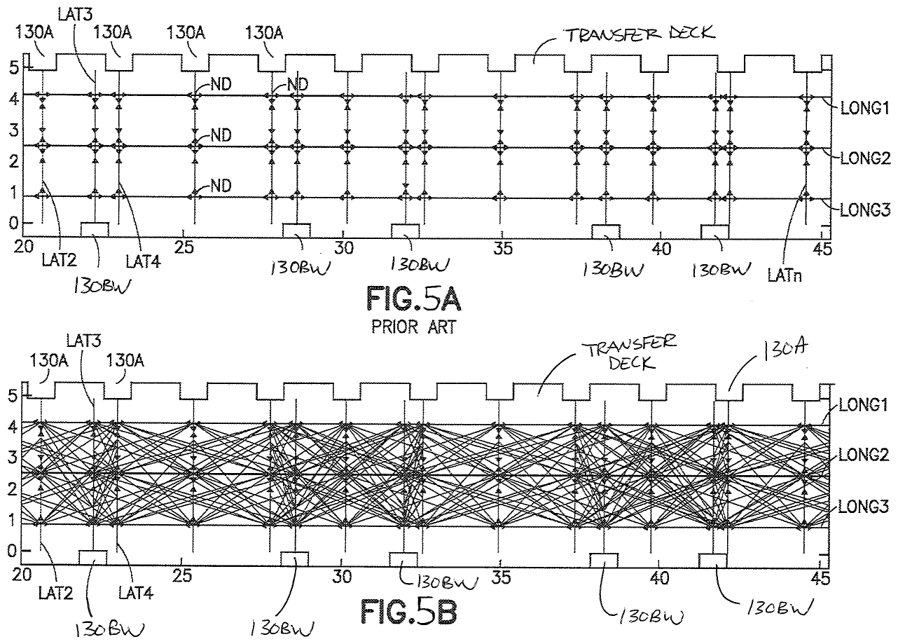

The automated storage and retrieval system 100 includes a plurality of autonomous guided bots or vehicles (e.g., one or more of a plurality of autonomous guided container bots 110 and a plurality of autonomous guided goods bots 262, also referred to herein as bots for convenience), each configured for free ranging motion so as to traverse freely along bot paths (e.g., BPT-BPT3, see FIGS. 4 and 5B, as described herein). The bot paths including time optimal unparameterized paths, on the non-deterministic deck (e.g., a respective one or more of the container transport deck 130DC and the breakpack goods deck 130DG) so that, in the case of the autonomous guided container bots 110, each autonomous guided container bot 110 accesses each storage location 130S in each aisle (such as one or more of a picking aisle 130A and driveway 130BW) from each location on the container transport deck 130DC and aisles. As may be realized, in the case of the autonomous guided goods bots 262, each autonomous guided goods bot 262 accesses each breakpack goods holding location (e.g., such as one or more of a breakpack station 140 and a breakpack goods interface 263) from each location on the breakpack goods deck 130DG.

The automated storage and retrieval system 100 includes a controller (such as one or more of control server 120 and warehouse management system 2500 or other suitable controller) that is communicably connected to each autonomous guided bot of the plurality of autonomous guided bots (e.g., one or more of the plurality of autonomous guided container bots 110 and autonomous guided goods bots 262) so as to assign a series of tasks, or goals, to each autonomous guided bot 110, 262. The series of tasks, or goals, includes at least one task, or goal, to at least one autonomous guided bot 110, 262 moving the autonomous guided bot 110, 262 from an initial location to a different final location via bot routes 499A-499C describing bot paths BPT-BPT3 (see FIG. 4). It is noted that as used herein a “task” or “goal” is a final pose of an autonomous guided bot 110, 262 at a destination or terminus of a route effecting the corresponding task or goal, where the terms “task” and “goal” may be used interchangeably herein. A “goal” may denote or mean a destination/terminus position, location and time thereof of a given autonomous guided botᵢ (g^{j},t^{j}); where g is goal and t is time. A task may denote or mean an autonomous guided bot function (to be carried out by the autonomous guided bot) at the goal, e.g. pick, place, or idle (pick and place may also be represented as idle), and/or dwell or park of the autonomous guided bot 110, 262 at a goal. Thus, task and goal with respect to autonomous guided bot routing and path planning may be interchanged. It is also noted that the task or goal may be located in a picking aisle 130A, in an extension portion or pier 130BW (also referred to as a driveway), on the transfer deck 130DC, 130DG, or at any other suitable location of the storage array or structure 130 on or along which an autonomous guided bot 110, 262 may traverse.

As described herein, the controller 120, 2500 is configured with a bot route planner 120RP, 2500RP that has a multi-agent path finding algorithm resolver 120P, 2500P. The multi-agent path finding algorithm resolver 120P, 2500P determines, for each bot route effecting the at least one task, occurrence and type of a conflict between autonomous guided bots 110, 262 performing the series of tasks, or goals (e.g., where the at least one task may be effected by the bot route in its entirety or in whole). The multi-agent path finding algorithm resolver 120P, 2500P, from the determination of occurrence and type of conflict, resolves each conflict free bot route that determines the bot route respectively for each autonomous guided bot 110, 262 performing the at least one task, or goal, and the conflict free bot route is based on bot priority and precedence constraint between route legs describing, at least in part, the respective bot route of a common autonomous guided bot 110, 262 performing the at least one task, or goal.

As described herein, the multi-agent path finding algorithm resolver 120P is configured to resolve that the bot route is conflict free via (e.g., by employing) a heuristic determination (sec, for example, FIG. 6 and the component parts (sec, e.g., FIGS. 7-20) thereof as described herein) that each bot route leg, describing the bot route, is conflict free. The multi-agent path finding algorithm resolver 120P effects the heuristic determination through application of priority conditions and precedence constraints between conflicting autonomous guided bots 110, 262, as described herein. As noted herein, the multi-agent path finding algorithm resolver 120P resolves the conflict free bot route and is configured to one or more of: identify the solution is a complete solution with determination that each bot route leg describing the bot route in entirety is conflict free; and identify the solution is a partial solution with determination that at least one bot route leg, describing the bot route at least in part, is conflict free, and that each leg of the at least one conflict free leg, describing the at least part of the bot route, is in sequentially successive order from the initial location, and each preceding leg has precedence over the sequentially successive leg.

In accordance with the present disclosure, a bot routing problem may be defined as: (M, B, R). Here, M is a map that models the “world” structure (e.g., the “world” being at least a portion of the storage and retrieval system 100, such as one or more level 130L of a storage structure 130 of the storage and retrieval system 100, an entirety of the storage structure 130, a goods deck 130DG, a container deck 130DC, or any other suitable portion(s) of the storage and retrieval system 100). B is a set of autonomous guided bots {b₁, b₂, b₃, . . . , bₙ) with size N, and each autonomous guided bot b ε B has a start pose s ε R³, where the bot dynamic model and bot geometry shape are given as well. R is a set of goals (i.e., route legs), and each route leg r ε R is a tuple (b, i, s, g, d, α), where: b is the autonomous guided bot 110, 262 that is assigned to execute this route leg; i is an index that represents this route leg as the i^{th} route leg of the autonomous guided bot 110, 262; s ε R³ is the source pose; g ε R³ is the destination pose; dε R²⁴ is the dwell duration representing the time estimation of this autonomous guided bot's 110, 262 operation at the destination; and α ε {0, 1} represents whether he route leg is active (i.e., 1) or non-active (i.e., 0).

With reference to FIGS. 1 and 6, the present disclosure provides for a solution to the above route planning problem of the bot routes 499A-499C. In the present disclosure, a sequence of time stamped trajectories of all the non-active route legs of the bot routes 499A-499C is employed. Each trajectory is a sequence of time-stamped waypoints ((t₁, p₁), (t₂, p₂), . . . ), respecting its bot dynamic model and an environmental model. The bot trajectories generated in accordance with the present disclosure are collision-free trajectories.

To generate the bot routes 499A-499C a controller 120, 2500 of the storage and retrieval system is configured with (e.g., includes non-transitory computer program code that when executed by the controller causes the controller to perform the aspects of the present disclosure described herein) the bot route planner 120RP, 2500RP that has the multi-agent path finding algorithm resolver 120P, 2500P. The multi-agent path finding algorithm resolver 120P, 2500P may employ a priority-based search function PBS (e.g., resident in a memory 120M, 2500M of the controller 120, 2500 or any other suitable location accessible by the multi-agent path finding algorithm resolver 120P, 2500P) and is configured to heuristically determine the bot routes.

In the heuristic determination controller 120, 2500 seeks (e.g., in what may be a best fit search) the earliest conflict between conflicting route legs of at least one autonomous guided bot 110, 262 with another autonomous guided bot 110, 262, as described herein. The heuristic determination resolves post-goal conflicts, such as dead end conflicts, between at least one autonomous guided bot 110, 262, that has a terminus or goal of the bot route later than another bot, and at least one route leg of the another autonomous guided bot 110, 262 (e.g., having another task different than the at least one task of the least one autonomous guided bot 110, 262 that has the terminus or goal of the bout route later than the another autonomous guided bot 110, 262). The at least one autonomous guided bot 110, 262 that has the terminus or goal of the bot route later than the another autonomous guided bot 110, 262, forms a dead-end in an aisle 130A or driveway 130BW of the storage array SA, and the resolved bot route of the complete solution for the at least one autonomous guided bot 110, 262 is dead-end free.

It is noted the dead end conflict may include the at least one autonomous guided bot 110, 262 being posed and maintained for a sustained period at the terminus or goal of the bot route, where the sustained period encompasses the at least one bot 110, 262 performing at least one task and dwelling (or parking) there thereafter so that the dwelling bot 110, 262 forms a dead-end in the aisle 130A or driveway 130BW (where the post goal conflict determination is a dead-end type conflict check; parking is for an unknown time exceeding a planning period of the determination).

The heuristic determination one or more of: resolves bot idling conflict between at least one bot 110, 262 idling (for a predetermined time), in a pose intervening between the at least one task and an immediately sequential task in a series of tasks, and at least one route leg of another bot 110, 262 (e.g., having another task different than the at least one task and the immediately sequential task); and resolves a bot idling conflict between at least one bot 110, 262 idling (for a predetermined time), in a pose intervening between at least one conflict free leg of a (partially resolved) bot route and an immediately succeeding leg of the bot route, and at least one route leg of another bot 110, 262 (e.g., having another task different than the at least one task and the immediately sequential task).

As an example, the heuristic determination of route legs starts from a root search node (FIG. 6, Block 600) and repeatedly adding priority relations and updating planning results to generate child search nodes (FIG. 6, Block 610), until a valid solution is found. A search node includes a set of priorities (the set of priorities being a time current up-to-date set of priorities), and planning results such as the planned trajectories of a subset of route legs are also stored (or otherwise embodied) in each search node. In a root search node, the initial priorities are: active route legs have higher priorities than non-active route legs, and for each autonomous guided bot 110, 262, its previous route legs have a higher priority than subsequent route legs.

The multi-agent path finding algorithm resolver 120P, 2500P is configured to repeat the following (which will be described in greater detail herein) until a valid plan is found, or all solution candidates have been explored:

Plan each route leg individually until a conflict is detected. The route leg whose previous same-bot route leg has been planned and finishes earlier is planned first. Note, at this stage of route planning, the planned route legs PRL do not have priority relations with non-active route legs and are only concerned with avoiding active route legs;

Where all conflicts are resolved (FIG. 6, Block 605) and all route legs have not been planned (FIG. 6, Block 615) the multi-agent path finding algorithm resolver 120P, 2500P of the controller 120, 2500 plans a route leg (FIG. 6, Block 625) and checks for conflicts between route legs (FIG. 6, Block 630) in a loop as illustrated in FIG. 6 until all route legs are planned or a conflict exists;

Where all conflicts are resolved (FIG. 6, Block 605) and all route legs have been planned (FIG. 6, Block 615), a solution for route planning is returned (FIG. 6, Block 620) and the controller 120, 2500 executes the solution effecting bot traverse within the storage and retrieval system 100;

Where all conflicts are not resolved (FIG. 6, Block 605), the multi-agent path finding algorithm resolver 120P, 2500P of the controller 120, 2500 finds the earliest conflict between two route legs (such as route legs A, B) and generates two children (e.g., child nodes) that inherit all priorities of its parent node but specifies different priorities between route legs A, B. The route legs A, B are replanned, and conflict checking is performed (FIG. 6, Block 610);

If there is at least one feasible child node (FIG. 6, Block 640), the multi-agent path finding algorithm resolver 120P, 2500P of the controller 120, 2500 selects the best node(s), e.g., given their successfully and partially planned solutions (FIG. 6, Block 602), to evaluate (e.g., search forward for conflicts-as illustrated in FIG. 6);

If there are no feasible child nodes (both child nodes have failed legs-FIG. 6, Block 640), the multi-agent path finding algorithm resolver 120P, 2500P of the controller 120, 2500 performs deadlock breaking as described herein, where two child nodes are generated, route legs are replanned, and conflict checking is performed (FIG. 6, Block 611). If there is at least one feasible child node (FIG. 6, Block 641), the multi-agent path finding algorithm resolver 120P, 2500P of the controller 120, 2500 selects the best node(s), e.g., given their successfully and partially planned solutions (FIG. 6, Block 602), to evaluate (e.g., search forward for conflicts—as illustrated in FIG. 6.

If there are no feasible child nodes (both child nodes have failed legs—FIG. 6, Block 641) after the generation and evaluation of the second set of child nodes (FIG. 6, Block 211), the multi-agent path finding algorithm resolver 120P, 2500P of the controller 120, 2500 determines if a restart of the path planning can resolve the failed route legs (FIG. 6, Block 645). If a restart will not resolve the failed route legs, the multi-agent path finding algorithm resolver 120P, 2500P chooses/selects the current node (FIG. 6, Block 603) to evaluate (e.g., search forward for conflicts—as illustrated in FIG. 6). Where a restart of the path planning will resolve the failed route legs, the multi-agent path finding algorithm resolver 120P, 2500P constructs a new root node (FIG. 6, Block 613) to evaluate (e.g., search forward for conflicts—as illustrated in FIG. 6). In the restart, the multi-agent path finding algorithm resolver 120P, 2500P forces a subset of failed route legs to have high priorities (e.g., higher than the previous priorities of the failed route legs) as described herein.

As will be described herein, the bot route planner 120RP, 2500RP may include one or more of adaptive time paddings for trajectory occupancy calculations and a startup occupancy. The adaptive time paddings for trajectory occupancy calculations determine when and where an autonomous guided bot 110, 262 is while considering execution delays and communication latencies. The startup occupancy may mitigate side effects of using box over-approximation to calculate the occupied regions of the autonomous guided bots 110, 262.

The present disclosure provides for, with the controller (e.g., such as one or more of controller 120 and warehouse management system 2500 including a respective bot route planner 120RP, 2500RP, which may form part of a control system 100CS), autonomous transport vehicle travel path planning in the automated storage and retrieval system 100 having one or more fleet 110LF, 262LF of autonomous guided bots (such as autonomous guided container transport vehicles or container bots 110 and/or autonomous goods transport vehicles or autonomous guided goods bots 262 which are collectively and generally referred to herein as autonomous guided bots 110, 262).

Each fleet 110LF, 262LF of autonomous guided bots 110, 262 includes about forty autonomous guided bots 110, 262 per storage level (e.g., about forty autonomous guided bots 110 on each containers deck 130DC and about forty autonomous guided bots 262 on each goods deck 130DG) although, there may be more or less than the about forty autonomous guided bots 110 on each level of containers deck 130DC and more or less than the about forty autonomous guided bots 262 on each goods deck 130DG. While the present disclosure is described herein with respect to non-holonomic autonomous guided bots 110, 262 (as described herein), the present disclosure is equally applicable with respect to holonomic autonomous transport vehicles or bots such as those produced by Boston Dynamics Inc. of Waltham, Massachusetts (United States) (sec, e.g., U.S. Pat. No. 10,265,871 issued on Apr. 23, 2019 and U.S. patent application Ser. No. 17/699,534 filed on Mar. 21, 2022); and those produced by Amazon Technologies Inc. (see, e.g., U.S. Pat. No. 11,643,279 issued on May 9, 2023).

The automated storage and retrieval system 100 has a control system 100CS that includes one or more of the control server 120 (also referred to as a controller) and the warehouse management system 2500. The control system 100CS is configured (i.e., the one or more of the control server 120 and warehouse management system 2500 resolver 120P, 2500P is configured) with non-transitory computer program code that embodies the bot route planner 120RP, 2500RP that has the multi-agent path finding algorithm resolver 120P, 2500P. As noted above, the multi-agent path finding algorithm resolver 120P, 2500P may employ the priority-based search function PBS that is resident in a memory of the control system 100CS, such as one or more of memory 120M of control server 120 and memory 2500M of the warehouse management system 2500. When the priority-based search function PBS is executed by the multi-agent path finding algorithm resolver 120P, 2500P, the priority-based search function PBS causes one or more autonomous transport vehicles 110, 262 of the automated storage and retrieval system 100 to operate as described herein.

The multi-agent path finding algorithm resolver 120P, 2500P employing the priority-based search function PBS configures the controller, such as one or more of control server 120 and warehouse management system 2500, of the automated storage and retrieval system 1000 so that the controller 120, 2500 plans travel paths (which as described herein may be straight paths, arcuate paths, compound paths forming shapes such as “S” shape curves, or any other combination of straight and arcuate paths-sec FIGS. 4-5B) of the autonomous transport vehicles 110, 262 of the respective fleet 110LF, 262LF (each fleet having about forty bots) within several hundred milliseconds, and particularly within about two hundred milliseconds, and more particularly about 100 milliseconds or less than about 100 milliseconds. As may be realized, the autonomous transport vehicles 110, 262 of each fleet 110LF, 262LF may be isolated from each other so that each fleet 110LF, 262LF is separate and distinct from each other fleet 110LF, 262LF. The fleets 110LF, 262LF operate in separate and distinct areas of the automated storage and retrieval system 100 such that the paths and trajectories of route legs for autonomous container transport vehicles 110 of fleet 110LF do not interfere with the paths and trajectories of route legs of the autonomous goods transport vehicles 262 of fleet 262LF. Here, path planning as described herein may be performed for each of fleets 110LF, 262LF independent of path planning for each other fleet 110LF, 262LF.

Referring again to FIG. 1, for each fleet 110LF, 262LF, the controller 120, 2500 is configured to obtain or otherwise collect unplanned route legs URL from any suitable source such as from one or more vehicle controller VC, where the one or more vehicle controller VC issue(s) at least movement commands to the autonomous transport vehicles 110, 262 of the automated storage and retrieval system 100. The one or more vehicle controller VC may be a part of one or more of the controller 120, warehouse management system 2500, or otherwise disposed so as to be accessible to the one or more the controller 120 and warehouse management system 2500. The vehicle controller VC may be a controller 110C, 262C of an autonomous transport vehicle 110, 262, where the controller 110C, 262C generates the route legs in a manner substantially similar to that described in U.S. Pat. No. 11,760,570 issued on Sep. 19, 2023, the disclosure of which is incorporated herein by reference in its entirety. The unplanned route legs URL may be stored in memory 120M, 2500M or any other suitable location accessible by the control system 100CS (the unplanned route legs may be read by the control system 100CS directly from the one or more vehicle controller VC without storage in memory 120M, 2500M). The unplanned route legs URL are analyzed by the bot route planner 120RP, 2500RP as described herein to generate planned route legs PRL for effecting autonomous guided bot 110, 262 traverse within the storage structure 130.

Still referring to FIG. 1, in accordance with the present disclosure the automated storage and retrieval system 100 may operate in a retail distribution center, warehouse, or the back of a retail store. The automated storage and retrieval system 100 may operate to, for example, fulfill orders received from retail stores for case units such as those described in U.S. Pat. No. 10,822,168 issued on Nov. 3, 2020 and U.S. patent application Ser. No. 17/358,383 filed on Jun. 25, 2021, the disclosures of which are incorporated by reference herein in their entireties. For example, the case units are cases or units of goods not stored in trays, on totes or on pallets (e.g. uncontained). In other examples, the case units are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. In accordance with the present disclosure, shipping cases for case units (e.g. cartons, barrels, boxes, crates, jugs, or any other suitable device for holding case units) may have variable sizes and may be used to hold case units in shipping and may be configured so they are capable of being palletized for shipping or sent to a downstream logistics process (e.g., such as goods to person automation) without being palletized. The case units may be segmented case units that include multiple order profiles in one case unit (e.g., such as a segmented tote). Here, the segmented case unit may increase the product density within the case unit and any downstream logistics (e.g., downstream packaging solution such as the goods to person automation). It is noted that when, for example, bundles or pallets of case units arrive at the storage and retrieval system the content of each pallet may be uniform (e.g. each pallet holds a predetermined number of the same item-one pallet holds soup and another pallet holds cereal) and as pallets leave the storage and retrieval system the pallets may contain any suitable number and combination of different case units (e.g. a mixed pallet where each mixed pallet holds different types of case units-a pallet holds a combination of soup and cereal) that are provided to, for example the palletizer in a sorted arrangement for forming the mixed pallet. In the present disclosure the storage and retrieval system 100 described herein may be applied to any environment in which case units are stored and retrieved.

Also referring to FIG. 1D, it is noted that when, for example, incoming bundles or pallets (e.g. from manufacturers or suppliers of case units arrive at the storage and retrieval system for replenishment of the automated storage and retrieval system 100, the content of each pallet may be uniform (e.g. each pallet holds a predetermined number of the same item-one pallet holds soup and another pallet holds cereal). As may be realized, the cases of such pallet load may be substantially similar or in other words, homogenous cases (e.g. similar dimensions), and may have the same SKU (otherwise, as noted before the pallets may be “rainbow” pallets having layers formed of homogeneous cases). As pallets PAL leave the storage and retrieval system 100, with cases filling replenishment orders, the pallets PAL may contain any suitable number and combination of different case units CU (e.g., each pallet may hold different types of case units—a pallet holds a combination of canned soup, cereal, beverage packs, cosmetics and household cleaners). The cases combined onto a single pallet may have different dimensions and/or different SKU's. In the present disclosure, the storage and retrieval system 100 may be configured to generally include an in-feed section, a storage and sortation section (where, storage of items is/may be optional) and an output section as will be described in greater detail below. In the present disclosure, the system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and assemble the corresponding groups of cases into what may be referred to as mixed case pallet loads MPL. The system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and sequence the corresponding groups of cases in the manner described in U.S. Pat. No. 9,856,083 issued on Jan. 2, 2018, the disclosure of which is incorporated herein by reference in its entirety.

The storage and sortation section includes a multilevel automated storage system that has an automated transport system that in turn receives or feeds individual cases into the multilevel storage array SA for storage in a storage area (such as storage spaces 130S of the storage structure 130). The storage and sortation section may define outbound transport of case units from the multilevel storage array such that desired case units are individually retrieved in accordance with commands generated in accordance to orders entered into a warehouse management system, such as warehouse management system 2500, for transport to the output section. The storage and sortation section may receive individual cases, sorts the individual cases (utilizing, for example, the buffer and interface stations described herein), e.g., in a case level sortation, and transfers the individual cases to the output section in accordance to orders entered into the warehouse management system. The sorting and grouping of cases according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015, the disclosure of which is incorporated herein by reference in its entirety.

The distribution of case units CU within the storage structure 130 and on each level 130L of the storage structure may be a stochastic distribution (a random distribution of each product within the storage structure so that each product is available to efficiently pick without obstruction) that effects fulfillment of orders. The orders for filled items (e.g., the pallets, cases, containers, package of goods, individual (unpacked) goods, etc.) may also be stochastic (e.g., substantially random in the items ordered and a time the order is received) and may be fulfilled by the automated storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL as described herein with respect to FIG. 1D (see also, e.g., U.S. Pat. No. 8,965,559 titled “Pallet Building System” and issued on Feb. 24, 2015, the disclosure of which is incorporated herein by reference in its entirety). The picking of the case units CU for order fulfillment by the autonomous guided bots 110, 262 described herein may be referred to as tasks or goals that may be randomly/stochastically effected for order fulfillment. The stochastic nature of order fulfillment and case unit storage as described herein may be similar to (or the same as) the stochastic order fulfillment and storage described in U.S. patent application Ser. No. 17/358,383 filed on Jun. 25, 2021 (and published as US 2022/0002081), U.S. patent application Ser. No. 18/323,758 filed May 25, 2023 (and published as US 2023/0382644), U.S. patent application Ser. No. 18/063,202 filed (Feb. 27, 2023 (and published as US 2023/0182306), U.S. Pat. No. 11,760,569 issued on Sep. 19, 2023, U.S. Pat. No. 11,608,228 issued on Mar. 21, 2023, the disclosure of which are incorporated herein by reference in their entireties.

The output section generates the pallet load in what may be referred to as a structured architecture of mixed case stacks. The structured architecture of the pallet load described herein is representative and it is noted the pallet load may have any other suitable configuration. For example, the structured architecture may be any suitable predetermined configuration such as a truck bay load or other suitable container or load container envelope holding a structural load. The structured architecture of the pallet load may be characterized as having several flat case layers L121-L125, L12T as described in U.S. Pat. No. 9,856,083, previously incorporated by reference herein in its entirety.

In accordance with the present disclosure, referring again to FIG. 1, the automated storage and retrieval system 100 includes a storage array (e.g., storage structure 130 having storage spaces 130S) with at least one elevated storage level 130L and at least one breakpack module 266 (as described herein). It is noted that while the storage array is described as a three dimensional storage array, the storage array may be a two dimensional storage array (e.g., single level floor), the back of a truck, or any other suitable storage array where case units may be transferred directly by the storage and retrieval system 100 (such as by the autonomous guided container bots 110) or indirectly (e.g., by fork trucks or other vehicle/operator placing case units on a conveyor in a predetermined sequence (grouped stock keeping units or other categorical sequencing)) to a breakpack module 266. Where the storage array is a single level (i.e., single level floor) the breakpack module 266 is located on the floor level of the storage array. Mixed product units are input and distributed in the storage array in cases CU of product units of common kind per case CU (each case input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers) to lift modules 150A for entry into a storage level 130L of the storage structure 130).

The automated storage and retrieval system 100 includes an automated transport system (e.g., autonomous container transport vehicles or autonomous guided container bots 110, autonomous goods transport vehicles or autonomous guided goods bots 262, breakpack modules, and other suitable level transports described herein) with at least one asynchronous transport system for transporting cases/products on a given storage structure level 130L (e.g., level transport). Here, as will be described, the storage and retrieval system 100 includes non-holonomic autonomous guided container bots 110 that undeterministically (i.e., are not physically constrained for travel along a given path, not restricted to Cartesian motion, and not restricted to travel lanes of a Cartesian grid of travel lanes) travel along one or more physical pathways (such as described with respect to FIGS. 4-5B) of the storage and retrieval system 100 to provide at least one level of asynchronicity. The autonomous guided container bots 110 of each respective storage level 130L may be confined to the respective storage level 130L such that each storage level has a respective fleet 110LF of autonomous guided container bots 110 for which path planning is determined as described herein independent of other fleets 110LF of other storage levels 130L. The storage structure may be configured such that autonomous guided container bots 110 may travel between two or more storage levels 130L such that the fleet 110LF includes the autonomous guided container bots 110 of the two or more storage levels 130L. The autonomous guided container bots 110 are configured for high speed travel, where the high speed travel is in excess of about 20 km/hr (e.g. about 5.6 m/sec) and more particularly about 32 km/hr (e.g. about 9.144 m/sec) or about 36 km/hr (e.g. about 10 m/sec) with the container bot 110 carrying a payload of about 60 lbs (about 27 kg) to about 90 lbs (about 41 kg) (although the payload may be less than about 60 lbs or more than about 90 lbs and the high speed travel may be greater than 10 m/sec).

At least another level of asynchronicity is provided (as described herein) such that, for example, case/product holding locations are greater than the number of bots transporting cases/products. At least one lift 150 is provided for transporting cases/products between storage levels (e.g., between level transport) or the cases/products may be presorted an on a predetermined level before a container bot 110 retrieves the cases/products (e.g., such that the lift does not transfer the cases/products between levels for container bot 110 retrieval). The at least one lift 150B is communicably connected to the storage array as described herein so as to automatically retrieve and output, from the storage array, product units distributed in the cases in a common part (e.g., the storage locations 130S of a respective storage level 130L) of the at least one elevated storage level 130L of the storage array. The output product units being one or more of mixed singulated product units, in mixed packed groups, and in mixed cases. As an example, the automated storage and retrieval system 100 includes output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). Here the output station 160EC is an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT is a commercial output station where large numbers of goods are generally provided on pallets for fulfilling orders from commercial entities (e.g., commercial stores, warehouse clubs, restaurants, etc.). The automated storage and retrieval system 100 includes both the commercial output station 160UT and the individual fulfillment output station 160EC; although, the automated storage and retrieval system includes one or more of the commercial output station 16OUT and the individual fulfillment output station 160EC.

The automated storage and retrieval system 100 also includes the input and output vertical lift modules 150A, 150B (generally referred to as lift modules 150—it is noted that while input and output lift modules are shown, a single lift module may be used to both input and remove case units from the storage structure), a storage structure 130 (which may have at least one elevated storage level as noted above and may form a multilevel storage array), and at least one autonomous guided container bot 110 (which form at least a part of the asynchronous transport system for level transport) which may be confined to a respective storage level of the storage structure 130 and are distinct from a container transfer deck 130DC on which they travel. The lift modules 150 include any suitable transport configured to vertically raise and lower case units and are inclusive of reciprocating elevator type lifts, fork lift trucks, etc. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL (FIG. 1D) for shipping. As used herein the lift modules 150, storage structure 130 and autonomous guided container bots 110 may be collectively referred to herein as the multilevel automated storage system (e.g. storage and sorting section) noted above so as to define (e.g. relative to e.g. a container bot 110 frame of reference REF—FIG. 4A—or any other suitable storage and retrieval system frame of reference) transport/throughput axes (in e.g. three dimensions) that serve the three dimensional multilevel automated storage system where each throughput axis has an integral “on the fly sortation” (e.g. sortation of case units during transport of the case units) so that case unit sorting and throughput occurs substantially simultaneously without dedicated sorters as described in U.S. Pat. No. 9,856,083, previously incorporated herein by reference in its entirety.

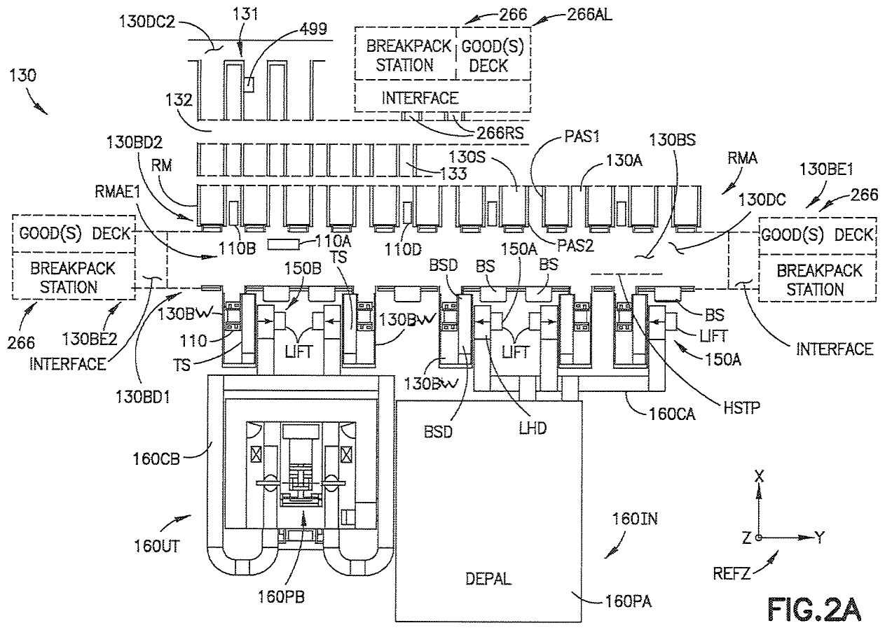

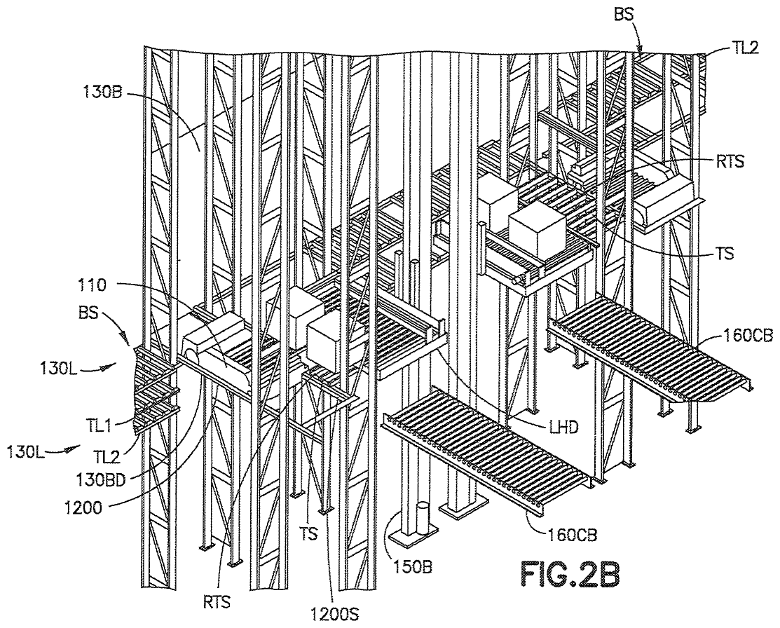

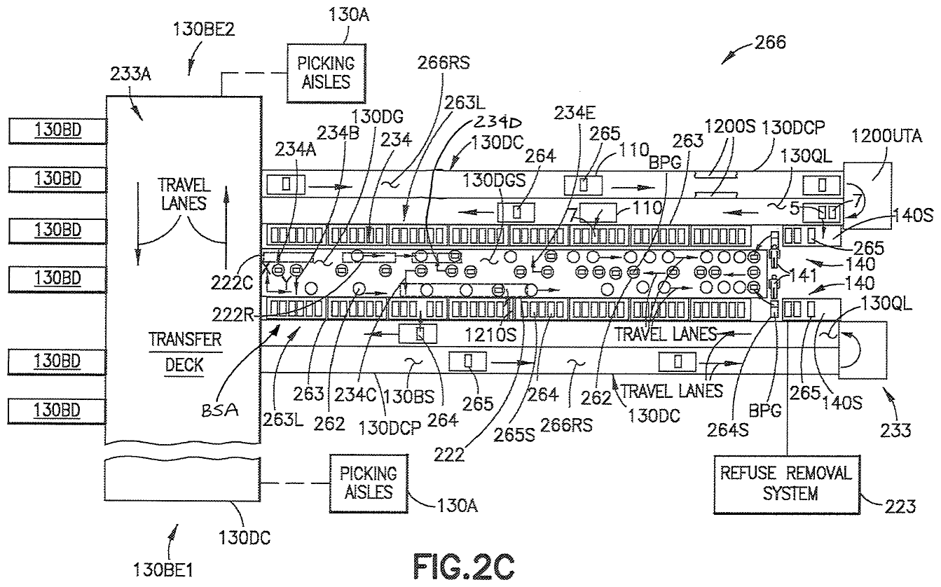

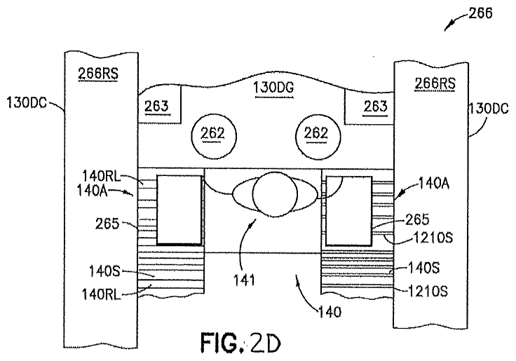

Also referring to FIGS. 1, 1C, 2A, and 2C, the storage structure 130 may include a container autonomous transport travel loop(s) 233, 233A (e.g., formed on and along a container transfer deck 130DC), disposed at a respective level of the storage structure 130. It is noted that the lifts 150 are connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) (see FIG. 2C) and the breakpack goods containers 264 (empty or filled) (see FIG. 2C) into and out of the at least one elevated storage level 130L of the storage structure 130. Container storage locations (or spaces) 130S are arrayed peripherally along the container transfer deck 130DC. For example, multiple storage rack modules RM, configured in a high-density three dimensional rack array RMA, are accessible by storage or deck levels 130L. As used herein the term “high density three dimensional rack array” refers to the three dimensional rack array RMA having undeterministic open shelving distributed along picking aisles 130A where, multiple stacked shelves may be accessible from a common picking aisle travel surface or picking aisle level as described in U.S. Pat. No. 9,856,083, previously incorporated by reference herein in its entirety.

Each storage level 130L includes pickface storage/handoff spaces 130S (referred to herein as storage spaces 130S or container storage locations 130S) arrayed peripherally along the container transfer deck 130DC. At least one of the storage locations 130S is a supply container storage location 130SS, and another of the container storage locations is a breakpack goods (or order) container storage location 130SB. The storage spaces 130S may be formed by the rack modules RM where the rack modules include shelves that are disposed along storage or picking aisles 130A (that are connected to the container transfer deck 130DC) which, e.g., extend linearly through the rack module array RMA and provide container bot 110 access to the storage spaces 130S and transfer deck(s) 130B. The shelves of the rack modules RM may be arranged as multi-level shelves that are distributed along the picking aisles 130A. As may be realized the autonomous guided container bots 110 travel on a respective storage level 130L along the picking aisles 130A and the container transfer deck 130DC for transferring case units between any of the storage spaces 130S of the storage structure 130 (e.g. on the level which the container bot 110 is located) and any of the lift modules 150 (e.g. each of the autonomous guided container bots 110 has access to each storage space 130S on a respective level and each lift module 150 on a respective storage level 130L). The transfer decks 130B are arranged at different levels (corresponding to each level 130L of the storage and retrieval system) that may be stacked one over the other or horizontally offset, such as having one container transfer deck 130DC at one end or side RMAE1 of the storage rack array RMA or at several ends or sides RMAE1, RMAE2 of the storage rack array RMA as described in, for example, U.S. patent application Ser. No. 13/326,674 filed on Dec. 15, 2011 the disclosure of which is incorporated herein by reference in its entirety.

The container transfer decks 130DC are substantially open and configured for the undeterministic traversal of autonomous guided container bots 110 along multiple travel lanes (e.g. along an X throughput axis with respect to the bot frame of reference REF illustrated in FIG. 4A) across and along the transfer decks 130B. As will be described in further detail below (and as described in U.S. Pat. No. 10,556,743 issued on Feb. 11, 2020 and having application Ser. No. 15/671,591, the disclosure of which is incorporated herein by reference in its entirety) the multiple travel lanes may be configured to provide multiple access paths or routes to each storage location 130S (e.g., pickface, case unit, container, or other items stored on the storage shelves of rack modules RM) so that autonomous guided container bots 110 may reach each storage location using, for example, a secondary path if a primary path to the storage location is obstructed. As may be realized, the transfer deck(s) 130B at each storage level 130L communicate with each of the picking aisles 130A on the respective storage level 130L. Autonomous guided container bots 110 bi-directionally traverse between the container transfer deck(s) 130DC and picking aisles 130A on each respective storage level 130L so as to travel along the picking aisles (e.g. along the X throughput axis with respect to the bot frame of reference REF illustrated in FIG. 4A) and access the storage spaces 130S disposed in the rack shelves alongside each of the picking aisles 130A (e.g. autonomous guided container bots 110 may access, along a Y throughput axis, storage spaces 130S distributed on both sides of each aisle such that the container bot 110 may have a different facing when traversing each picking aisle 130A, for example, referring to FIG. 4A, drive wheels 202 leading a direction of travel or drive wheels trailing a direction of travel). As may be realized, throughput outbound from the storage array in the horizontal plane corresponding to a predetermined storage or deck level 130L is effected by and manifest in the combined or integrated throughput along both the X and Y throughput axes. As noted above, the container transfer deck(s) 130DC also provides container bot 110 access to each of the lifts 150 on the respective storage level 130L where the lifts 150 feed and remove case units (e.g. along the Z throughput axis) to and/or from each storage level 130L and where the autonomous guided container bots 110 effect case unit transfer between the lifts 150 and the storage spaces 130S.

As described above, referring also to FIG. 2A, the storage structure 130 may include multiple storage rack modules RM, configured in a three dimensional array RMA where the racks are arranged in aisles 130A, the aisles 130A being configured for container bot 110 travel within the aisles 130A. The container transfer deck 130DC has an undeterministic transport surface on which the autonomous guided container bots 110 travel where the undeterministic transport surface (also referred to herein as a deck surface) 130BS has multiple travel lanes (e.g., more than one juxtaposed travel lane (e.g. high speed bot travel paths HSTP)) for travel of the container bot 110 along the container autonomous transport travel loop(s) 233, 233A formed by the container transfer deck 130DC, where the multiple travel lanes connect the aisles 130A. The container autonomous transport travel loop 233A provides the container bot 110 with random access to any and each picking aisle 130A and random access to any and each lift 150A, 150B on the respective level 130L of the storage structure 130. At least one of the multiple travel lanes has a travel sense opposite to another travel lane sense of another of the multiple travel lanes (so as to form the container autonomous transport travel loop 233).

As may be realized, any suitable controller of the storage and retrieval system 100 such as for example, control server 120 or warehouse management system 2500, may be configured to create any suitable number of alternative pathways for retrieving one or more case units (and/or breakpack containers) from their respective storage locations 130S when a pathway provided access to those case units is restricted or otherwise blocked. For example, the control server 120 may include suitable programming, memory and other structure for analyzing the information sent by the container 110, lifts 150A, 150B, and input/output stations 160IN, 160UT, 160EC for planning a container bot's 110 primary or preferred route to a predetermined item within the storage structure. The preferred route may be the fastest and/or most direct route that the container bot 110 can take to retrieve the case units/pickfaces. The preferred route may be any suitable route. The control server 120 (and/or warehouse management system 2500) may also be configured to analyze the information sent by the autonomous guided container bots 110, the lifts 150A, 150B, and input/output stations 160IN, 160UT, 160EC for determining if there are any obstructions along the preferred route. If there are obstructions along the preferred route the control server 120 may determine one or more secondary or alternate routes for retrieving the case units so that the obstruction is avoided and the case units can be retrieved without any substantial delay in, for example, fulfilling an order. It should be realized that the container bot route planning may also occur on the container bot 110 itself by, for example, any suitable control system, such as a controller (system) 110C onboard the container bot 110. As an example, the bot control system may be configured to communicate with the control server 120 for accessing the information from other autonomous guided container bots 110, the lifts 150A, 150B, and the input/output stations 160IN, 160UT, 160EC for determining the preferred and/or alternate routes for accessing an item in a manner substantially similar to that described above. It is noted that the container bot 110 controller 110C may include any suitable programming, memory and/or other structure to effect the determination of the preferred and/or alternate routes.

Referring to FIG. 2A, as a non-limiting example, in an order fulfillment process the container bot 110A, which is traversing container transfer deck 130DC, may be instructed to retrieve item 499 from picking aisle 131. However, there may be a disabled bot 110B blocking aisle 131 such that the bot 110A cannot take a preferred (e.g. the most direct and/or fastest) path to the case unit 499. In this example, the control server 120 may instruct the container bot 110A to traverse an alternate route such as through any unreserved picking aisle (e.g. an aisle without a container bot in it or an aisle that is otherwise unobstructed) so that the container bot 110A can travel along, for example, another container transfer deck 130DC2 that is substantially similar to container transfer deck 130DC. The container bot 110A can enter the end of the picking 131, opposite the blockage, from the other container transfer deck 130DC2 so as to avoid the disabled container bot 110B for accessing the item 499. The storage and retrieval system 100 may include one or more bypass aisles 132 that run substantially transverse to the picking aisles 130 to allow the autonomous guided container bots 110 to move between picking aisles 130 in lieu of traversing the container transfer decks 130DC, 130DC2. The bypass aisles 132 may be substantially similar to travel lanes of the container transfer decks 130DC, 130DC2, as described herein, and may allow bidirectional or unidirectional travel of the autonomous guided container bots through the bypass aisle 132. The bypass aisle 132 may provide one or more lanes of container bot travel where each lane has a floor and suitable guides for guiding the bot along the bypass aisle 132 in a manner similar to that described herein with respect to the transfer decks 130DC, 130DC2. The bypass aisles 132 may have any suitable configuration for allowing the autonomous guided container bots 110 to traverse between the picking aisles 130. It is noted that while the bypass aisle 132 is shown with respect to a storage and retrieval system having transfer decks 130DC, 130DC2 disposed on opposite ends of the storage structure, a storage and retrieval system 100 having only one transfer deck may also include one or more bypass aisles 132.

A breakpack module 266AL may be located on a side of the container transfer deck 130DC on which the picking aisles 130 are located and one or more picking aisles 130 extend into the breakpack module 266AL so as to form container bot riding surface(s) 266RS. Here the container bot 110A is to deliver a supply container 265 to the breakpack module 266AL and the picking aisle 133 extending into the breakpack module is blocked by container bot 110D. The control server 120 and/or container bot controller 110C determines a secondary or bypass route for the container bot 110A to access breakpack station (either travelling along the other container transfer deck 130DC2 and/or bypass aisle 132) in a manner substantially similar to that described above with respect to item 499.

It is noted that the storage and retrieval systems shown and described herein have exemplary configurations only and it is noted the storage and retrieval systems may have any suitable configuration and components for storing and retrieving items as described herein. For example, the storage and retrieval system may have any suitable number of storage sections, any suitable number of transfer decks, any suitable number of breakpack modules, and corresponding input/output stations.

The juxtaposed travel lanes are juxtaposed along a common undeterministic transport surface 130BS between opposing sides 130BD1, 130BD2 of the container transfer deck 130DC. As illustrated in FIG. 2A, the aisles 130A are joined to the container transfer deck 130DC on one side 130BD2 of the container transfer deck 130DC although, the aisles may be joined to more than one side 130BD1, 130BD2 of the container transfer deck 130DC in a manner substantially similar to that described in U.S. patent application Ser. No. 13/326,674 filed on Dec. 15, 2011, the disclosure of which is previously incorporated by reference herein in its entirety. As will be described in greater detail below the other side 130BD1 of the container transfer deck 130DC may include includes deck storage racks (e.g. interface stations (also referred to as transfer stations) TS and buffer stations BS) that are distributed along the other side 130BD1 of the container transfer deck 130DC so that at least one part of the transfer deck is interposed between the deck storage racks (such as, for example, buffer stations BS or transfer stations TS) and the aisles 130A. The deck storage racks are arranged along the other side 130BD1 of the container transfer deck 130DC so that the deck storage racks communicate with the autonomous guided container bots 110 from the container transfer deck 130DC and with the lift modules 150 (e.g. the deck storage racks are accessed by the autonomous guided container bots 110 from the container transfer deck 130DC and by the lifts 150 for picking and placing pickfaces so that pickfaces are transferred between the autonomous guided container bots 110 and the deck storage racks and between the deck storage racks and the lifts 150 and hence between the autonomous guided container bots 110 and the lifts 150).

Referring again to FIG. 1, each storage level 130L may also include charging stations 130C for charging an on-board power supply of the autonomous guided container bots 110 on that storage level 130L such as described in, for example, U.S. patents application Ser. No. 14/209,086 filed on Mar. 13, 2014 and Ser. No. 13/326,823 filed on Dec. 15, 2011 (now U.S. Pat. No. 9,082,112), the disclosures of which are incorporated herein by reference in their entireties.

Referring to FIGS. 1, 2A, 2C, as noted above, the automated storage and retrieval system 100 includes one or more break pack modules 266. The breakpack modules 266 are configured to break down product containers or case units CU into breakpack goods containers 264 for order fulfillment, such as described in U.S. patent application Ser. No. 17/358,383 filed Jun. 25, 2021, the disclosure of which was previously incorporated herein by reference in its entirety. The breakpack modules 266 may operate as an automated decant process for downstream logistics such as goods to person automation. One or more breakpack modules 266 may be located on a common level 130L of the automated storage and retrieval system, where one or more levels of the automated storage and retrieval system 100 include at least one breakpack module 266. The breakpack module(s) 266 may be plug and play modules that may be coupled to any suitable portion of the structure of the automated storage and retrieval system 100. For example, the breakpack module(s) may be coupled to a container transfer deck 130DC or picking (or pick) aisle(s) 130A of the automated storage and retrieval system 100 as will be described in greater detail below. The breakpack module(s) 266 may be disposed on any suitable number of stacked storage levels of the automated storage and retrieval system 100. Here, the automated storage and retrieval system 100 may be configured, such as through any suitable controller (e.g., control server 120) so that the automated storage and retrieval system 100 has selectable modes of operation. In one mode of operation the automated storage and retrieval system 100 is configured to output product cases, containers, and/or case units to a palletizer. In another mode of operation, such as with the breakpack module(s) 266 employed, the automated storage and retrieval system 100 is configured to break down product cases, product containers, and/or case units and output breakpack goods containers, product cases, containers, and/or case units to a palletizer, or re-enter the breakpack (order) container(s) and/or a remainder of a product cases, containers, and/or case units to a palletizer (e.g., after being broken down) into storage for later retrieval.

The controller 120 (or warehouse management system 2500), as may be realized, is configured to plan travel paths and effect operation of a container bot 110 and an autonomous guided goods bot 262 (both of which form at least part of the asynchronous transport system) (sec also, e.g., FIG. 2C) for assembling orders of breakpack goods BPG from supply containers 265 into breakpack goods containers 264 and outfeed of breakpack goods containers 264 through container outfeed stations TS as will be described herein. For example, the controller 120 (or warehouse management system 2500) is configured to effect operation of the container bot(s) 110 between the container storage locations 130S, the breakpack operation station 140, and a breakpack goods container 264 located along the breakpack goods transfer deck 130DG. As another example, the controller 120 is configured to effect operation of the autonomous guided goods bot(s) 262 so that transport of the breakpack goods BPG, by the autonomous guided goods bot 262 traverse on the goods transfer deck 130DG, sorts the breakpack goods BPG, e.g., in a unit/each level sortation, to corresponding breakpack goods containers 264. As a further example, the controller 120 is configured to effect operation of the container bot(s) 110 so that the container bot(s) 110 accesses corresponding breakpack goods containers 264 at the goods transfer deck 130DG and transports the breakpack goods containers 264 via traverse along the container transfer deck 130DC to at least one of a container output/transfer station TS and a corresponding container storage location 130SB of storage shelves of a corresponding level 130L of the multilevel storage array.

The controller 120 (or warehouse management system 2500) is also configured to plan travel paths and effect operation of the container bot(s) 110 and effect operation of lifts 150 (e.g., to form a container supply system) so as to introduce empty breakpack goods containers 264 into the automated storage and retrieval system so that the container bot(s) 110 transport the empty breakpack goods containers 264, along the transport loops 233, 233A of the container transfer deck(s) 130DC and into a breakpack module 266 for placement at a breakpack goods interface location(s) 263L of a breakpack goods interface 263 for transfer of breakpack goods BPG into the breakpack goods containers 264. Empty breakpack containers 264 may be transferred to (in a manner similar to that noted above with the lifts and autonomous guided container bots) and stored in the storage spaces 130SB, 130S of the rack modules RM or buffered at an infeed station, where the controller 120 is configured to effect transfer of the empty breakpack goods containers 264 from the storage spaces 130SB, 130S or buffer location to the breakpack goods interface 263 in a manner similar to that described above. The controller 120 may be configured to effect operation of the container bot(s) 110 and lifts 150 (e.g., forming a container supply system) so as to introduce empty supply containers 265 or standardized containers 265S (as described herein) into the automated storage and retrieval system so that the container bot(s) 110 transport the empty supply containers 265 or standardized containers 265S, along the transport loops 233, 233A of the container transfer deck(s) 130DC and to the breakpack operation station 140 of a breakpack or directly or indirectly to a downstream logistics process such as the goods to person process.

Each breakpack module 266 may have a container bot riding surface 266RS that forms a portion 130DCP of the container transfer deck 130DC, where the riding surface 266RS is substantially similar to that of container transfer deck 130DC, although the container bot riding surface 266RS may be substantially similar to that of the picking aisles 130A. For case of explanation, the present disclosure will refer to the container bot riding surface 266RS within the breakpack module 266 as a portion of the container transfer deck 130DC. Where the bot riding surface 266RS is formed by a portion of (or is an extension of) the container transfer deck 130DC it is noted that, while the container transfer deck 130D is illustrated in FIG. 2C a single path transport loop, the transport loop of the breakpack module 266 may be a multilane transport loop substantially similar to container transport deck illustrated in FIG. 2A. For example, referring to FIG. 2E the container bot travel surface 266RS is an open undeterministic travel surface having multiple travel inbound and outbound lanes. For example, there are multiple inbound travel lanes TL1, TL2 where travel lane TL2 is a bypass lane for travelling around obstructions on travel lane TL1 (or vice versa). There may also be multiple outbound travel lanes TL3, TL4, TL5. Here, travel lane TL5 defines a queue lane 130QL (FIG. 2C) for the autonomous guided container bots 110 at the breakpack goods interface 263 while travel lanes TL4 and TL5 may be used for egress from the breakpack module 266, with travel lane TL5 being a bypass for travelling around obstructions on travel lane TL4 (or vice versa). Case units may be transferred between the storage array and the breakpack module 266 indirectly, such as by conveyors and/or fork trucks. The autonomous guided container bots 110 or fork trucks may deliver case units to conveyors that transport the case units to the breakpack station and from the breakpack station to the storage array or downstream logistics process.

Each of the breakpack modules 266 includes a breakpack goods autonomous transport travel loop 234 (see exemplary breakpack goods autonomous transport travel loops 234A-234E formed on and along a goods deck or goods transfer deck 130DG), at least one breakpack operation station 140, and a breakpack goods interface 263 disposed between and interfacing the goods transfer deck 130DG with the container transfer deck 130DC. Referring also to FIGS. 1 and 2A, the breakpack goods module 266 may include one or more belt sorters BST (such as cross belt sorters) that is/are configured as an interface(s) between autonomous guided goods bots 262 (operating on the goods deck 130DG) and the autonomous guided container bots 110 (operating on the container transport deck 130DC), between the autonomous guided container bots 110 and the breakpack operation station 140, and/or between the breakpack operation station 140 and the autonomous guided goods bots 262. For exemplary purposes only, the goods deck 130DG is illustrated as having three travel lanes that form the (variable length) travel loops 234A-234E; however, the goods deck may have any suitable number of travel lanes that form any suitable number of breakpack goods autonomous transport travel loops 234. Each breakpack module 266 may be undeterministically coupled (e.g., the breakpack modules 266 maybe coupled to the automated storage and retrieval system 100 at any suitable location thereof, such as to one or more ends 130BE1, 130BE2, or centrally located between the two ends 130BE1, 130BE2 such as in place of picking aisles 130 (and storage locations) or at any other suitable location) to the automated storage and retrieval system 100 in any suitable manner (e.g., so as to form a part thereof). Though the breakpack modules 266 are coupled undeterministically to the structure of the automated storage and retrieval system 100 each component of the breakpack modules 166 is independent (e.g., self-contained as a unit) and/or independently automated in guidance and travel of the bots (e.g., autonomous guided goods bots 262) from the components of the automated storage and retrieval system, so that the interface between the components of the breakpack modules 266 and the components of the automated storage and retrieval system 100 is undeterministic.

The breakpack module(s) 266 may be coupled to the structure of the automated storage and retrieval system 100 at any suitable location and at any suitable level(s) 130L. For example, as noted above, a break pack module 266 may be located at one or more ends 130BE1, 130BE2 of the container transfer deck 130DC or at one or more sides 130BD1, 130BD2 of the container transfer deck 130DC (such as in lieu of storage rack modules RM/picking aisles 130A or lifts 150A, 150B, or as an extension of one or more picking aisles 130A). Each of the breakpack modules 266 is a plug and play module that is integrated with (or otherwise connected to) the container transfer deck 130DC so that the container transfer deck 130DC is communicably coupled to the container bot riding surface 266RS. The container transfer deck 130DC extends into the breakpack module to form the container bot riding surface 266RS (e.g., the breakpack module forms a modular part of the container transfer deck 130DC) so that autonomous guided container bots 110 traverse or move into and out of the breakpack modules 266 along the undeterministic container transfer deck 130DC, and at least one of the multiple travel lanes of the container transfer deck 130DC defines a queue lane 130QL (FIG. 2C) for the autonomous guided container bots 110 at the breakpack goods interface 263. The container bot riding surface 266RS includes rails 1200S (see FIG. 1B) that extend from the container transport deck 130DC in a manner similar to that of the picking aisles 130A, so that autonomous guided container bots 110 traverse or move into and out of the breakpack modules 266 along the rails 1200S, and the rails 1200S defines a queue lane 130QL (FIG. 2C) for the autonomous guided container bots 110 at the breakpack goods interface 263. It is noted that where the container bot riding surface 266RS is formed by rails 1200S the riding surface may include an undeterministic turn around area 1200UTA (that is similar to the open undeterministic container transfer deck 130DC) on which the autonomous guided container bots 110 turn to transition between different travel portions (e.g., inbound and outbound) of the breakpack goods autonomous transport travel loop 234. As can be seen in FIG. 2C, the container bot travel surface 266RS of the breakpack module 266 forms a travel loop 233 around which the autonomous guided container bots 110 travel to respectively transport along the container bot travel surface 266RS travel loop 233 a supply container (e.g., case unit, pickface, remainder container, etc.) between the storage locations 130S and a breakpack operation station 140 (and/or vice versa), and a breakpack goods container (also referred to as a breakpack container) 264 between the breakpack goods interface 263 and the breakpack goods container storage location 130SB or a lift 150A (and/or vice versa). The travel loop 233 provides the container bot 110 with random access to any and each breakpack goods interface locations 263L of the breakpack goods interface 263 along the bot travel surface 266RS, where the breakpack goods interface locations 263L form an asynchronous product distribution system.

The goods transfer deck 130DG forms a goods autonomous transport travel loop 234 disposed at the storage level 130L. The goods transfer deck 130DG is separate and distinct from the travel loop 233 formed by the container bot travel surface 266RS, and has the breakpack goods interface 263 coupling respective edges of the container autonomous transport travel loop 233 of the container transfer deck 130DC and the breakpack goods autonomous transport travel loop 234 of the goods transfer deck 130DG. The goods autonomous transport travel loop 234 formed by the goods transfer deck 130DG is disposed on a deck surface 130DGS of a deck (e.g., goods transfer deck 130DG) at a respective storage level 130L, and the breakpack goods autonomous transport travel loop(s) 234 of the goods transfer deck 130DG is disposed on a different deck surface 130DGS of the deck (e.g., goods transfer deck 130DG), separate and distinct from the deck surface 130BS of the container bot travel surface 266RS (formed by the container transfer deck 130DC and/or rails 1200S) where the container autonomous transport travel loop 233 is disposed. The breakpack goods autonomous transport travel loop 234 formed by the goods transfer deck 130DG (and hence the goods travel deck 130DG) is disposed to confine at least one autonomous goods bot 262 to the respective storage level 130L. The at least one autonomous guided goods bot 262 is arranged or otherwise configured for transporting, along the breakpack goods autonomous transport travel loop 234 formed by the goods transfer deck 130DG, one or more breakpack goods BPG (e.g., a pack that is unpacked from the supply container in a pack level sort or a unit/each unpacked from a pack in a unit/each level sort) between the breakpack operation station 140 and the breakpack goods interface 263. The container bot(s) 110 is also configured to autonomously pick and place the breakpack goods containers 264 at the breakpack goods interface 263 as described herein. The breakpack goods interface 263 may be substantially similar to one or more of the transfer stations TS and buffer stations BS described herein and include an undeterministic surface (similar to that of the rack storage spaces 130S described herein) upon which breakpack goods containers 264 are placed so as to form an undeterministic interface between the goods transfer deck 130DG and the container transfer deck 130DC.

The goods transfer deck 130DG facilitates a decanting process where goods are picked from one container (such as a supply container 265 or any other suitable standardized container 265S) at the breakpack operation station 140 and consolidated with goods (generally of the same type) in another (e.g., outbound as noted below) supply container 265 or standardized container 265S at the breakpack goods interface 263, where the other supply container 265 or standardized container 265S is returned to storage. Generally, supply containers 265 inbound to the breakpack modules 266 are picked until empty but only some (not all) of the goods from the inbound supply container may be decanted. Here, what may be referred to as outbound (i.e., outbound from the breakpack modules 266) supply containers 265 or standardized containers 265S (such as totes, trays, etc.) may also be placed on the breakpack goods interface 263 by the container bot(s) 110 in a manner similar to that described herein for the breakpack goods containers 264 to facilitate the decanting process. In the decanting process, goods are removed from a supply container 265 (which may be an original product/good(s) case packaging) at the breakpack operation station 140 and consolidated into the outbound supply container(s) 265 or standardized container 265S (e.g., having the same type of goods as those being removed at the breakpack operation station 140) located on the breakpack goods interface 263. Consolidation of goods having the same type from multiple supply containers 265 into a lesser number of supply containers 265 (and then returned to storage by the container bot(s) 110) may increase the storage density of the automated storage and retrieval system 100 as the supply containers 265 stored in the storage racks can be maintained in a substantially “full” state (rather than having multiple containers that are less than full with the same type of goods therein. The decanted goods (in the standardized container or outbound supply container) may be output from the storage and retrieval system 100 via the lifts 150 to be palletized as part of a pallet load (such as at output station 160UT) or to be shipped individually (such as at output station 160EC).

The autonomous guided goods bots 262 may be any suitable type of autonomously guided bot with a payload configured for holding breakpack goods, not product containers (e.g., case units, pickfaces, etc.). Each of the autonomous guided goods bots 262 has a payload hold configured dissimilar from a payload hold of the container bot 110. The autonomous guided goods bots 262 are configured to autonomously travel unconstrained along and across the breakpack goods autonomous transport travel loop(s) 234 formed by the goods deck 130DG and any suitable travel speeds, which may be the same as, greater than, or less than those travel speeds noted above with respect to the autonomous guided container bots 110. The autonomous guided goods bots 262 are configured so as to automatically unload one or more breakpack goods BPG (retrieved from the breakpack operation station 140) from the autonomous guided goods bot 262 to breakpack goods containers 264 at the breakpack goods interface 263. Suitable examples of autonomous guided goods bots 262 include those produced by Symbotic of Wilmington, Massachusetts (United States), see for example, U.S. patent application Ser. No. 17/657,705 filed on Apr. 1, 2022 (Published as US PG Pub 2022/0289479), U.S. Provisional Patent Application No. 63/452,735 filed Mar. 17, 2023; and those produced by Tompkins International of Raleigh, North Carolina (United States), see for example, U.S. Pat. No. 10,248,112 issued on Apr. 2, 2019. The breakpack goods autonomous transport travel loop(s) 234 formed by the goods deck 130DG has multiple travel lanes (see FIG. 2C) for travel of the autonomous guided goods bots 262 along the breakpack goods autonomous transport travel loop(s) 234 (see, e.g., travel loops 234A-234E) formed by the goods deck 130DG. As noted herein, three travel lanes are illustrated for exemplary purposes only and it is noted there may be more or less than three travel lanes. At least one of the multiple travel lanes is a passing lane for the autonomous guided goods bot 262 travel passing an obstruction on another of the multiple travel lanes in a manner similar to that described herein with respect to the multiple travel lanes of the container transfer deck 130DC. The breakpack goods autonomous transport travel loop(s) 234 provide the autonomous guided goods bots 262 with random access to any and each of the breakpack goods interface locations 263L of the breakpack goods interface 263. The breakpack goods autonomous transport travel loop(s) 234 may provide the autonomous guided goods bots 262 access to the belt sorter BST where the belt sorter BST sorts (and may be configured as a sorting buffer) the breakpack goods to the breakpack goods interface 263. Here the belt sorter BST operates as an interface between the autonomous guided goods bots 262 and autonomous guided container bots 110.

One or more portions of the goods transfer deck 130DG (such as adjacent the breakpack goods interface locations 263L) can be reserved to provide an exit (or off) ramp or entrance (or on) ramp from or to a travel loop travel 234A-234E to effect a transfer of breakpack goods BPG to or from the breakpack goods container(s) 264 (or supply containers 265, 265S) at the breakpack goods interface locations 263L. Exit ramps (referred to herein as ramps 222, 222C, 222R) will be described herein but it should be understood that the entrance ramps are substantially opposite in direction to the exit ramps 222, 222C, 222R (e.g., provide access to rather than access from a travel loop). One or more ramps 222, 222C, 333R are provided depending on, for example, bot 110 kinematics (velocity, direction, etc.) and location(s) of (destination) breakpack goods interface locations 263L (e.g., near corners of the goods transfer deck 130DG, away from the corners of the goods transfer deck 130DG, etc.) being accessed by the autonomous guided goods bots 262. For exemplary purposes only, ramp 222 is a generic depiction of an on/off ramp that may be located anywhere on the goods transfer deck 130DG and have any suitable length. Ramp 222C is located in a corner of the goods transfer deck 130DG. Ramp 222R is a “rolling” ramp that moves to follow a path of an autonomous guided goods bot 262 traveling along the ramp 222R,

The ramps 222, 222C, 222R (both on and off ramps) may be “closed” temporarily from general access by the autonomous guided goods bots 262 (e.g., only predetermined autonomous guided goods bots delivering breakpack goods to and from the breakpack goods interface locations 263L within the areas designated by the ramps 222, 222C, 222R have access to respective on and off ramps). Generally, the ramps 222, 222C, 222R provide passage to and from a passing lane to a destination breakpack goods interface location 263L. Each ramp 222, 222C, 222R may be bidirectional (such as where a goods bot 2662 enters the ramp and travels in one direction along the ramp to pick or place a breakpack good BPG and then travels in the opposite direction along the ramp to exit from the ramp). The ramp may be a “counter-flow ramp” where travel along a ramp 222, 222C, 222R is in a generally opposing direction to a travel direction around one or more of the travel loop(s) 234 (e.g., an autonomous guided goods bot 262 exits the travel loop and travels in the generally opposing direction along the ramp 222, 222C, 222R). Where the ramp 222, 222C, 222R is an off ramp, the ramp 222, 222C, 222R may terminate at the destination breakpack goods interface location 263L. Similarly, where the ramp 222, 222C, 222R is an on ramp, the ramp 222, 222C, 222R may begin at the destination breakpack goods interface location 263L. As noted above, the ramps 222, 222C, 222R may be located anywhere on the goods transfer deck 130DG such that ramp entry locations vary in what may be referred to as a parking lane (e.g., a lane or a portion of a travel loop in which the goods bot stops to pick or place breakpack goods BPG) based on one or more of bot kinematics and locations of available breakpack goods interface locations 263L. It is noted that while the turns of the autonomous guided goods bots 262 to and from the ramps 222, 222C, 222R are illustrated as being substantially 90° turns, the turns may have an “S” shape similar to that described in U.S. patent application Ser. No. 16/144,668 filed on Sep. 27, 2018 and titled “Storage and Retrieval System”, the disclosure of which is incorporated herein by reference in its entirety.

The ramps 222, 222C, 222R are dynamically generated and may be dynamically effected (e.g., a “rolling” ramp, such as ramp 222R) so that the ramp “rolls” in a progressive fashion with an initial ramp length generated from goods bot entry with adequate clearance for goods bot collision avoidance. The ramp 222, 222C 222R may be initiated (at bot entry) given that the ramp to the destination breakpack goods interface location 263L is “blocked” (or otherwise obstructed) by an active autonomous guided goods bot 262/active breakpack goods interface location 263L but the blockage is expected to clear before the autonomous guided goods bot 262 traveling along the ramp reaches the blockage. If the blockage to the ramp 222, 222C, 222R clears, the ramp 222, 222C, 222R may be extended to the destination breakpack goods interface location 263L; however, if the blockage does not clear the autonomous guided goods bot 262 travelling along the ramp 222, 222C, 222R is redirected to, for example, a passing lane and a new ramp is calculated/determined so that the autonomous guided goods bot 262 can place breakpack goods BPG at the destination breakpack goods interface location 263L or another destination breakpack goods interface location 263L.

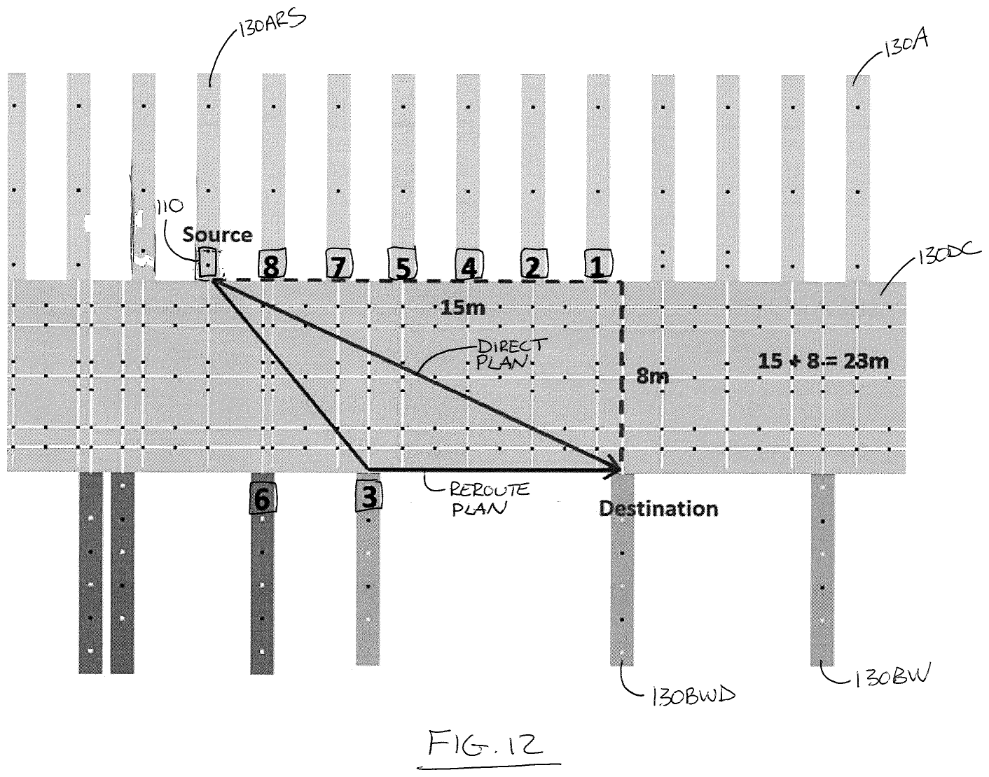

Referring also to FIG. 2D, the breakpack operation station 140 is configured so that one or more breakpack goods BPG are unpacked from supply container(s) 265 at the breakpack operation station 140, and at least one autonomous guided goods bot 262 is configured so as to be loaded with the one or more breakpack goods BPG at the breakpack operation station 140. An operator at the breakpack operation station 140 places the breakpack goods BPG to the at least one autonomous guided goods bot 262 for transfer to the breakpack goods interface 263. Referring to FIGS. 1 and 2A, a belt sorter BST is disposed between the breakpack operation station 140 and the autonomous guided goods bots 262 and forms an interface therebetween. Here the operator at the breakpack operation station places the breakpack goods BPG to the belt sorter BST where the belt sorter BST sorts (and may operates as a sorting buffer) the breakpack goods BPG to the autonomous guided goods bots 262. The breakpack operation station 140 includes any suitable supply container 265 support surface 140S. The support surface 140S is an undeterministic surface substantially similar to that of the storage shelves described herein and include slats 1210S that form the support surface 140S. The support surface 140S may be an undeterministic roller conveyor (powered or unpowered), having rollers 140RL with an arrangement similar to rollers 110RL (see FIGS. 4A and 4B) of the container bot 110 described herein so that tines 273A-273E of the pick head 270 of the container bot 110 (FIGS. 4A and 4B) are interdigitated with the rollers of the roller conveyor for placing (or picking) supply containers 265 to (or from) the support surface 140S. Here, the container bot 110 is configured to autonomously transfer the supply container(s) 265 from the container bot 110 to the breakpack operation station 140 (such as to the support surface 140S) in the manner described herein. Referring to FIGS. 1 and 2A, the autonomous guided container bots 110 may deliver the supply containers 265 to a belt sorter BST configured as an interface between the autonomous guided container bots 110 and the breakpack operation station 140. Here, the autonomous guided container bots 110 place the supply containers 265 to the belt sorter BST and the belt sorter BST sorts the supply containers 265 (and may operate as a sorting buffer) to the support surface 140S of the breakpack operation station 140. The support surface 140S may be configured so that as the supply containers 265 are placed by the container bot 110 or belt sorter BST the supply containers 265 move along the support surface 140S towards an operator 141 (e.g., a human operator or any suitable robotic operator (e.g., articulated arm, gantry, etc.)) for picking of breakpack goods BPG from the supply containers 265 and placement of the picked breakpack goods to autonomous guided goods bots 262 or to one or more of standardized containers 265S (such as totes, trays, etc.) and breakpack goods containers 264 located at an operator staging area 140A in any suitable manner to effect one or more of a pack level sortation of goods or a unit/each level sortation of goods. The supply containers 265 may be moved along the support surface 140S to a respective operator staging area 140A where the operator 141 picks the breakpack goods BPG from the supply containers 265 for placement in an autonomous guided goods bot 262 or in another container 265S, 264. The operator staging area 140A may be contiguous with and/or formed by the support surface 140S. As described herein, supply cases 265 with remaining goods therein after breakpack is performed may be picked by the autonomous guided container bots 110 from the support surface 140S or staging area 140A and returned to storage or to a lift 150. Empty supply containers 265 may be removed from the support surface 140S or staging area 140A by the operator 141 and stored at the breakpack operation station 140 for later removal in any suitable manner. Autonomous guided container bots 110 may transport empty containers from the storage and retrieval system via the lifts 150. The breakpack operation station 140 may include any suitable refuse removal system 223 for removing refuse (or trash, e.g., shrink wrapping, packaging, boxes, etc.) from the storage and retrieval system. The refuse removal system 223 may include one or more of chutes, conveyors, lifts, or any other suitable transport configured to move refuse to a predetermined location; although, the refuse may be placed in containers and removed from the storage and retrieval system by the autonomous guided container bots 110 via the lifts 150. As can be seen in FIGS. 2C and 13, the breakpack goods transfer deck 130DG joins the breakpack operation station 140 and the container transfer deck 130DC at a separate location (e.g., at the breakpack goods interface locations 263L) from each access of the container transfer deck 130DC to the breakpack operation station 140 (e.g., at the common support surface 140S) for the container bot 110.

The autonomous guided container bots 110 may be any suitable independently operable autonomous transport vehicles that carry and transfer case units along the X and Y throughput axes throughout the storage and retrieval system 100. The autonomous guided container bots 110 may be automated, independent (e.g. free riding) autonomous transport vehicles. Suitable examples of bots can be found in, for exemplary purposes only, U.S. Pat. No. 10,822,168 issued on Nov. 3, 2020; U.S. Pat. No. 8,425, 173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2015; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The autonomous guided container bots 110 (described in greater detail below) may be configured to place case units, such as the above described retail merchandise, into picking stock in the one or more levels of the storage structure 130 and then selectively retrieve ordered case units. The throughput axes X and Y (e.g. pickface transport axes) of the storage array may be defined by the picking aisles 130A, at least one container transfer deck 130DC, the container bot 110 and the extendable end effector (as described herein) of the container bot 110 (and the extendable end effector of the lifts 150 may also, at least in part, define the Y throughput axis).

The pickfaces (which may include supply containers 265) are transported between an inbound section of the storage and retrieval system 100, where pickfaces inbound to the array are generated (such as, for example, input station 160IN) and a load fill section of the storage and retrieval system 100 (such as for example, output station 160UT or output station 160EC), where outbound pickfaces from the array are arranged to fill a load in accordance with a predetermined load fill order sequence or an individual fulfillment order(s) in accordance with a predetermined individual fulfillment order sequence. Pickfaces (e.g., of supply containers 265) may be transported between the storage spaces 130S and a load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence. Breakpack goods container(s) 264 (multiple breakpack goods containers may be arranged in and transported as a pickface) are transported between the storage spaces 130S and the load fill section and/or between the breakpack goods interface 263 of the breakpack module(s) 266 and the load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence.

Referring also to FIGS. 1A, 1B, 1C, and 2A the rack module array RMA (see FIGS. 1C and 2A) of the storage structure 130 includes vertical support members 1212 and horizontal support members 1200 (see FIGS. 1A and 1B) that define the high density automated storage array as will be described in greater detail below. Rails 1200S may be mounted to one or more of the vertical and horizontal support members 1212, 1200 in, for example, picking aisles 130A and be configured so that the autonomous guided container bots 110 ride along the rails 1200S through the picking aisles 130A. At least one side of at least one of the picking aisles 130A of at least one storage level 130L may have one or more storage shelves (e.g. formed by rails 1210, 1200 and slats 1210S).

Autonomous guided container bots 110 traversing a picking aisle 130A, at a corresponding storage level 130L, have access (e.g. for picking and placing case units and/or breakpack goods containers) to each storage space 130S that is available on each shelf, where each shelf (which shelves may be disposed on one or more storage levels located between adjacent vertically stacked storage levels 130L on one or more side(s) PAS1, PAS2 of the picking aisle 130A). Each storage space 130S of the one or more storage shelf levels is accessible by the container bot 110 from the rails 1200 (e.g. from a common picking aisle deck 1200S that corresponds with a container transfer deck 130DC on a respective storage level 130L).

Referring again to FIG. 2A each container transfer deck 130DC or storage level 130L includes one or more lift pickface interface/handoff stations TS (referred to herein as interface stations TS) where case unit(s) (e.g. individual case units, pickfaces, supply containers, etc.), totes and/or breakpack goods containers 264 are transferred between the lift load handling devices LHD and autonomous guided container bots 110 on the container transfer deck 130DC. The interface stations TS are located at a side of the container transfer deck 130DC opposite the picking aisles 130A and rack modules RM, so that the container transfer deck 130DC is interposed between the picking aisles and each interface station TS. As noted above, each container bot 110 on each picking level 130L has access (via a respective container transfer deck 130DC) to each storage location 130S, each picking aisle 130A, and each lift 150 on the respective storage level 130L, as such each container bot 110 also has access to each interface station TS on the respective level 130L. The interface stations TS may be offset from high-speed bot travel paths HSTP along the container transfer deck 130DC so that container bot 110 access to the interface stations TS is undeterministic to bot speed on the high speed travel paths HSTP. As such, each container bot 110 can move a case unit(s) (e.g. individual case units, pickfaces (built by the bot), supply containers, etc.), totes and/or breakpack goods containers 264 from every interface station TS to every storage space 130S corresponding to the deck level 130L and vice versa.

The interface stations TS may be configured for a passive transfer (e.g. handoff) of case units (e.g. individual case units, pickfaces, supply containers, etc.), totes and/or breakpack goods containers 264 between the container bot 110 and the load handing devices LHD of the lifts 150 (e.g. the interface stations TS have no moving parts for transporting the case units) which will be described in greater detail below. For example, also referring to FIG. 2B the interface stations TS and/or buffer stations BS include one or more stacked levels TL1, TL2 of transfer rack shelves RTS (e.g. the container bot 110 being configured to access each of the one or more stacked levels TL1, TL2) which may be substantially similar to the storage shelves described above (e.g. each being formed by rails 1210, 1200 and slats 1210S) such that container bot 110 handoff (e.g. pick and place) occurs in a passive manner substantially similar to that between the container bot 110 and the storage spaces 130S (as described herein) where the case units or totes are transferred to and from the shelves. The buffer stations BS on one or more of the stacked levels TL1, TL2 may serve as a handoff/interface station with respect to the load handling device LHD of the lift 150. Load handling device LHD (or lift) handoff (e.g. pick and place) of case units (e.g. individual case units, pickfaces, supply containers, etc.), totes and/or breakpack goods containers 264 to the stacked rack shelves RTS (and/or the single level rack shelves) occurs in a passive manner substantially similar to that between the container bot 110 and the storage spaces 130S (as described herein) where the case units, totes and/or breakpack goods containers 264 are transferred to and from the shelves. The shelves may include any suitable transfer arms for picking and placing case units, totes and/or breakpack goods containers 264 from one or more of the container bot 110 and load handling device LHD of the lift 150. Suitable examples of an interface station with an active transfer arm are described in, for example, U.S. Pat. No. 9,694,975 issued on Jul. 4, 2017, the disclosure of which is incorporated by reference herein in its entirety.

The location of the container bot 110 relative to the interface stations TS may occur in a manner substantially similar to bot location relative to the storage spaces 130S. For example, location of the container bot 110 relative to the storage spaces 130S and the interface stations TS may occur in a manner substantially similar to that described in U.S. Pat. No. 9,008,884 issued on Apr. 14, 2015 and U.S. Pat. No. 8,954,188 issued on Feb. 10, 2015, the disclosures of which are incorporated herein by reference in their entireties. For example, referring to FIGS. 1 and 1A, the container bot 110 includes one or more sensors 110S that detect the slats 1210S or a locating feature 130F (such as an aperture, reflective surface, RFID tag, etc.) disposed on/in the rail 1200. The Slats and/or locating features 130F are arranged so as to identify a location of the container bot 110 within the storage and retrieval system, relative to e.g. the storages spaces and/or interface stations TS. The container bot 110 may include a controller 110C that, for example, counts the slats 1210S to at least in part determine a location of the container bot 110 within the storage and retrieval system 100. The location features 130F may be arranged so as to form an absolute or incremental encoder which when detected by the container bot 110 provides for a container bot 110 location determination within the storage and retrieval system 100. The sensor 110S may be configured to localize the container bot 110 through any suitable image processing of images of case units disposed on the storage selves.

One or more peripheral buffer/handoff stations BS (substantially similar to the interface stations TS and referred to herein as buffer stations BS) may be located at the side of the container transfer deck 130DC opposite the picking aisles 130A and rack modules RM, so that the container transfer deck 130DC is interposed between the picking aisles and each buffer station BS. The peripheral buffer stations BS are interspersed between or, as shown in FIGS. 2A and 2B, otherwise in line with the interface stations TS. The peripheral buffer stations BS may be formed by rails 1210, 1200 and slats 1210S and are a continuation of (but a separate section of) the interface stations TS (e.g. the interface stations and the peripheral buffer stations are formed by common rails 1210, 1200). As such, the peripheral buffer stations BS may include one or more stacked levels TL1, TL2 of transfer rack shelves RTS as described above with respect to the interface stations TS, although the buffer stations may include a single level of transfer rack shelves. The peripheral buffer stations BS define buffers where case units/totes/breakpack goods containers and/or pickfaces are temporarily stored when being transferred from one container bot 110 to another different container bot 110 on the same storage level 130L as will be described in greater detail below. The peripheral buffer stations may be located at any suitable location of the storage and retrieval system including within the picking aisles 130A and anywhere along the container transfer deck 130DC.

Still referring to FIGS. 2A and 2B at least the interface stations TS may be located on an extension portion or pier 130BW (also referred to as a driveway) that extends from the container transfer deck 130DC, although a length of the interface stations TS may be arranged and extend along the container transfer deck. The pier 130BW may be similar to the picking aisles where the container bot 110 travels along rails 1200S affixed to horizontal support members 1200 (in a manner substantially similar to that described above). The travel surface of the pier 130BW may be substantially similar to that of the container transfer deck 130DC. Each pier 130BW is located at the side of the container transfer deck 130DC, such as a side that is opposite the picking aisles 130A and rack modules RM, so that the container transfer deck 130DC is interposed between the picking aisles and each pier 130BW. The pier(s) 130BW extends from the transfer deck at a non-zero angle relative to at least a portion of the high speed bot transport path HSTP. The pier(s) 130BW may extend from any suitable portion of the container transfer deck 130DC including the ends 130BE1, 130BE2 of the container transfer deck 130DCD. Peripheral buffer stations BSD (substantially similar to peripheral buffers stations BS described above) may also be located at least along a portion of the pier 130BW.

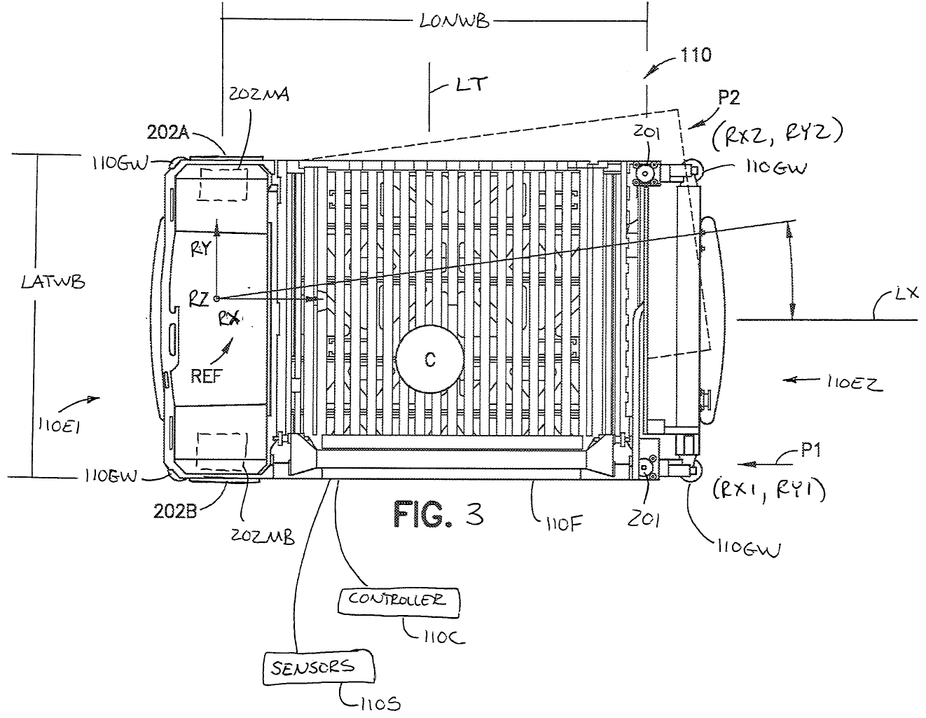

As described above, and referring to FIG. 3, the autonomous guided container bots 110 and the autonomous guided goods bots 262 are non-holonomic. For example, referring to the container bot 110 for exemplary purposes (noting the autonomous guided goods bots 262 have a similar non-holonomic configuration), the goods bot 110 includes two drive wheels 202A, 202B located on opposite sides of the bot 110 at end 110E1 (e.g. first longitudinal end) of the bot 110 for supporting the bot 110 on a suitable drive surface however, any suitable number of drive wheels are provided on the bot 110. Each drive wheel 202A, 202B may be coupled substantially directly to a respective motor 202MA, 202MB such that the drive wheel 202A, 202B is coupled to an output of the motor 202MA, 202MB without a speed reduction unit disposed therebetween (e.g. so that each motor 202MA, 202MB and the respective drive wheel 202A, 202B form a reductionless drive). Each drive wheel 202A, 202B is independently controlled so that the bot 110 may be steered through a differential rotation of the drive wheels 202A, 202B (e.g. differential torque steering), although the rotation of the drive wheels 202 may be coupled so as to rotate at substantially the same speed. Any suitable steering wheels 201 are mounted to the frame on opposite sides of the bot 110 at end 110E2 (e.g. second longitudinal end) of the bot 110 for supporting the bot 110 on the drive surface. The wheels 201 may be caster wheels that freely rotate allowing the bot 110 to pivot through differential rotation of the drive wheels 202 for non-holonomically changing a travel direction of the bot 110. The wheels 201 may be steerable wheels, such as for example articulated wheel steering, that turn under control of, for example, a bot controller 110C (which is configured to effect control of the bot 110 as described herein) for changing a travel direction of the bot 110. The bot 110 may include any suitable wheel arrangement (e.g. a three wheel configuration, a four wheel configuration, etc.). The bot 110 may include one or more guide wheels 110GW located at, for example, one or more corners of the frame 110F. The guide wheels 110GW may interface with the storage structure 130, such as guide rails 1200 (FIG. 1B) within the picking aisles 130A, guide rails (not shown) on the transfer deck 130B and/or at interface or transfer stations for interfacing with the lift modules 150 for guiding the bot 110 and/or positioning the bot 110 a predetermined distance from a location to/from which one or more case units are placed and/or picked up as described in, for example, U.S. Pat. No. 9,561,905 issued on Feb. 7, 2017, the disclosure of which is incorporated herein by reference in its entirety. Location of the bot 110 at the predetermined distance from a location to/from which one or more case units are placed and/or picked up may be effected in any suitable manner such as with sonar/sonic sensors, index or line following sensor, GPS sensors, inductive sensors, capacitive sensors, infrared sensors, computer vision sensors, etc. of the container bot 110 or any combination thereof.

As described herein, and referring to FIG. 4, the container transfer deck 130DC has an undeterministic transport surface 130BS on which the autonomous guided container bots 110 travel where the undeterministic transport surface 130BS has more than one juxtaposed travel direction or lane HSTP (which correspond at least in part to a guidance feature of navigation array 3000 that is disposed on the undeterministic transport surface 130BS) connecting the aisles 130A, transfer deck 130B, and the pier 130BW to each other. While the navigation array is described herein with respect to the container transfer deck 130DC, it is noted the breakpack goods transfer deck 130DG may be similar to the container transfer deck 130DC and include a respective navigation array 3000 having the features described herein with respect to the container transfer deck 130DC. As may be realized, the juxtaposed travel lanes (the terms “travel lane” and “direction” may be used interchangeably herein) are juxtaposed along a common undeterministic transport surface 130BS between opposing sides 130BD1, 130BD2 (see also FIG. 2A) of the transfer deck 130B. For example, FIG. 4 illustrates longitudinal lanes such as an aisle side travel lane LONG1, a lift side travel lane LONG3 and a pass through travel lane LONG2, but it should be understood that more or fewer travel lanes are provided. Juxtaposed lateral travel lanes, such as lanes LAT1-LAT7 may be arranged on the transfer deck 130B to allow bot traverse to and from picking aisles 130A, driveways 130BW, transfer stations TS, buffer stations BS, and/or any other suitable location of the storage and retrieval system that is accessed through a path that is transverse to the longitudinal lanes.

As can be seen in FIG. 4 the navigation array 3000 is illustrated, for exemplary purposes, as a grid of linearly distributed features. The linearly distributed features LDF include longitudinal features LONG1-LONG3 and lateral features LAT1-LAT7 where the longitudinal and lateral directions are relative to the transfer deck (e.g. the longitudinal features LONG1-LONG3 define at least one of the travel lanes HSTP and the lateral features LAT1-LAT7 define travel lanes HSTT that cross the travel lanes HSTP. The linearly distributed features LDF may allow for container bot 110 traverse between offset (parallel and/or crossing) travel lanes HSTP, HSTT in the storage structure 130 for entry into aisles 130A, driveways 130BW, buffer stations BS, transfer stations TS or any other suitable location at which the bot 110 performs an operation (transfer of cases, charging of the bot, bot induction into the storage structure, bot removal from the storage structure, etc.). The linearly distributed features LDF may also allow for bot traverse between crossing travel lanes HSTP, HSTT for entry into aisles 130A, piers 130BW, buffer stations BS, transfer stations TS or any other suitable location at which the bot 110 performs an operation (transfer of cases, charging of the bot, bot induction into the storage structure, bot removal from the storage structure, etc.) where when the bot 110 detects a linear distributed feature the bot 110 establishes a location of the bot 110 during travel as will be described in greater detail below. As may be realized, one or more of the aisles 130A and piers 130BW may be “dead ends” in that there is an entry into the aisle 130A or pier 130BW from the container transfer deck 130DC but there is no exit for the container bot from the aisle 130A or pier 130BW unless the container bot reverses direction and exits the aisle 130A or pier 130BW at the same point the bot entered the aisle 130A or pier 130BW (i.e., the aisle or pier has restricted access such that only a single point of ingress/egress to/from the aisle or pier exists).

The linearly distributed features LDF may connect the aisles 130A to each other, cross the aisles 130A, connect the aisles 130A to one or more of the transfer stations TS, the buffer stations BS and the piers 130BW or any combination thereof. As may be realized, one or more of the linearly distributed features LDF are substantially aligned with one or more of the interface between the transfer deck 130B and the aisles 130A, and the interface between the transfer deck 130B and the piers 130BW. As noted above, at least a portion of the linearly distributed features LDF may be substantially aligned with one or more bot traverse paths 3010 along the transfer deck 130B. It is noted that while the linearly distributed features LONG1-LONG3, LAT1-LAT7 are illustrated as forming an orthogonal grid, the longitudinal features LONG1-LONG3 and the lateral features LAT1-LAT7 may cross each other at any suitable angles. While three longitudinal features LONG1-LONG3 (defining, for example, at least in part three travel lanes HSTP) and seven lateral features LAT1-LAT7 (defining, for example, at least in part seven travel lanes HSTT), the transfer deck 130B may include any suitable number of longitudinal and lateral features LONG1-LONG3, LAT1-LAT7 defining at least in part any suitable number of travel lanes oriented in any suitable directions relative to the transfer deck 130B.

The linearly distributed features LDF may be formed of, for example, any suitable guide tapes, any suitable transfer deck 130B features (grooves, apertures, channels, etc.), and edge of the transfer deck 130B or any combination thereof. The linearly distributed features LDF may be uncoded (e.g. do not include identifying features such as for determining container bot 110 location), although the linearly distributed features may be coded (e.g. include or are formed of barcodes or other identifying indicia or features so as to provide for container bot 110 location determination). It is noted however, that the linearly distributed features are placed at predetermined locations on the transfer deck 130B to allow the bot to establish at least an estimated location of the container bot 110 while travelling at high speeds (as previously described) along the transfer deck 130B. With reference to FIG. 3, the spacing between juxtaposed linearly distributed features LDF is not dependent on container bot 110 dimensions or operational aspects, such as bot longitudinal wheelbase LONWB (where the container bot 110 has a longitudinal axis LX and a lateral axis LT), wheel track or lateral wheelbase LATWB, turn radius and bot width (in the lateral direction). The bot frame 110F, longitudinal wheelbase LONWB and lateral wheelbase LATWB may define a predetermined aspect (such as for example, a ratio of length to width) that provides the non-holonomic container bot 110 with a minimum turn radius (and/or minimum turn radius footprint defined by the outermost corners of the frame turning at the minimum turn radius). In one example, the spacing between juxtaposed travel lanes LONG1-LONG3, LAT1-LAT7 is such that it allows passage of two autonomous guided container bots 110 (travelling linearly) side by side on each lane but is less than the minimum turn radius of the non-holonomic container bot 110 for a 90° pivot turn (pivoting at the drive wheels 202—see FIG. 3, such as at a pivot location/axis disposed between the drive wheels 202A, 202B)). As such the outer lanes (e.g. the aisle side travel lane and the lift side travel lane and/or corresponding lanes at the ends 130BE1, 130BE2 of the container transfer deck 130DC) may be positioned close to the sides of the container transfer deck 130DC (by an amount just sufficient to allow the container bots 110 to travel along the travel lane) but less than the spacing required for the container bot 110 to make a 90° pivot turn (pivoting at the drive wheels 202—see FIG. 3). The position of the picking aisles 130A, the lift interfaces/transfer stations TS and buffers stations BS relative to the container transfer deck 130DC and each other are decoupled from bot 110 turn considerations.

It is noted that for descriptive purposes only, the intersections between the linearly distributed features are referred to as nodes ND so that the transfer deck surface 130BS and its associated features (e.g. the linearly disturbed features LDF) are represented as a grid (as described above) with an array of nodes. The nodes ND may be disposed at any suitable predetermined location on the longitudinal and/or lateral features LONG1-LONG3, LAT1-LAT7 (such as at an intersection) of the linearly distributed features LDF that may correspond, for example, to a feature of the storage structure 130 and/or navigation array 3000 (e.g. at a terminus to a storage aisle 130A, at a lift transfer station TS, an entry to a pier 130BW, at a buffer station BS or at any other suitable location of the container transfer deck 130DC). It should be understood that the concept of a node ND as used herein is to exemplify that the navigation array 3000 defines the linearly distributed features LDF which map out the container transfer deck 130DC in two dimensions where the array of nodes ND on the deck are associated with the longitudinal and lateral features LONG1-LONG3, LAT1-LAT7. As will be described in greater detail below, waypoints WP1-WP2 that lay along a container bot 110 travel path may be created at predetermined locations on the container transfer deck 130DC where one or more waypoints WP1-WP4 may coincide with one or more nodes ND and, as with the nodes ND, may be positioned on linearly distributed features LDF defining a respective linear direction. One or more of the waypoints WP1-WP4 may be located between nodes ND, be located offset from the nodes ND in any suitable direction, or be located offset from the linearly distributed features LDF in any suitable direction.

As described herein, the container bots 110 travel along time optimal paths and trajectories, examples of which are illustrated in FIG. 4 with respect to transport paths BTP-BTP3 where each of the transport paths embody respective trajectories. The transport path BTP includes waypoints WP1, WP2, WP3, and WP4. The transport path BTP2 includes waypoints WP5 and WP6. The transport path BPT3 includes waypoints WP6 and WP7. The transport paths may include straight paths, arcuate paths, compound paths forming shapes such as “S” shape curves, or any other combination of straight and arcuate paths. The time optimal paths and trajectories may be generated in any suitable manner such as the manner described in U.S. Pat. No. 11,760,570 issued on Sep. 19, 2023 the disclosure of which is incorporated herein by reference in its entirety. The time-optimal trajectories 990A-990n, 991A-991n, 992A-992n, 993A-993n, 994A-994n and respective time optimal paths embodied thereby allow the bot 110 to smoothly transition, while travelling at the high speeds described herein, along a smooth curved (curve, curves, or curvature is used generally herein to refer to traverse path lines with concave/convex shape, through the techniques applied herein are equally applicable to path lines with flat curves that will be expressly identified as such) path defined by the corresponding trajectory between two navigation features arranged along a common direction (e.g. such as between one or more of the longitudinal navigation features LONG1-LONG3 or between one or more of the lateral navigation features LAT1-LAT7) and/or between two navigation features that are arranged in different directions (e.g. such as between longitudinal navigation features LONG1-LONG3 and lateral navigation features LAT1-LAT7, see FIG. 4). The time-optimal trajectories 990A-990n, 991A-991n, 992A-992n, 993A-993n, 994A-994n, based on bot dynamic model(s), may be categorized or catalogued, in a table 6042T (such as stored in a memory 110M, 262M of the bot controller 110C, 262C of a respective autonomous guided container bot 110 and/or autonomous guided goods bot 262-see FIG. 4A), in any suitable manner. The trajectories may be according to their respective characteristics shown categorized according to linear length L, L1, . . . , Ln along the curved path defined by the corresponding trajectory where the length L, L1, . . . , Ln corresponds to a linear distance to be travelled by the bot 110 between positions P1 (RX1, RY1) and P2 (RX2, RY2) (sec FIGS. 3 and 4) defined within the bot 110 map coordinate system REF as specified in a bot motion command received from, for example, controller 120.

Referring now to FIGS. 4, 5A, and 5B, exemplary bot traverse paths of an exemplary container bot 110 are shown in accordance with the present disclosure. These transport paths may be for any suitable bot such as, for example, the container bots 110 and/or autonomous guided goods bots 262 described herein. As may also be realized the time-optimal trajectory or trajectories may be generated (in any suitable manner, such as described in U.S. Pat. No. 11,760,570, previously incorporated herein by reference in its entirety) for each of these exemplary traverse paths. It is noted that the term “traverse path” as used herein and depicted in the drawings refers to the physical traverse paths of the autonomous guided container bots 110 and/or autonomous guided goods bots 262 on/along the undeterministic surface 130BS defined by the open undeterministic container transfer deck 130DC (and similar undeterministic surface defined by the open and undeterministic goods deck 130DG) or floor between locations thereon. It is noted that the traverse paths may include one or more segments (such as those described herein with respect to FIGS. 4 and 4A) that are joined to each other to form the traverse path. The term “trajectory” of the traverse path includes kinematic properties of the respective autonomous guided container bot 110 and autonomous guided goods bot 262 such as, for example, acceleration, velocity, etc. moving along and defining the traverse path.

As described above, any suitable controller, such as controller 110C, 262C of the respective autonomous guided container bot 110 and autonomous guided goods bot 262, may be configured as a bang-bang controller for generating time-optimal motions of the bot 110 using maximum power of the respective autonomous guided container bot 110 and autonomous guided goods bot 262 drive section. It is noted the present disclosure allows for the generation of otherwise predetermined autonomous guided bot 110, 262 unparameterized autonomous guided bot 110, 262 trajectories having motor torque (e.g. maximum torque/peak usable torque) and/or boundary constraints for, e.g., different autonomous guided bot 110, 262 payload applications or any other velocity, acceleration, etc. constraints. The term unparameterized as used herein with respect to the generated trajectories means that the trajectory and traverse path characteristics are unconstrained as to the curve or shape of the trajectory (either with respect to time or in the position-velocity reference frame or space) such that a time-optimal trajectory shape is achieved within the noted constraints of available autonomous guided bot 110, 262 maximum motor torque (e.g., the desired maximum usable torque for the maximum available current from the autonomous guided bot 110, 262 power source, and other bot dynamic models (e.g., mass, moment of inertia, radius of drive wheels, drive wheel base, etc.) and initial and final inertial conditions). In accordance with the present disclosure, trajectories can be generated for each of the traverse path segments such that optimal (shortest) move times (e.g. autonomous guided bot 110, 262 traverse times between a starting point of the traverse path and an ending point of the traverse path) are achieved for given maximum drive torque constraints. Further, peak torque requirements for drive components, such as motors and/or gear boxes (if any), can be reduced (with or without shorter move times) leading to lower costs associated with the autonomous guided bot 110, 262, reduced size of the drive components, and/or increased life of the autonomous guided bot 110, 262.

As used herein, the term “smooth” or “smoothness” with respect to the generated trajectories refers to a continuous linear velocity along the curved traverse path over time. It is noted that a discontinuity in linear velocity is generally not practically achievable, given the autonomous guided bot 110, 262 inertial and dynamic characteristics at high and medium speeds, and undesired.

The time-optimal trajectories may be categorized based on autonomous guided bot 110, 262 dynamic model characteristics and/or other boundary conditions, such as a bot payload (e.g., empty or loaded bot), payload mass and/or size where more massive payloads and/or denser payloads (e.g., resulting in bot mass center eccentricity) may define larger radius/curved turns at the high speeds. The trajectories may be categorized based on one or more of a distance to be travelled by the autonomous guided bot 110, 262 and a payload weight/mass and/or size/mass distribution or payload density.

As may be realized from FIGS. 4 and 4A, there are different types of predetermined time-optimal dynamic model based trajectories that define different path curves the autonomous guided bot 110, 262 can dynamically select by the bot controller 110C, 262C (or any other suitable controller such as control server 120 or warehouse management system 2500) from, singly and/or in a dynamically selected combination applied consecutively or separated by a flat path line (see FIG. 4A), to follow from an initial position (with an initial static and/or on the fly pose) to a final position (with a final desired/resultant static and/or on the fly pose). The trajectories may be characterized by simple curves having any suitable shape such as a straight line, semi-circles and hook or “J” shapes, although the trajectories may be any suitable complex curves such as “S” shaped curves having multiple changes in direction or inflection points as described. For example, one type of time-optimal trajectory is a component time-optimal trajectory having curved portions and straight portions where the curved portions are compound curves or turns with one or more of a variable or constant turn radius/rate, constant or changing turn directions and simple turns. As another example of a time-optimal trajectory type, the characterizing path shapes of the time optimal trajectories are a simple turn (turning in one direction during the move) having one or more of a variable turn radius/rate (e.g., the trajectory of paths 991A-991n and 992A-992n illustrated in FIG. 4A) or constant turn radius/rate (e.g., the trajectory of paths 990A-990n illustrated in FIG. 4A) in a single direction. The different component time-optimal trajectories (e.g. simple and compound) may be joined to each other, end to end, to form a transport path BTP (e.g., as shown in FIG. 4, having a time-optimal trajectory characterized by an “S” shape (e.g., such as the trajectory of paths 993A-993n shown in FIG. 4A) combined with a time-optimal trajectory characterized by a simple curve/turn; although, a flat curve path trajectory (e.g., such as the trajectory of paths 994A-994n shown in FIG. 4A) may be joining the bending curve path trajectory) followed by the autonomous guided bot 110, 262.

Referring now to FIGS. 4, 4A, 5A and 5B, conventionally non-holonomic autonomous guided bot 110 traverse across the container transfer deck 130DC or a goods deck 130DG is facilitated by, for example (see FIG. 5A) line following where the guidelines are arranged in a grid pattern such that bot (autonomous guided vehicle) turns are limited to 90° turns where the 90° turns are made at nodes ND (e.g. crossing points) of the guidelines. As may be realized from the above, the high speed navigation of the autonomous guided bots 110, 262 described herein allows substantially unrestricted non-holonomic autonomous guided bot 110, 262 traverse (see FIG. 5B) along the undeterministic surface of a respective one of the open undeterministic container transfer deck 130DC and the open undeterministic breakpack goods transfer deck 130DG such the bot 110, 262 can travel from node to node without being restricted to making 90° turns at the nodes ND, thereby decreasing autonomous guided bot 110, 262 transfer/travel times across the respective container transfer deck 130DC and breakpack goods transfer deck 130DG. This allows the autonomous guided bot 110, 262 to travel at the speeds described herein while navigating the undeterministic surface of the respective container transfer deck 130DC and breakpack goods transfer deck 130DG and while making turns into the picking aisles 130A and/or lift interface areas such as the driveways 130BW or buffer/transfer stations located along a side of the container transfer deck 130DC (such as shown in FIGS. 2A-2C) or to breakpack stations 140 and breakpack goods interface location(s) 263L of a breakpack goods interface 263 of the breakpack goods transfer deck 130DG.

Referring to FIGS. 1, 7, and 8, as described herein, autonomous guided bot 110, 262 route planning may be effected by one or more of the controller 120 and warehouse management system 2500 (or any other suitable controller of the storage and retrieval system 100). Bot route planning will be described with respect to controller 120 for exemplary purposes only, where bot route planning may be effected in a similar manner when performed by the warehouse management system 2500.

FIG. 7 illustrates an example of path planning for three autonomous guided bots A, B, C accordance with the present disclosure (path planning may be performed for more or less than three autonomous guided bots, for example, planning may be performed for all autonomous guided bots of a respective fleet). In FIG. 7, the route for autonomous guided bot A has three legs A1, A2, A3 where the first route leg is active towards aisle 130AR1. The route for autonomous guided bot B has three legs B1, B2, B3 that are non-active route legs that are to be scheduled. As illustrated in FIG. 7, autonomous guided bot B starts its path in aisle 130AR1, traverses deeper into aisle 130AR1, picks a case unit CU, and then places the case unit CU in driveway 130BWR3. Autonomous guided bot C is located in driveway 130BWR3 and is to travel into aisle 130AR1 along two route legs C1, C2. Travel times are noted in FIG. 7 for the direct paths of each autonomous guided bot A, B, C, where for example, the travel time for autonomous guided bot A route leg A1 is 8 time units (5 time units on the container transfer deck 130DC and 3 time units in the aisle 130AR1. The time units will be referred to herein as seconds but any other suitable time units may be used.

As noted herein, to plan the paths of the autonomous guided bots A, B, C illustrated in FIG. 7, the multi-agent path finding algorithm resolver 120P, 2500P of the bot route planner 120RP, 2500RP applies the priority conditions and precedence constraints between conflicting autonomous guided bots 110, 262. The precedence constraints describe precedence between sequential successive tasks, or goals, in the series of tasks, or goals, of the at least one autonomous guided bot 110, 262 with respect to at least another sequential successive task, or goal, in the series of tasks, or goals, of another autonomous guided bot 110, 262 conflicting with the at least one autonomous guided bot 110, 262.

For example, to plan the paths of the autonomous guided bots A, B, C illustrated in FIG. 7, the multi-agent path finding algorithm resolver 120P, 2500P of the bot route planner 120RP, 2500RP determines (or otherwise recognizes) there is an active route leg A1 and initializes a stack with a root node with the following members: Priorities=InitialPriorities; Trajectories={ActiveTrajectoryOfA1}; and Conflicts={ }. Here, the InitialProperties has two sets: active route legs have highest priorities (A1, B1), (A1, C1); and priorities between same-bot route legs (A1, A2), (A2, A3), (B1, B2), (B2, B3), (C1, C2). In a first iteration of path planning, the multi-agent path finding algorithm resolver 120P, 2500P pops (e.g., removes from the stack) the root node and keeps planning route legs until a conflict is found (see the loop in FIG. 6 formed by Blocks 600, 605, 615, 625, 630). As an example, the multi-agent path finding algorithm resolver 120P, 2500P plans the route legs in the following order (e.g., given the above-noted members): route leg B1 starts at t=0 and ends at t=3; route leg C1 starts at t=0 and ends at t=4; as active route leg A1 has a higher precedence than route leg B2, route leg B2 starts at t=5 and ends at t=10; route leg C2 starts at t=4 and ends at t=28; route leg A2 starts at t=8 and ends at t=11; route leg B3 starts at t=10 and ends at t=25; and route leg A3 starts at t=11 and ends at t=22. In this example, there are no conflicts such that no child nodes are generated, and the solution is found (FIG. 6, Block 620) in one iteration. In the example, illustrated in FIG. 7, every route leg can start immediately except autonomous guided bot B will wait 2 seconds to start route leg B2 to avoid a conflict with autonomous guided bot A.

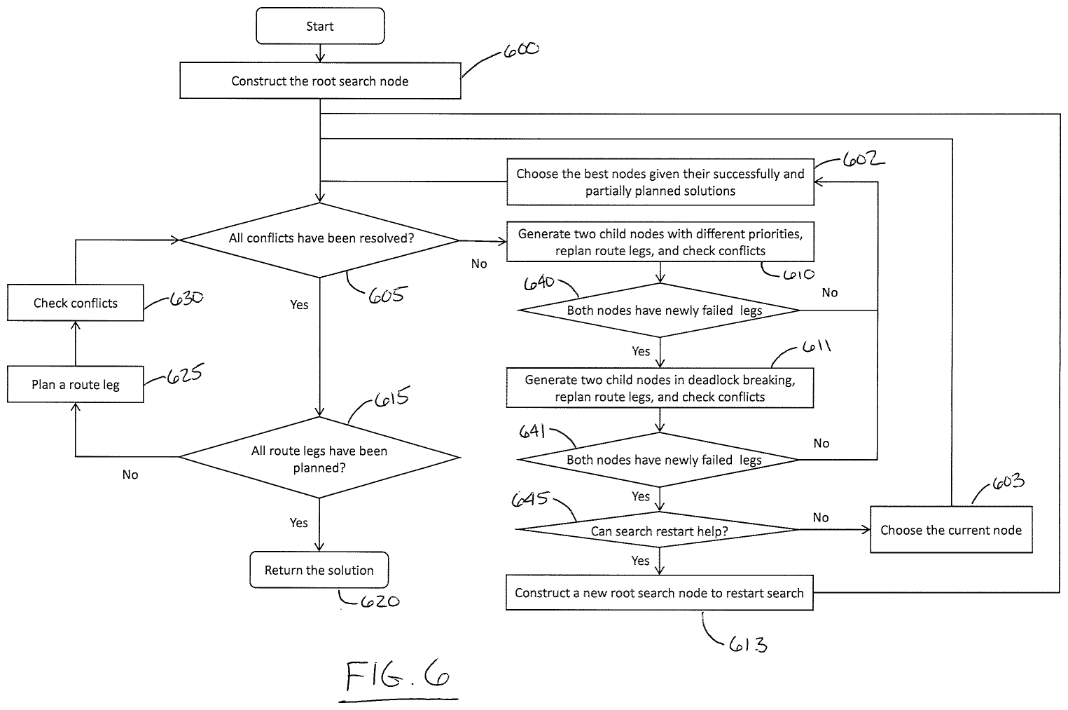

FIG. 8 illustrates another example of path planning for four autonomous guided bots A, B, C, D (again, path planning may be performed for more or less than rout autonomous guided bots) in accordance with the present disclosure. In this example, autonomous guided bot A has three route legs A1, A2, A3 and moves from aisle driveway 130BWR8 to aisle 130AR1 and then to driveway 130BWR2. Autonomous guided bot B has three route legs B1, B2, B3 and moves from driveway 130BWR7 to aisle 130AR1 and then to driveway 130BWR3. Autonomous guided bot C has two route legs C1, C2 and moves from aisle 130AR5 to driveway 130BWR4 and then to aisle 130AR1. Autonomous guided bot D has one route leg D1 and moves from aisle 130AR6 to driveway 130BWR4. The travel times for each route leg are illustrated in FIG. 8 alongside the respective route leg (e.g., in a manner similar to that of FIG. 7).

To plan the paths of the autonomous guided bots A, B, C, D illustrated in FIG. 8, the multi-agent path finding algorithm resolver 120P, 2500P of the bot route planner 120RP, 2500RP determines (or otherwise recognizes) there is no active route legs and initializes the stack with a root node with the following members: Priorities=InitialPriorities; Trajectories={ActiveTrajectoryOfA1}; and Conflicts={ }. Here, the InitialPriorities are priorities between same-bot route legs (A1, A2), (A2, A3), (B1, B2), (B2, B3), (C1, C2). In the first iteration of path planning, the multi-agent path finding algorithm resolver 120P, 2500P pops the root node and keeps planning route legs until at least one conflict is found. As an example, the multi-agent path finding algorithm resolver 120P, 2500P plans the following route legs in the order of: route leg A1 starts at t=0 and ends at t=8; route leg B1 starts at t=0 and ends at t=14; route leg C1 starts at t=0 and ends at t=5; route leg D1 starts at t=0 and ends at t=10; route leg C2 starts at t=5 and ends at t=25; and route leg starts at t=8 and ends at t=11. As can be seen route leg A2 collides with route leg B1.

As route leg A2 collides with route leg B1, the above-forward planning process terminates, child nodes are generated (FIG. 6, Block 610), and the conflict is resolved by adding priority constraints. Here, two child nodes are generated, where in the first of the child nodes, A2 has a higher priority where B1 is replanned to start at t=3 and end at t=17. In the second of the child nodes, B1 has a higher priority than A2 where n plan can be found under this priority. Here, the first child node is feasible, while the second child node is not feasible (FIG. 6, Block 612). The feasible child node (i.e., the first of the child nodes) is pushed to the stack.

With the first of the child nodes in the stack, the multi-agent path finding algorithm resolver 120P, 2500P pops the pushed child node and keeps planning route legs until a conflict is found. As an example, the multi-agent path finding algorithm resolver 120P, 2500P plans the following route legs in the order of: route leg A3 starts at t=11 and ends at t=23; route leg B2 starts at t=17 and ends at t=23; and route leg B3 starts at t=23 and ends at t=31. There are no additional conflicts between route legs and all route legs are planned. This solution was found in the second iteration and one child node was pushed to the stack. In this solution every route leg can start immediately except autonomous guided bot B will wait 3 seconds to start route leg B1 to avoid the conflict between route legs A2 and B1.

In accordance with the present disclosure, conflict checking (see, e.g., FIG. 6, Blocks 605, 630, 640, 641) of the route legs, such as (for non-limiting exemplary purposes) in the examples described above with respect to FIGS. 7 and 8, will be described. Conflict checking by the multi-agent path finding algorithm resolver 120P, 2500P of the bot route planner 120RP, 2500RP includes one or more of: a spatial conflict check to determine whether two autonomous guided bots 110, 262 visit the same spatial regions (e.g., of an aisle 130A, driveway 130BW, and/or transfer deck 130DC, 130DG) at the same time in their planned horizons (e.g., along their designated or otherwise expected to be planned route legs/paths/trajectories); a deadend conflict check where it is determined whether two trajectories will lead to unavoidable conflicts outside of the planning horizon of these two trajectories; and a conflict-at-idling check where it is determined whether a bot is idling when a conflict occurs. The expression “idling” as used herein is where an autonomous guided bot 110, 262 remains at a location for an unspecified prolonged amount of time until called on to execute a task after finishing all of its route legs or giving up all of its subsequent route legs. It is noted that idling is different from dwelling, and the latter, as used herein, is where an autonomous guided bot 110, 262 is performing an operation (such as a case unit transfer pick and/or place) for a requested/predetermined (finite) time period.

The problem of conflict checking is given as two trajectories of two route legs, e.g., route legs RL-A and RL-B, and their dwelling times after reaching their goals, respectively. The returned solution to the conflict check is one of no conflict or a conflict. The conflict is defined as (A, B, T) where A and B are the route legs whose given trajectories collide and T is the earliest conflict time. In resolving a conflict, a spatial (or earliest) conflict check is performed, such as by the multi-agent path finding algorithm resolver 120P, 2500P, to determine whether the two given trajectories sweep the same spatial region at the same time. The spatial conflict check iterates over a trajectory's spatial areas (for one of the autonomous guided bots 110, 262) ordered by their time stamps and checks whether the other autonomous guided bot 110, 262 also visits he same spatial area at the same time. The spatial conflict check terminates once all spatial areas are checked or a conflict is found. The earliest conflict time is recorded as time T. The time complexity of performing this spatial conflict check is linear to the total number of visited spatial regions.

Deadend conflict checking may also be performed by the multi-agent path finding algorithm resolver 120P, 2500P. For example, being free from conflict in two trajectories planned horizon (such as determined by the spatial conflict check) may not be sufficient to determine the two trajectories are acceptable for path planning purposes. For example, in some cases, the conflict free trajectories can lead to an unavoidable conflict in the future (i.e., after the autonomous guided bots 110, 262 travelling along the two trajectories reach their goals) resulting in a deadend for one of more of the two autonomous guided bots 110, 262.

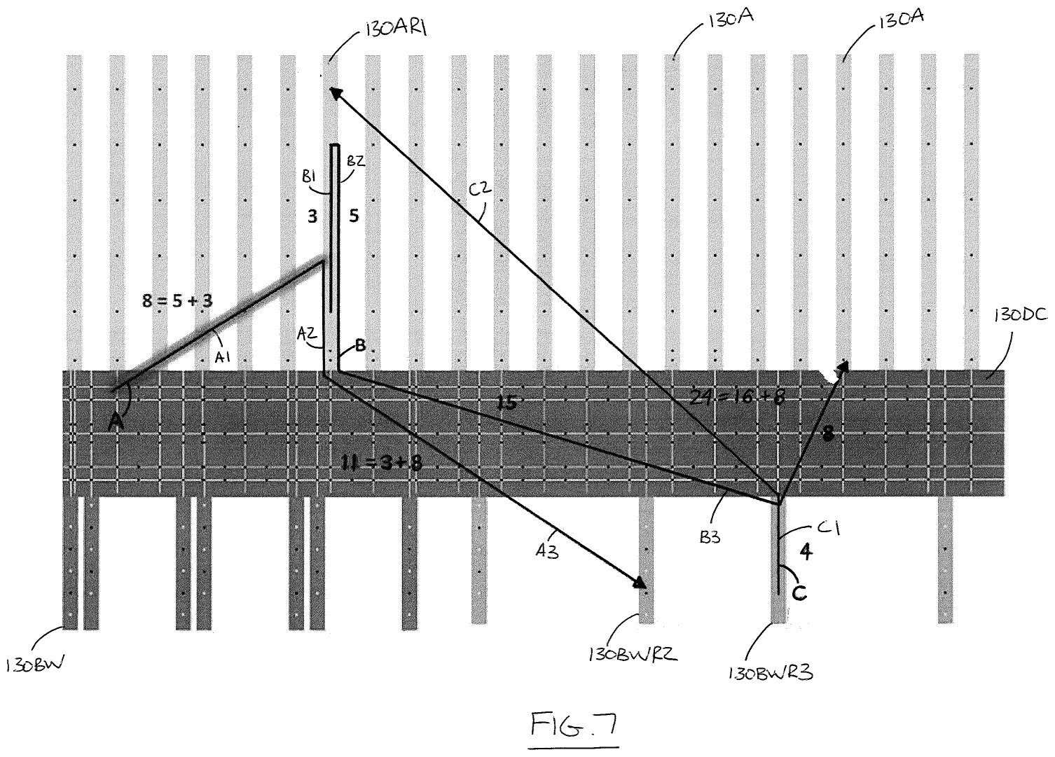

Referring to FIGS. 9A and 9B, an example of deadend-free trajectories and an example of trajectories with a deadend are respectively provided. In FIG. 9A, it takes 5 seconds for autonomous guided bot A to finish route leg A1 and 12 seconds for autonomous guided bot B to finish route leg B1. Here, if the two autonomous guided bots A, B start moving to their destinations immediately (i.e., at t=0), autonomous guided bot A as enough time to move out of the driveway 130BWR1 before autonomous guided bot B enters the same driveway 130BWR1. In FIG. 9B, the only difference in the trajectories is that the distance autonomous guided bot A travels into driveway 130BWR1 is deeper than that illustrated in FIG. 9A, such that it now takes autonomous guided bot A 8 seconds to finish the first route leg A1 and 12 seconds for autonomous guided bot B to finish the first route leg B1. However, after 8 seconds, autonomous guided bot B is already at the entrance to driveway 130BWR1 and will continue moving deeper into the driveway 130BWR1. Here, in the example illustrated in FIG. 9B, if the two autonomous guided bots A, B start moving immediately (i.e., at t=0), although they are conflict free in the first 8 seconds when autonomous guided bot A finishes the first route leg A1, the autonomous guided bots A, B will collide regardless of how autonomous guided bot A tries to avoid this conflict. In this example, autonomous guided bot B is trapping autonomous guided bot A into a deadend and the trajectories of route legs A1, B1 of the autonomous guided bots A, B are said to lead to an unavoidable future conflict (i.e., a deadend).

Given two trajectories of two autonomous guided bots (such as autonomous guided bots A, B of FIGS. 9A and 9B), the multi-agent path finding algorithm resolver 120P, 2500P may check for deadends by: finding the autonomous guided bot A, B whose trajectory ends later than the other autonomous guided bot's A, B trajectory (the autonomous guided bot whose trajectory ends later may be referred to as a “trapper bot” and the other autonomous guided bot referred as the “trapped bot”—in FIG. 9B autonomous guided bot B is the trapper bot and autonomous guided bot A is the trapped bot); and treating the trapper bot's trajectory as a dynamic obstacle. When treating the trapper bot's trajectory as a dynamic obstacle, the multi-agent path finding algorithm resolver 120P, 2500P verifies whether either of the following holds: the trapped bot can idle for an undetermined amount of time after completing its trajectory; and the trapped bot can move to some other aisle/driveway entrance and idle at this location for an undetermined amount of time. A single bot routing/planning function (as described herein) of the multi-agent path finding algorithm resolver 120P, 2500P is employed to perform the dynamic obstacle checks noted above and if either of the dynamic obstacle checks hold, the trapped bot can manage to be not caught by the trapper bot and the two trajectories are considered to be deadend free.

When performing a conflict-at-idling check, the multi-agent path finding algorithm resolver 120P, 2500P determines whether there is a conflict when one autonomous guided bot is idling at a location and another autonomous guided bot is moving towards that same location, or when two autonomous guided bots are idling at the same region. The multi-agent path finding algorithm resolver 120P, 2500P may treat two types of conflict-at-idling differently as if two autonomous guided bots are idling at the same region, giving cither autonomous guided bot a higher priority may not allow both autonomous guided bots to reach their goals because the high priority autonomous guided bot may occupy the region for an undetermined amount of time. Resolution of conflict-at-idling will be addressed in greater detail herein with respect to conflict resolution strategies.

In view of the above, the overall conflict check effected by the multi-agent path finding algorithm resolver 120P, 2500P is as follows: spatial (or earliest) conflict check is performed regardless of whether a conflict is detected during idling; deadend checking is performed if no (spatial/earliest) conflict is detected; and idling conflict is performed to determine whether two route legs will collide when one is idling. It is noted that autonomous guided bots may collide several times under two route legs (one route leg for each autonomous guided bot) however, the multiple collisions are treated as a single conflict and are resolved together. The time stamp for the multiple collisions is always the earliest conflict time except for the deadend, where the end time of the route leg is employed as the deadend happens out of the planned horizons.

The multi-agent path finding algorithm resolver 120P, 2500P is configured with conflict resolution strategies so as to determine which conflict to resolve first (as there can be multiple conflicts), and how to resolve a single conflict. With respect to the existence of multiple conflicts, the multi-agent path finding algorithm resolver 120P, 2500P may be configured to choose the conflict that happens the earliest for resolution, as the earlier conflict is more likely to affect the later conflicts (the later conflicts may disappear or need to be resolved again after resolving an earlier conflict). With respect to resolving a single conflict, the multi-agent path finding algorithm resolver 120P, 2500P may be configured for what may be referred as “normal conflict resolution” where priorities are specified between two route legs that are involved in the conflict. For example, the two child nodes are created where each child node gives one leg a higher priority than the other leg (i.e., child node one gives route leg A1 a higher priority than route leg B1 while child node two gives route leg B1 a higher priority than route leg A1). However, here there are two other different resolution cases (conflict resolution while bots are idling and deadlock breaking) that are addressed below.

When executing normal conflict resolution, the multi-agent path finding algorithm resolver 120P, 2500P resolves a conflict between two route legs (A, B). Here, the multi-agent path finding algorithm resolver 120P, 2500P generates two child nodes. The first child node has priority A>B (i.e., route leg A has a higher priority than route leg B) and the second child node as priority B>A (i.e., route leg B has a higher priority than route leg A). As described herein, the two child nodes inherit all the properties of their parents. For example, if the parent has priority C>A and C>B, then the first child node has priorities C>A, C>B, A>B and the second child node has priorities C>A, C>B, B>A. When determining normal conflict resolution, priority cycling may not occur such when priorities are specified, the higher-priority route legs and lower priority route legs are conflict-free except for recorded conflicts due to planning failure, which will be addressed herein.

For each child node, the multi-agent path finding algorithm resolver 120P, 2500P is configured to replan the route legs to ensure the route legs with priority relations are conflict free (see FIG. 6, Blocks 640, 641). Here, the low-priority route leg Low-RL is planned and all the route legs that satisfy the following are planned: the route leg has a lower priority than Low-RL, and the route leg's trajectory collides with LOW-RL or the route legs that have a higher priority than Low-RL. As noted above, a child node inherits its parent's priorities. As such, is A>B, then the route legs with a higher priority than A automatically gain higher priority over the route legs with lower priority than B. Here, a chain of route legs can be replanned to make sure they are conflict free.

Where a conflict happens between autonomous guided bots (such as autonomous guided bots A, B) when at least one of the autonomous guided bots A, B is idling assigning priorities to the autonomous guided bots A, B may not resolve the conflict (as noted above). Here, the conflict may be divided into two scenarios by the multi-agent path finding algorithm resolver 120P, 2500P. For example, a first of the scenarios is that both autonomous guided bots A, B idle at the same location and the second of the scenarios is that one autonomous guided bot A idles at a location while the other autonomous guided bot B, passes it or dwells for a while at the same location.

In the first scenario, one autonomous guided bot A, B that is idling and colliding is assigned to another destination to idle.

In the second scenario, the idling route leg of autonomous guided bot A is set to a high priority, such that the route leg (and its autonomous guided bot A) will prefer moving towards its destination and stay there for an undetermined amount of time; the low-priority autonomous guided bot B will try moving towards its destination before the high-priority route leg and move to somewhere else. The low-priority autonomous guided bot B may succeed if the low-priority autonomous guided bot B has enough time to get out of the destination aisle 130A/driveway 130BW while the high-priority autonomous guided bot A moves at full speed towards the same the destination aisle 130A/driveway 130BW. However, in most cases, the planning fails. Here, the multi-agent path finding algorithm resolver 120P, 2500P is configured to resolve the idling conflict by, while the lower-priority autonomous guided bot B is to avoid the higher-priority autonomous guided bot A, the higher-priority autonomous guided bot A accommodating the lower-priority autonomous guided bot B by moving to somewhere else after reaching its destination.

In the second scenario, with a conflict occurring while only one autonomous guided bot is idling, the multi-agent path finding algorithm resolver 120P, 2500P is configured to effect one of the following: assign the non-idling autonomous guided bot a higher priority such that the idling finds somewhere else to idle (the non-idling autonomous guided bot may succeed if the idling autonomous guided bot has enough time to get out of the aisle 130A/driveway 130BW while the non-idling autonomous guided bot moves at full speed towards the same aisle 130A/driveway 130BW); and assign the idling autonomous guided bot a higher priority (in addition, the idling autonomous guided bot should move somewhere else even if it has a higher priority because if the idling autonomous guided bot is not moving to another location the idling autonomous guided bot does not accommodate the low-priority non-idling autonomous guided bot and will block the only path for the non-idling autonomous guided bot).

Where a non-conflicting route leg plan cannot be found between the route legs for autonomous guided bots A, B given the priorities A>B or B>A, a deadlock exists. An example, of the deadlock is the example noted above where two autonomous guided bots A, B idle at the same destination. Other examples include, but are not limited to: two autonomous guided bots moving towards each other, and assigning any route leg of one autonomous guided bot with a high priority where another autonomous guided bot cannot manage to avoid conflicts. The multi-agent path finding algorithm resolver 120P, 2500P is configured to effect deadlock breaking (see FIG. 6, Block 611).

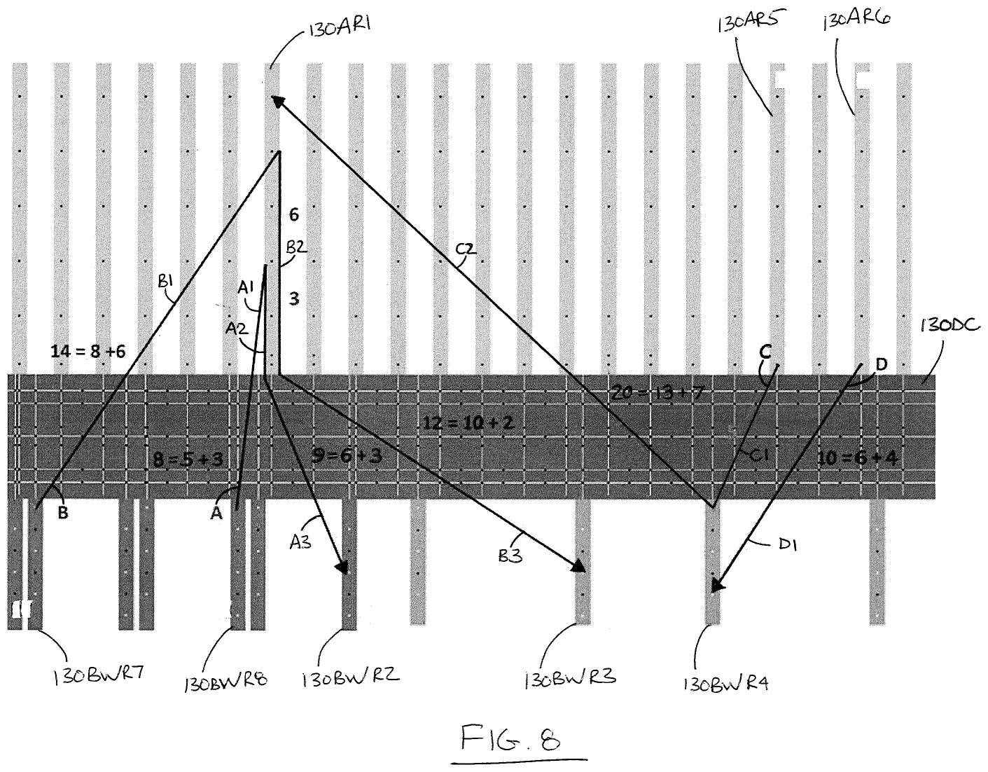

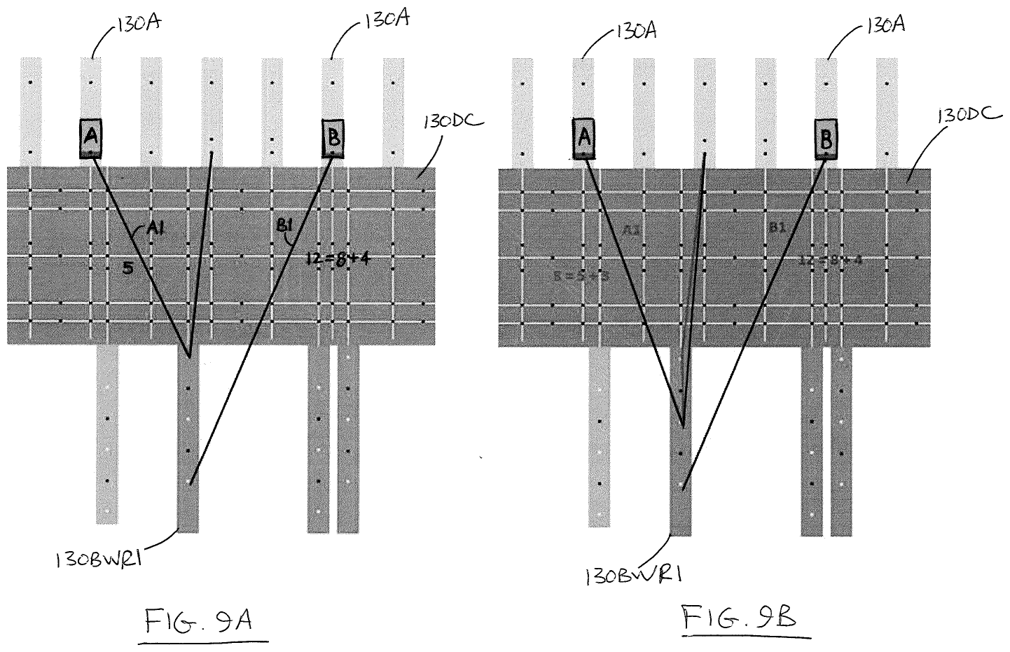

Referring to FIGS. 10A and 10B examples of transfer deck deadlock and aisle or driveway deadlock are respectively illustrated. As illustrated in FIG. 10A, autonomous guided bots A, B are disposed on the containers deck 130DC at the same location. Autonomous guided bot A is to travel to aisle 130AR2 along route leg A1 while autonomous guided bot B is to travel to aisle 130AR1 along route leg B1, where the autonomous guided bots A, B are blocking each other's path/trajectory resulting in a deadlock. As illustrated in FIG. 10B, both autonomous guided bots A, B are disposed in driveway 130BWR3. Autonomous guided bot A is to move deeper into the driveway 130BWR3 along route leg A1 while autonomous guided bot B is to move out of driveway 130BWR3 along route leg B1, where the route legs result in the autonomous guided bots A, B blocking each other's path/trajectory resulting in a deadlock. The multi-agent path finding algorithm resolver 120P, 2500P is configured to break deadlock such as those illustrated in FIGS. 10A and 10B by replanning the high-priority route leg and then replanning the low-priority route leg. In planning the high-priority route leg the multi-agent path finding algorithm resolver 120P, 2500P is configured to not visit the low-priority route leg's source pose (this means the region currently occupied by the autonomous guided bot belonging to the low-priority route leg is reserved as an obstacle for the high-priority route leg), and schedule the autonomous guided bot belonging to the high-priority route leg to move instead of scheduling the autonomous guided bot belonging to the high-priority route leg to remain idle. In scheduling the autonomous guided bot belonging to the high-priority route leg to move, if the autonomous guided bot is located in an aisle 130A or driveway 130BW the autonomous guided bot is moved out of the aisle 130A or driveway 130BW, or if the autonomous guided bot is located on a transfer deck (such as the containers deck 130DC) the autonomous guided bot is moved to an aisle 130A or driveway 130BW. It is noted that when breaking a deadlock, the autonomous guided bot belonging to the high-priority route leg is not forced to move such that if blocked by another autonomous guided bot that is not part of the deadlock, the autonomous guided bot belonging to the high-priority route leg may idle until the other autonomous guided bot (that is not part of the deadlock) is moved and traffic is clear to break the deadlock.

The multi-agent path finding algorithm resolver 120P, 2500P is configured to employ deadlock breaking when the normal conflict resolution is insufficient. However, where route legs of two autonomous guided bots 110, 262 start from the transfer deck (such as containers deck 130DC or goods deck 130DG) the multi-agent path finding algorithm resolver 120P, 2500P is configured to directly invoke deadlock braking rather than employ normal conflict resolution for the route legs (of the two autonomous guided bots 110, 262) that start from the transfer deck.

As noted herein, a single bot routing/planning function (as described herein) of the multi-agent path finding algorithm resolver 120P, 2500P is employed to perform dynamic obstacle checks. The single bot routing/planning function (referred to herein as single bot routing) configures the multi-agent path finding algorithm resolver 120P, 2500P to plan a trajectory for one autonomous guided bot 110, 262 (referred to as single bot routing) to reach its destination while avoiding conflict with autonomous guided bots 110, 262 having higher-priority route legs.

The single bot planning problem is given as <p, s, g, to, d, b, O, C, IDLE, PREFER_MOVE, LEAVE> where, p is the planning purpose (which can be IDLING or MOVING), s ε R³ is the source pose, g E R3 is the destination pose, to is the start time of the planning horizon (t=0 if this goal is the first goal; otherwise to equals the end time of the last planned goal of this autonomous guided bot), d ε R^{≥} is the dwell duration representing the time estimation of this autonomous guided bot's operation at the destination, b is the autonomous guided bot to plan, O is a set of occupancies (each occupancy being in the form of <SPATIAL_INDEX, τ, τ′>, the planned trajectory should not visit this SPATIAL_INDEX from time t to time τ′), C is a set of startup occupancies (which will be discussed below), IDLE ε {0, 1} indicates whether this autonomous guided bot is preferred to be moved or not, and LEAVE indicates whether this autonomous guided bot is forced to leave after reaching its goal and dwelling for a long enough time.

The planning result, of the single bot planning, is a pair <STATUS, P> where STATUS indicates the planning result status and P is a plan including the planned trajectories and other trajectory metrics. The STATUS may be SUCCESS, PARTIAL, or FAILURE. SUCCESS means a conflict-free, goal-reaching plan is successfully found. PARTIAL means a conflict-free plan is found but the goal is not reached. FAILURE means no conflict-free plan can be found and the returned path has conflicts with other autonomous guided bots 110, 262.

As examples, two different single bot planning problems will be described. The first is what may be referred to as planning to idle and the second is what may be referred to as planning to move. As described further herein, in the planning to move type of planning, the multi-agent path finding algorithm resolver 120P, 2500P considers planning a successful destination-reaching plan and then a partial plan that simply keeps the autonomous guided bot 110, 262 safe around the destination while giving up reaching the destination.

In the planning to idle type of planning, the purpose p is set to IDLING, which means the autonomous guided bot 110, 262 has finished all of its goals and is expected to safely idle at a current location or any other suitable location. To resolve planning to idle the multi-agent path finding algorithm resolver 120P, 2500P sets the source s equal to the destination d, the dwell duration is set to 0 (i.e., d=0) as there is no operation to perform, IDLE is set to 1 (true), and in this context LEAVE means idling somewhere other than the autonomous guided bot's current aisle 130A or driveway 130BW. With the aforementioned parameters set, the multi-agent path finding algorithm resolver 120P, 2500P executes a two-step planning procedure where if a conflict-free plan is found, this conflict-free plan is returned with STATUS=SUCCESS, and the planning is terminated. If no plan is found after executing the two steps, the STATUS is returned as FAILURE. Here, the two steps include:

If the autonomous guided bot 110, 262 is not forced to leave (i.e., LEAVE=0), the multi-agent path finding algorithm resolver 120P, 2500P plans for the autonomous guided bot 110, 262 to idle on the current aisle 130A or driveway 130BW. Where the autonomous guided bot 110, 262 does not stay on any aisle 130A or driveway 130BW (i.e., the autonomous guided bot is on the transfer deck, such as the container deck 130DC or goods deck 130DG), the multi-agent path finding algorithm resolver 120P, 2500P plans the autonomous guided bot 110, 262 to move to a closest aisle 130A or driveway 130BW.

If the autonomous guided bot 110, 262 is forced to leave or no conflict-free plan is found in the previous step, the multi-agent path finding algorithm resolver 120P, 2500P pans the autonomous guided bot 110, 262 to idle on other aisle 130A or driveway 130BW entrances around the source location. The entrances that are closer to the current location are tried first. Planning is terminated if a plan if found, or a certain number of entrance nodes have been tried.

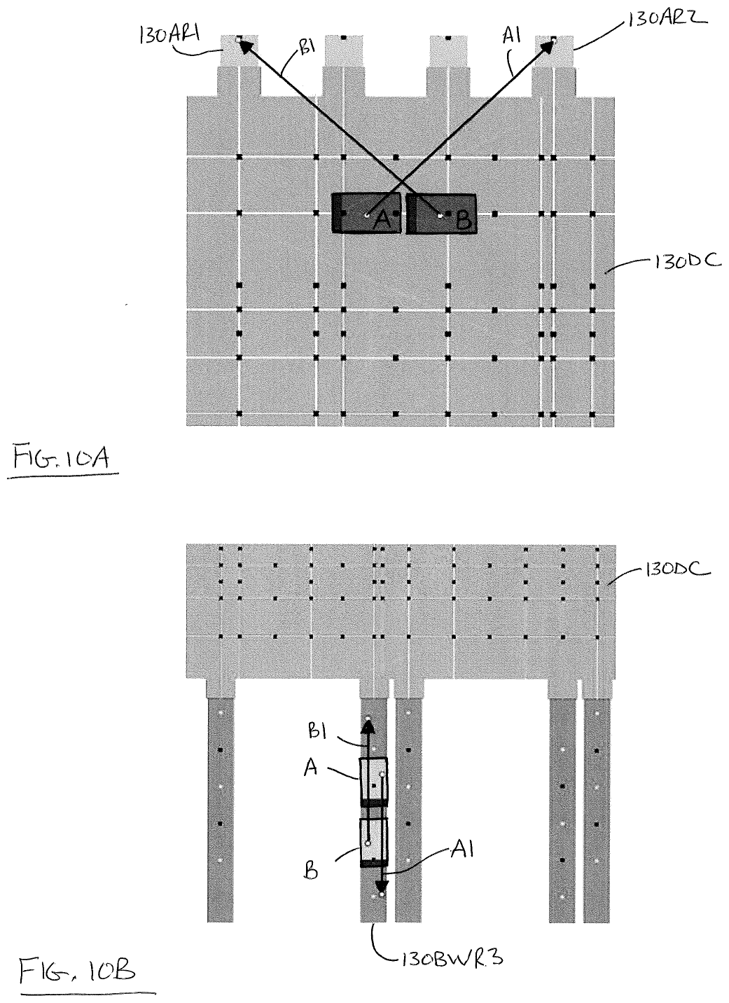

Referring to FIG. 11, an example of a planning to idle solution will be described. In this example, an autonomous guided bot 110 is disposed in aisle 130AR4 at node 2. Here, the multi-agent path finding algorithm resolver 120P, 2500P plans for the autonomous guided bot 110 to idle at the current location (i.e., node 2) or at some other location(s). The multi-agent path finding algorithm resolver 120P, 2500P determines whether the autonomous guided bot 110 can move and idle at node 1, which is the entrance to aisle 130AR4 and if not the multi-agent path finding algorithm resolver 120P, 2500P determines if the autonomous guided vehicle 110 can remain at node 2. If the autonomous guided bot 110 cannot idle at node 1 or remain at node 2, the multi-agent path finding algorithm resolver 120P, 2500P determines if the autonomous guided bot 110 an move to an entrance node and remain at the entrance node for an undetermined amount of time. The entrance nodes considered by the multi-agent path finding algorithm resolver 120P, 2500P are within a “neighborhood” of the current location (which in this case the current location is node 2). The neighborhood is defined as all entrances whose distance, from the entrance of the aisle (in this example, aisle 130AR4) in which the autonomous guided bot 110 is currently located, is within a predetermined neighborhood distance (which for exemplary purposes is set to about 10m but, the neighborhood distance may be larger or smaller than about 10 m). It is noted that the distances used in this example are Manhattan distances (i.e., a Manhattan distance is the sum of absolute differences between points across all the dimensions), but any other suitable distance measure may be employed. As illustrated in FIG. 11, there are eight nodes 1 and 3-9 representing the entrances of aisles 130AR1-130AR3, 130AR5-130AR7, and driveways 130BW8-130BW9 that are within the neighborhood of node 1 (i.e., the entrance of aisle 130AR4 in which the autonomous guided bot 110 is located). The node numbers indicate the planning order of the nodes in the neighborhood (i.e., node 1 gets planned before node 2, node 2 gets planned before node 3, etc.). Planning is terminated once a valid location to idle is found. It is noted that if LEAVE is set to 1 (i.e. LEVE=1), nodes 1 and 2 are skipped in the planning (as the autonomous guided bot 110 is to leave the source aisle 130AR4) and node 3 is the first to be considered.

In the planning to move type of planning, trajectories are planned for one autonomous guided bot to reach its destination while avoiding conflict with autonomous guided bots having higher-priority route legs. The planning to move type of planning the multi-agent path finding algorithm resolver 120P, 2500P plans the autonomous guided bot to move towards the destination (if a plan is found STATUS=SUCCESS is returned) and if a plan is not found, plans the autonomous guided bot to idle around (if a plan is found STATUS=PARTIAL is returned). Where a conflict-free plan is found after performing these two steps, the plan is returned and the planning is terminated. If a conflict-free plan is not found after performing these two steps STATUS=FAILURE is returned. Note that even where a FAILURE status is returned, a plan that indicates this bot will idle at the source pose will be returned and as such, autonomous guided bots with lower-priority route legs will avoid colliding with this failed, yet idling (staying) autonomous guided bot.

Where the STATUS=SUCCESS is returned, the corresponding plan may be considered a complete (planning) solution. Where the STATUS=PARTIAL is returned, the corresponding plan may be considered a partial (planning) solution. Here, the controller 120, 2500 is configured to command (at least one) autonomous guided bot 110, 262 to proceed along the resolved conflict free bot route based on the complete solution and/or the partial solution. Where the solution is a partial solution, and based on the controller 120 2500 command, the at least one autonomous guided bot 110, 262 proceeds along the at least one conflict free route leg of the partial solution, and the multi-agent path finding algorithm resolver 120P, 2500P continues the heuristic determination to complete the solution via best nodes of the heuristic.

In the planning to move type planning the multi-agent path finding algorithm resolver 120P, 2500P of the bot route planner 120RP, 2500RP is configured to effect an autonomous guided bot 110, 262 movement towards a destination by searching for a plan to directly move the autonomous guided bot 110, 262 to the destination by choosing the best avenue along which the autonomous guided bot 110, 262 reaches the destination soonest and can safely perform the specified goal/task (i.e., transfer operation) for a long enough time (i.e., dwell duration to complete the operation). Here, the planning stops if either of the following are satisfied: a direct plan is found, and the autonomous guided bot 110, 262 is planned to move towards the destination immediately (searching for a reroute plan may be omitted here as this non-delayed direct plan is a time optimal plan); and a direct plan is found and the autonomous guided bot 110, 262 is already within the neighborhood of the destination (searching for a reroute plan may be omitted here because the autonomous guided bot 110, 262 is already very close to the destination).

If a direct plan is not found the multi-agent path finding algorithm resolver 120P, 2500P searches for a reroute plan that reaches an aisle 130A or driveway 130BW entrance node and then moves directly to the destination (e.g., the destination being within the aisle 130A or driveway 130BW). Here, the multi-agent path finding algorithm resolver 120P, 2500P considers entrance nodes that are between the source location of the autonomous guided bot 110, 262 and the destination location where: the distance between the source and this entrance node is smaller than or equal to the distance between the source location and destination location, and the distance between the destination location and this entrance node is smaller than or equal to the distance between the source location and the destination location. Entrance nodes that are closer to the destination are tried first in the search for the reroute plan.

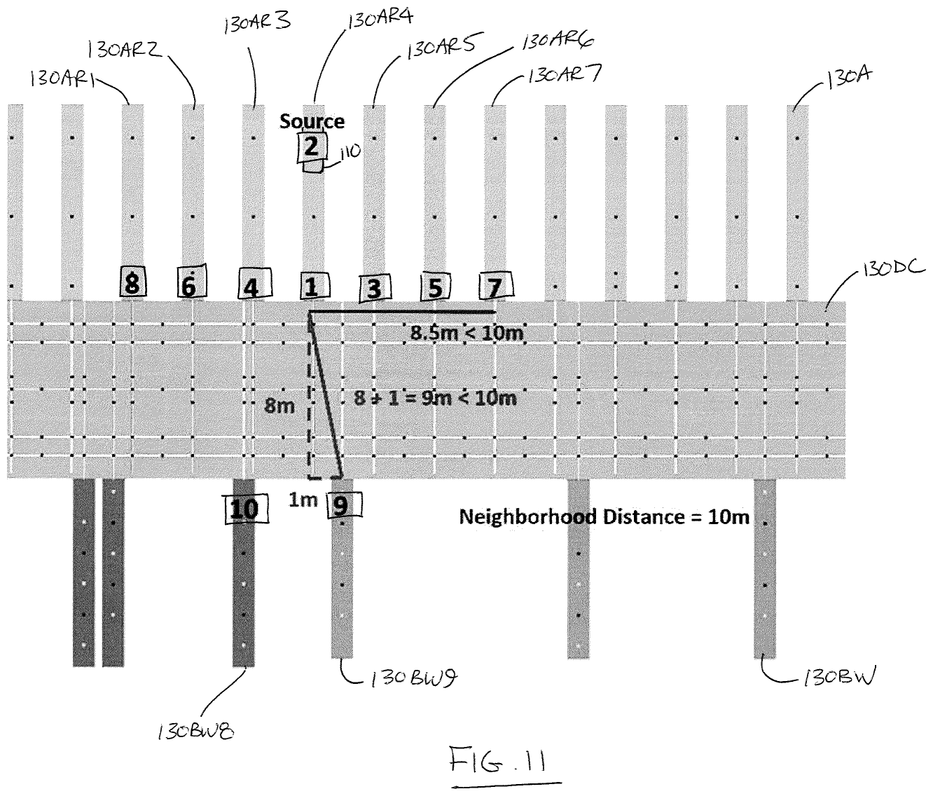

Referring to FIG. 12, an exemplary reroute plan is illustrated. As illustrated in FIG. 12, the autonomous guided bot 110 has its source location in aisle 130ARS and its destination location is in driveway 130BWD (while this example is provided for an autonomous guided bot on the containers deck 130DB the example is also applicable to planning routes on the goods deck 130DG). As a default, the multi-agent path finding algorithm resolver 120P, 2500P is configured to select the plan (from the available plans found) that reaches the destination soonest regardless of whether it is a direct plan or a reroute plan. As illustrated in FIG. 12, there are eight entrance nodes 1-8 within the neighborhood of the autonomous guided bot 110. A direct route exists between the source location and destination location of the autonomous guided bot 110 however, this direct plan may be unfeasible. As such, the multi-agent path finding algorithm resolver 120P, 2500P evaluates the entrance nodes for a reroute plan. Entrance node 3 may be the closest feasible entrance node to the destination and is selected by the multi-agent path finding algorithm resolver 120P, 2500P for the reroute plan.

In the planning to move type planning, if LEAVE is set to 1 (i.e., True), the multi-agent path finding algorithm resolver 120P, 2500P plans the autonomous guided bot 110, 262 to idle on aisle 130A or driveway 130BW entrances around the destination after the autonomous guided bot 110, 262 reaches the destination and dwells for the given amount of time (e.g., so as to perform the given goal or task). The whole planning to destination with LEAVE=1 succeeds where a conflict-free plan is found to idle on the other aisle 130A or driveway 130BW entrances.

It is noted that a destination may not always be reachable such that a feasible direct plan or feasible reroute plan is found. The destination may not be reasonable for several reasons, which include but are not limited to: an obstacle or dead (i.e., inoperable or immobilized) autonomous guided bots 110, 262 block the only path the destination, and a higher-priority autonomous guided bot 110, 262 is performing an operation at the destination of this autonomous guided bot 110, 262. In this instance the multi-agent path finding algorithm resolver 120P, 2500P may plan the autonomous guided bot to idle around a destination such that if a plan to idle is found, the plan is returned along with a STATUS=PARTIAL.

The multi-agent path finding algorithm resolver 120P, 2500P is configured to plan an autonomous guided bot 110, 262 to idle around a destination by selecting or otherwise determining a location for the autonomous guided bot 110, 262 to idle. Entrance nodes are preferred idle locations however, any suitable location of the transfer deck, aisle or driveway may be employed where such location does not hinder a path of another autonomous guided bot. determination of an idle location is made by the multi-agent path finding algorithm resolver 120P, 2500P based on a distance of the idle location from the source (this distance measures how far the autonomous guided bot will traverse to idle) and a distance from the destination (this distance measures how far the autonomous guided bot needs to travel to the destination after idling is finished). Referring to FIG. 13, given to idle location criteria noted above, three groups of entrance nodes are considered for idle locations.

One of the entrance node groups are those entrance nodes between the source and the destination. This group of entrance nodes may be referred as the inter-group of nodes and includes the nodes whose distances from the source location and from the destination location are less than the distance between the source location and the destination location (inclusive of the source node). If an autonomous guided bot 110, 262 can idle at its current aisle 130A (in this example, aisle 130ARS) or driveway 130BW location while being conflict free, the plan is a valid plan. This group of entrance nodes is evaluated by the multi-agent path finding algorithm resolver 120P, 2500P before other groups of entrance nodes because if the autonomous guided vehicle 110, 262 is idling there the autonomous guided vehicle 110, 262 may not have to detour from a direct path and the total traverse distance from the source location to the destination location is minimized. For exemplary purposes, entrance nodes 1-8 (inclusive of the source node) illustrated in FIG. 13 are included in the inter-group of nodes.

Another of the entrance node groups evaluated by the multi-agent path finding algorithm resolver 120P, 2500P is a group formed by entrance nodes around the destination location. This group of entrance nodes may be referred as the destination group of nodes and is evaluated next (e.g., after the inter-group of nodes) because, while the autonomous guided bot 110, 262 deviates or detours from a direct path, the autonomous guided bot 110, 262 makes the next most progress (relative to the inter-group of nodes) towards the destination. In the example illustrated in FIG. 13, entrance nodes 9-11 are included in the destination group of nodes.

Nodes forming a group around the source location (which may be referred to as the source group of nodes) is also evaluated by the multi-agent path finding algorithm resolver 120P, 2500P. The source group of nodes is evaluated after the destination group of nodes where such evaluation provides the autonomous guided bit 110, 262 a location to idle that avoids conflicts. In the example provided in FIG. 13, entrance nodes 12-14 are included in the source group of nodes.

The above noted groups of nodes are evaluated in the order noted by the multi-agent path finding algorithm resolver 120P, 2500P to plan the autonomous guided vehicle to idle. Within each group of nodes, the nodes are evaluated in an order from closest to destination location to farthest from the destination location (to place the autonomous bot as close to the destination location as possible), the exception being when the source node is evaluated first when the source node is within the group being evaluated and is within the neighborhood of the destination location.

In the present disclosure, conflict resolution between route legs (and autonomous guided bots belonging thereto) may include (as described herein) the creation of child search nodes. With the creation of child search nodes comes a heuristic selection (see, e.g., at least FIG. 6) as to which one of the child search nodes (the selected child search node may be referred to as a priority node) to employ for continuation of the conflict resolution. To select the priority node from the child search nodes the multi-agent path finding algorithm resolver 120P, 2500P is configured to evaluate the child nodes in the following manner. As described herein, the types of conflicts that may be resolved include a traverse bot conflict, an idle bot conflict, and a dead end bot conflict).

As noted herein, a returned plan can have one of four statuses: success, failure, partial, or no need to plan. It is noted that if a previous same-bot route leg is partially planned or failed, the following route legs for this bot need not be planned such that the STATUS of the plan for the following same-bot route legs is set to NoNeedToPlan.

When the multi-agent path finding algorithm resolver 120P, 2500P evaluates two child nodes, the following three metrics for the child nodes are compared one by one: the number of unresolvable conflicts (less is preferred), the number of failed route legs (less is preferred), and the total time of completing all tasks (i.e., flow time, where the time exceeding a predetermined finish time of every task contributes to the objective quadratically-less time is preferred).

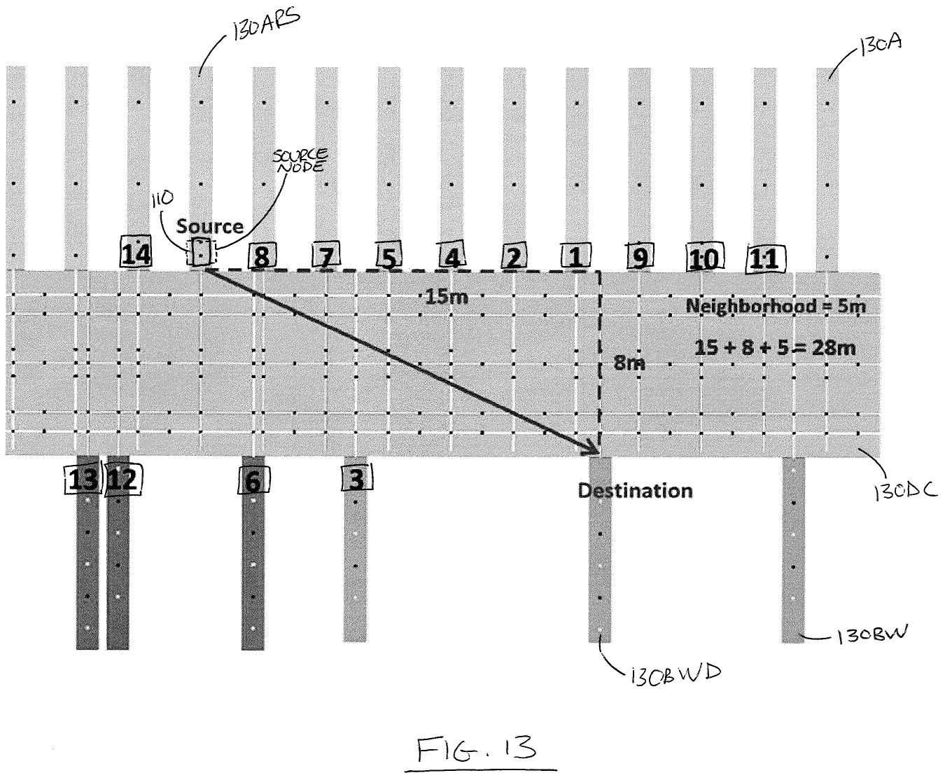

To evaluate the total time of completing all tasks the multi-agent path finding algorithm resolver 120P, 2500P sums the times of the planned trajectories. The multi-agent path finding algorithm resolver 120P, 2500P also evaluates how much progress a partial plan makes towards the destination location and how much of the bot path is left to schedule as a result of the partial plan. As an example, considering two partial plans that make different progress towards the destination the less progress the respective path makes, the shorter the time it takes to execute the respective partial plan. As such, comparing only the time it takes to execute the partial plan may not provide an optimal solution such that the multi-agent path finding algorithm resolver 120P, 2500P is instead configured to compare nodes with a good balance between the total time duration and the destination-reaching progress of the route legs of the two partial plans. Here, referring to FIG. 14, the multi-agent path finding algorithm resolver 120P, 2500P employs a weighted sum of the total time duration of the planned trajectories and the total duration estimations of the trajectory for the unplanned part. The multi-agent path finding algorithm resolver 120P, 2500P assigns different weights for planned trajectory durations and unplanned trajectory reference durations. As an example, the planned trajectory durations may have a weight of 1 while the unplanned trajectory reference durations may have a weight of 2.

In addition to the three metrics noted above for evaluating child nodes, the multi-agent path finding algorithm resolver 120P, 2500P may be configured to consider one or more of: a number of successfully planned route legs that will become active (with this metric solutions where more bots can greedily move and finish their current tasks will be favored), if a charge route leg is given a lower priority (here a penalty may be imposed since delaying in charge route legs may drain the electrical energy stored by the autonomous guided bot), and if a route leg from the transfer deck (such as the containers deck 130DC or goods deck 130DG) is given a lower priority (here a penalty is imposed because delaying this route leg will make an autonomous guided bot stay on the transfer deck for a longer period of time and may lead to increased bot traffic on the transfer deck).

As described above, conflict resolution may fail if the multi-agent path finding algorithm resolver 120P, 2500P cannot find conflict-free paths after employing the conflict resolution or deadlock breaking described herein. In a first example, conflict resolution may fail where the path execution of an active autonomous guided bot 110, 262 is abnormal and the active autonomous guided bot moves towards another autonomous guided bot 110, 262, and the other autonomous guided bot 110, 262 cannot avoid colliding with the active autonomous guided bot 110, 262. In a second example, in the parent node one autonomous guided bot 110, 262 may be pushed to move towards another autonomous guided bot 110, 262 under designated priorities where this conflict may fail to be resolved. The conflicts in the first example are unavoidable where the active route legs cannot be adjusted (i.e., priorities of the active route legs have not been decided) however, the multi-agent path finding algorithm resolver 120P, 2500P may be configured to mitigate conflicts such as described in the second example,

The failed instances of route planning can be summarized as having the condition: given the active route leg's trajectories, and the priority decisions made in the ancestor search nodes, none of the children can successfully resolve the current conflict. In a conventional priority based search, the priority based search is allowed to backtrack to mitigate failures however, backtracking will try every different priority combination in the worst case which makes the conventional priority based search exponentially complex and intractable. In accordance with the present disclosure the multi-agent path finding algorithm resolver 120P, 2500P employs a priority based search that is of a polynomial complexity to provide short resolution times (e.g., of about 200 milliseconds or less for a forty bot fleet or of about 100 milliseconds or less for the forty bot fleet). In the priority based search according to the present disclosure the multi-agent path finding algorithm resolver 120P, 2500P is configured to employ priority levels and search restarts in place of backtracking, where the priority level is a predetermined value defined by a user or otherwise preset in any suitable manner so as to balance between solution runtimes and planning failures (a higher maximum priority level provides for less failed routes at the expense of longer runtimes).

The priority levels are employed by the multi-agent path finding algorithm resolver 120P, 2500P (such as by a search restart module SRM thereof) for effecting a search restart. The priority levels affect the generation of child nodes in the search restart. Here, each route leg is assigned a priority level. Initially, the priority level of each route leg is zero, which is the lowest priority level. Every time a search is restarted, the priority level of a route leg is increased where in generating priorities to resolve conflicts, a route leg is given a higher priority if its priority level is not less than the priority level of the lower-priority route leg. For example, route legs A and B are involved in a conflict. The route legs A and B both have a priority level of 3, it may be specified that A>B or B>A. However, if A has level 2 priority and B has level 1 priority, it can only be specified that A>B because A's priority level is greater than B's priority level.

The multi-agent path finding algorithm resolver 120P, 2500P increases the priority levels of failed route legs when a search is restarted so that the failed route legs, now with a higher priority, are less likely to fail. The priority level of failed route legs is changed when a route leg is first planned and fails without any priority (here the priority of the failed route leg is changed to a maximum priority level to avoid assigning lower priorities to the failed route leg in the remaining planning process because in the first time of planning a route leg the route leg only has priority relations with active route legs and the failure means unavoidable conflicts with the active route legs-all other route legs are to avoid this failed route leg). The priority level of failed route legs may also be changed before restarting a search.

With failure of a conflict resolution (i.e., neither normal conflict resolution nor deadlock breaking can avoid a conflict), the multi-agent path finding algorithm resolver 120P, 2500P determines if a search restart may be effected (FIG. 6, Block 645) by: collecting all the failed route legs in the generated child nodes; for each collected failed route leg, check whether its priority level has reached the maximum priority level (if the route leg has reached the maximum priority level the route leg is discarded); for each collected failed route leg, the route leg is discarded if every higher-priority route leg of this route leg is either an active route or belongs to the same bot and the current collision resolution is not between this failed route leg and another route leg that has a higher priority level than this failed route leg (this means the child expansion is partial due to a lower priority level of the failed route leg); and if there are still failed route legs that have not been discarded there may be one or more failed route legs that may be successfully planned after a search restart.

With the remaining (non-discarded) failed route legs, a search restart is effected (FIG. 6, Block 613) by the multi-agent path finding algorithm resolver 120P, 2500P by: increasing the priority level of the remaining failed route legs; and reconstructing the root node by discarding all the planning results except the priority level information (here a new root node is pushed as the only node in the stack and searching for successful plans continues).

The multi-agent path finding algorithm resolver 120P, 2500P may be configured to effect a search restart if it is determined that a route leg has failed due to a conflict with a previous same-bot route leg. The runtime of the priority based search in accordance with the present disclosure may be decreased (e.g., sped up) by keeping the planning results of the route legs that no priority relations with the failed route legs when reconstructing root nodes.

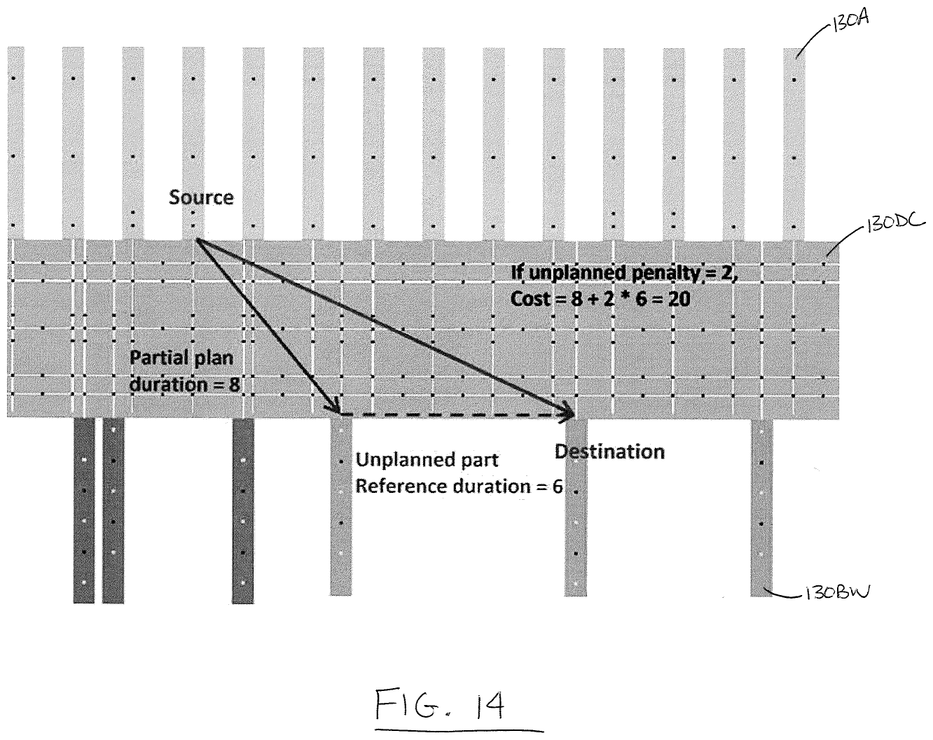

The multi-agent path finding algorithm resolver 120P, 2500P may be configured to determined where and when an autonomous guided bot 110, 262 is located by following a planned trajectory. The multi-agent path finding algorithm resolver 120P, 2500P may be configured to determine a list of occupancies and map the occupancies of a spatial region with respect to a time interval (a, b), which means a given autonomous guided bot 110, 262 occupies a spatial region from time t=a to time t=b. Here, with reference to FIG. 15, the multi-agent path finding algorithm resolver 120P, 2500P employs a time-space indexer (TSI) that divides the bot riding surfaces (e.g., of the transfer decks 130DC, 130DG, the aisles 130A and the driveways 130DW) of each storage level 130L into spatial units, where each spatial unit has an identical spatial size. Given a pose of an autonomous guided bot 110, 262, the multi-agent path finding algorithm resolver 120P, 2500P determines a subset of spatial units that the autonomous guided bot's 110, 262 perimeter intersects with, which represents the autonomous guided bot's 110, 262 occupied region (i.e., the spatial units occupied by the autonomous guided bot). Where a sequence of waypoints, along which the autonomous guided bot travels, are known (i.e., time stamped poses of the bot), the multi-agent path finding algorithm resolver 120P, 2500P determines the occupancies of the autonomous guided bot 110, 262 as the autonomous guided bot 110, 262 follows the waypoint sequence.

A naïve approach that may be employed by the multi-agent path finding algorithm resolver 120P, 2500P to determine or otherwise calculate the occupancies of a trajectory (i.e., sequence of waypoints) is: the occupied region ID indices at pose p are determined for every waypoint (pose p, time T) where this set of occupied region ID indices is equal to {Id1, Id2, Id3 . . . }. For each time space index Id there is an occupancy (Id, (T−τ, T+τ)), which means the autonomous guided bot 110, 262 occupies the region represented by Id from time t=(T″τ) to time t=(T+τ), where t is a positive value and is called the time padding. Here, (T−τ, T+τ) is called a reservation interval. A time padding is a predetermined value that is set by a user or in any suitable manner. As an example, the time padding may be set to about 1 second, although the time padding may be more or less than about 1 second. The above determination is repeated for each waypoint where the overlapped occupancy regions are aggregated to form a set of occupancies of the trajectory.

The time padding may serve to increase the time interval around a time stamp to visit a region as it takes an autonomous guided bot 110, 262 a non-zero duration from stepping into a region and leaving the same region. The time padding may also account for various execution uncertainties where the actual bot trajectory is not the same as the theoretical/reference trajectory. For example, an autonomous guided bot 110, 262 can arrive at a desired pose sooner or later than the time specified for the arrival. The difference between the actual trajectory and the reference trajectory may be referred to as trajectory error. A larger time padding provides a larger reservation interval for a given trajectory so that scheduled trajectories are more robust to execution errors compared to trajectories to which the time padding is not applied.

The time padding may be adaptively or dynamically determined by the multi-agent path finding algorithm resolver 120P, 2500P. To adaptively determine the time padding the multi-agent path finding algorithm resolver 120P, 2500P evaluates: estimation errors (the autonomous guided bot statues reported may be inaccurate); execution errors (autonomous guided bots may move faster or slower than expected due to discrepancies between a bot model and the actual physical bot-the difference between the planned bot trajectory and the actual bot trajectory is the execution error); and planning and communication delays (where it takes time to observe bot statuses and process other information, such as task assignments, before a planning request is executed, and it takes time to plan trajectories and communicate them before the autonomous guided bot controller receives the reference trajectories).

With respect to execution error, given a planned trajectory (in the form of a sequence of waypoints) the controller 120, 2500 (or bot controller 110C, 262C) will actuate a respective autonomous guided bot 110, 262 to reach the given waypoints at given times specified for each waypoint. Generally, the actual trajectories differ from the planned trajectories (e.g., at least for the exemplary reasons noted herein) such that all potential planned trajectories are grouped into a reachability envelope. The reachability envelope is a function of time and maps a time point to all the possible bot states at that time point (i.e., cross section).

Leverage reachability analysis tools (such as described in Jingkai Chen, et al., “Scalable and safe multi-agent motion planning with nonlinear dynamics and bounded disturbances,” Proceedings of the AAAI Conference on Artificial Intelligence, Vol. 35, No. 13, 2021, the contents of which are incorporated herein by reference in its entirety) may be employed to determine the reachability envelopes. The reachability envelopes effect determination of when an autonomous guided bot 110, 262 can be in a spatial region, which provides accurate reservation intervals and time padding at each spatial region.

The reachability envelopes may be determined (i.e., in lieu of the leverage reachability analysis tools) by providing spatial regions that are to be occupied at later times (i.e., in the future) with a larger time padding (i.e., the further into the future the spatial region to be occupied, the larger the time padding). For example, a parameter “TimePaddingRatePerSecondMs” (RPS) is provided, which means every second further into the future, the time reservation is increased with the value of RPS. For every time space index Id visited at time T, the time reservation may be specified as:

$$( T - τ - T * RPS , T + τ + T * RPS )$$

Noting that an active route leg's occupancy gets smaller over time because the longer the active route leg executes, the shorter the remaining trajectory is, which leads to uncertainty. For exemplary purposes, the value of RPS may be set to about sixty milliseconds per second, although the value of RPS may be greater or less than about sixty milliseconds per second.

Planning and communication delays (referred to herein as communication delays) are also considered by the multi-agent path finding algorithm resolver 120P, 2500P of the bot route planner 120RP, 2500RP in determining or otherwise calculating time reservations. As noted herein, time is needed to observe bot states, send information over the network 180 to and from the controller 120, 2500, plan trajectories and send trajectories to the autonomous guided bot controller 110C, 262C before the autonomous guided bot 110, 262 is actuated for goods transfer.

The two time points of estimating the bot status (e.g., poses) by the bot route planner 120RP, 2500RP and the time the controller (such as controller 120, 2500 and/or bot controller 110C, 262C) receives waypoints and actuates the respective autonomous guided bots 110, 262 for goods transfer.

A naïve method to account for communication delays is for the route planner 120RP, 2500RP to predict the time duration between the two time points by employing a fixed time value, and during planning and scheduling, the predicted poses for active autonomous guided bots 110, 262 are obtained by the route planner 120RP, 2500RP after the fixed time value and route planning is performed. As an example, the fixed time value may be set to about 100 ms but may be more or less than about 100 ms.

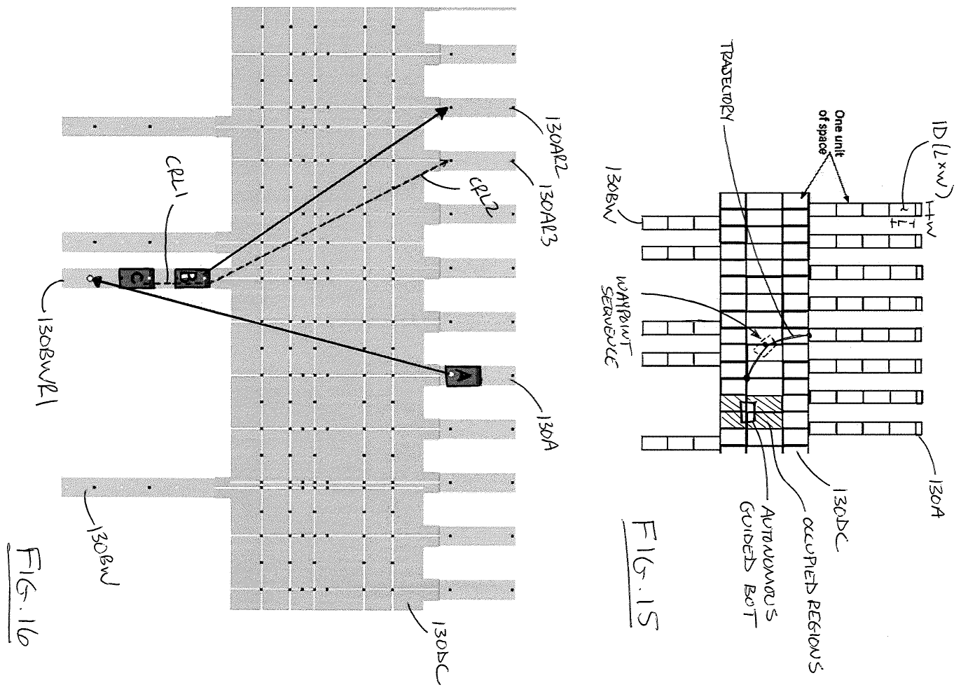

Referring to FIG. 16 as example employing three autonomous guided bots A, B, C will be described. Here, autonomous guided bot A is to enter the driveway 130BWR1. The other two autonomous guided bots B, C are within the driveway 130BWR1 and are to move out of the driveway 130BWR1 respectively into aisles 130AR2, 130AR3. A candidate routing plan is to have autonomous guided bot A and autonomous guided bot B start moving immediately (t=0) to their destinations directly while autonomous guided bot C's two route legs CRL1, CRL2 are scheduled to execute later but will not be activated immediately. In this candidate plan, the open time window of autonomous guided bot C's first route leg CRL1 is [1, 1.3], which means autonomous guided bot C can safely move out of the driveway 130BER1 after 1 second and before 1.3 seconds from the time autonomous guided bots A, B start to move (e.g., from t=0).

However, the time window [1, 1.3] may be missed if no planning cycle is invoked from t=1 to t=1.3 (e.g., the closest planning cycle gets invoked at t=0.9 and t=1.4). If a route leg gets scheduled in further into the future, it is more likely that the route leg's scheduled plan will be invalid at the scheduled future time as waypoints may be communicated to the autonomous guided bots when they are ready to be executed. To avoid the situation where the future scheduled route leg becomes invalid, the bot route planner 120RP, 2500RP is configured to one or more of adjust active route leg trajectories (e.g., slowing down or speeding up bots) to make sure their scheduled route legs are still schedulable, and apply a time padding for scheduled but non-active route legs.

To apply the time padding for scheduled but non-active route legs, the bot route planner 120RP, 2500RP is configured to adjust an upper bound of the time reservation by employing a predetermined parameter (e.g., the predetermined parameter being set by a user or set in any other suitable manner) referred to as the TimePaddingRatePerPlanStepMs (RPP). By adjusting the upper bound time padding, the autonomous guided bot 110, 262 is allowed to activate its currently scheduled trajectory with a certain amount of delay. Here, if a route leg will not be active immediately, we adjust the upper bound of its time reservation as follows:

$$( T - τ - T * RPS , T + τ + T * RPS + RPP ) .$$

RPP is added where a route leg is the first route leg of an autonomous guided bot 110, 262 (the first route leg is planned without RPP in single bot routing, and where a route leg is determined to be delayed, RPP is added and the delayed route leg is rescheduled), and/or RPP is added to a route leg is not the first route leg of this autonomous guided bot 110, 262. As an example, RRP may be set to about 500 ms (although RRP may be more or less than about 500 ms).

In the example illustrated in FIG. 16, with RRP employed in the time padding of the upper bound of the time reservation for autonomous guided bot A to start moving (i.e., bot A may not be active immediately and is delayed for 500 ms), leaving enough “slack” or “padded” time for autonomous guided bot C to accommodate a communication delay in the transmission of waypoints while maintaining valid route legs CRL1, CRL2.

It is noted that time padding may be inherited from previous same-bot plans. For example, for each route leg, the route planner 120RP, 2500RP records the end time padding (of the route leg) in the form of lower bound, upper bound) as employs this as the initial time padding for the next route leg of the same autonomous guided bot 110, 262. Still referring to FIG. 16, autonomous guided bot C has two route legs CRL1, CRL2. The first route leg CRL1 start time padding can be (−τ, +τ) by default (e.g., such as (−1, 1), although any suitable padding may be employed). As an example, the first route leg may be delayed and the first route leg CRL1 trajectory duration is T1, then the time padding will be:

$$( - τ - T * RPS , τ + T * RPS + RPP )$$

where this lower bound becomes the initial time padding for the next route leg CRL2 and keeps bloating if there is any delay or long trajectory duration. It is noted that RPP may be added twice to the route leg CRL2 reservation interval if the previous route leg CRL1 gets delayed. As may be realized, the values of RPP and RPS may be tuned or otherwise adjusted to balance throughput performance with respect to failed route legs and a collision avoidance system intervention times (the collision avoidance system being of the autonomous guided bots 110, 262, such as described in U.S. Pat. No. 8,594,835 issued on Nov. 26, 2013, the disclosure of which is incorporated herein by reference in its entirety).

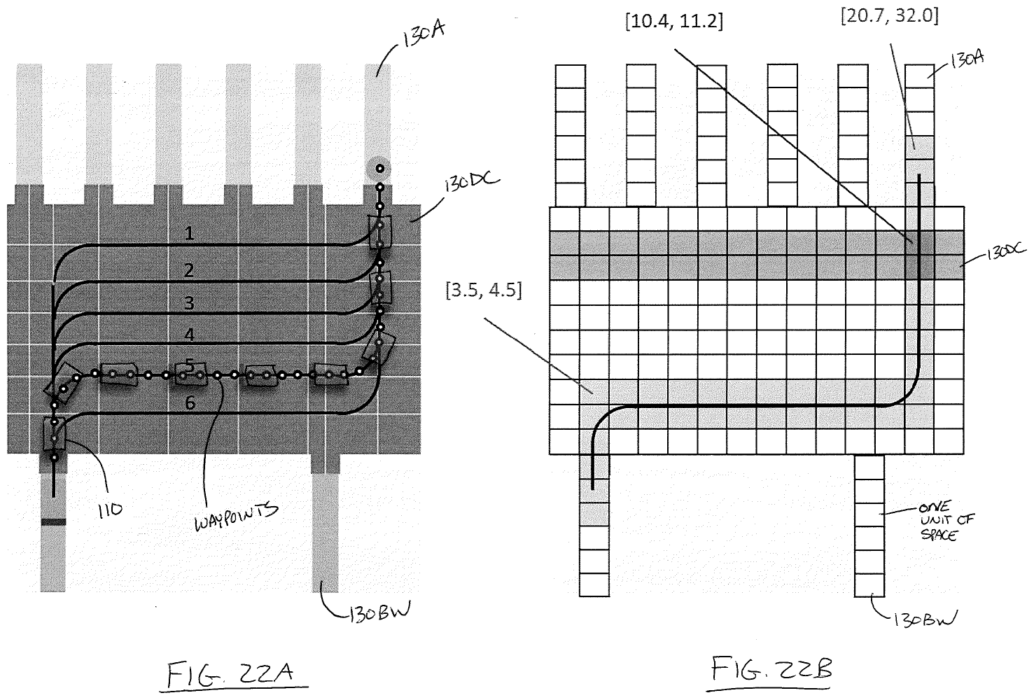

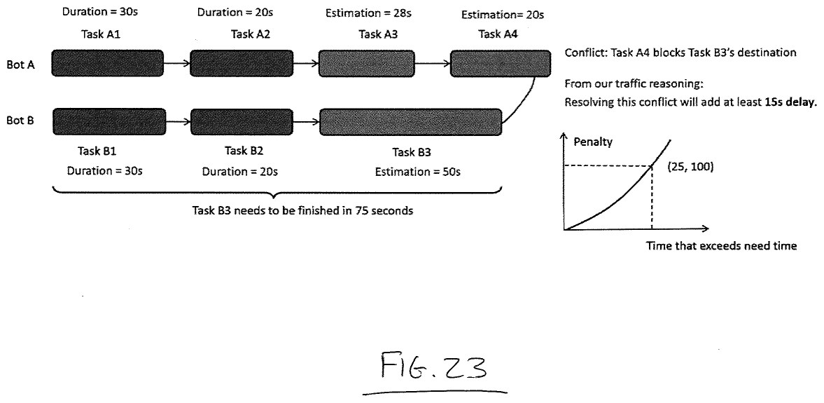

Referring to FIGS. 22A and 22B the routing of the autonomous guided bots 110, 262 may be effected with risk-aware routing with high fidelity models. Such models are illustrated in FIGS. 22A and 22B. FIG. 22A is an exemplary enumeration of all trajectories of an autonomous guided bot 110, 262 under real dynamics, where each is interpolated to high-fidelity timed waypoints. Here, time intervals for the autonomous guided bot 110, 262 to visit a map region are stored by, for example, the bot route planner 120RP, 2500RP or controller 120, 2500, as time-space reservations, where planning is effected by finding the earliest arrival time by checking against higher-priority tasks' reservations. The intervals in the reservations are also uncertainty aware where: for actuation or communication delay, their reservation bounds are properly adjusted; as autonomous guided bots 110, 262 can accumulate execution deviation, their reservations are extended in the beginning but also adjusted with respect to the latest autonomous guided bot pose estimations over time; for high-risk moves (e.g., two autonomous guided bots make turns and are head-to-head), their reservations are properly extended; and uncertainty and reservations adjustments are driven by data collected from daily execution in real-world warehouses.

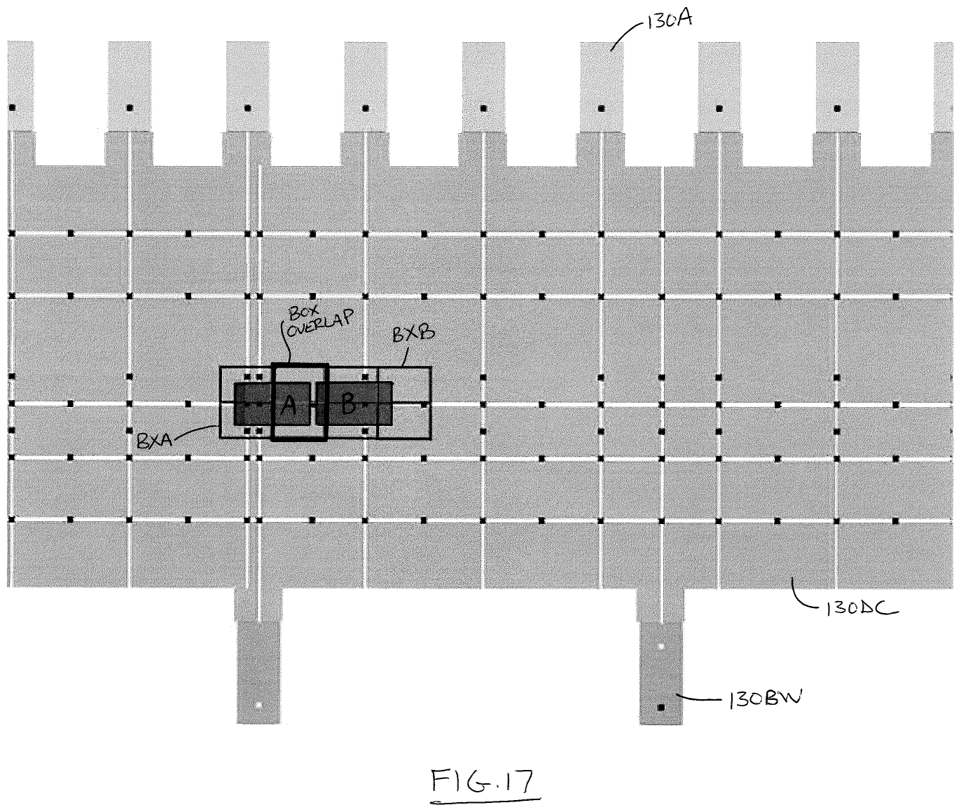

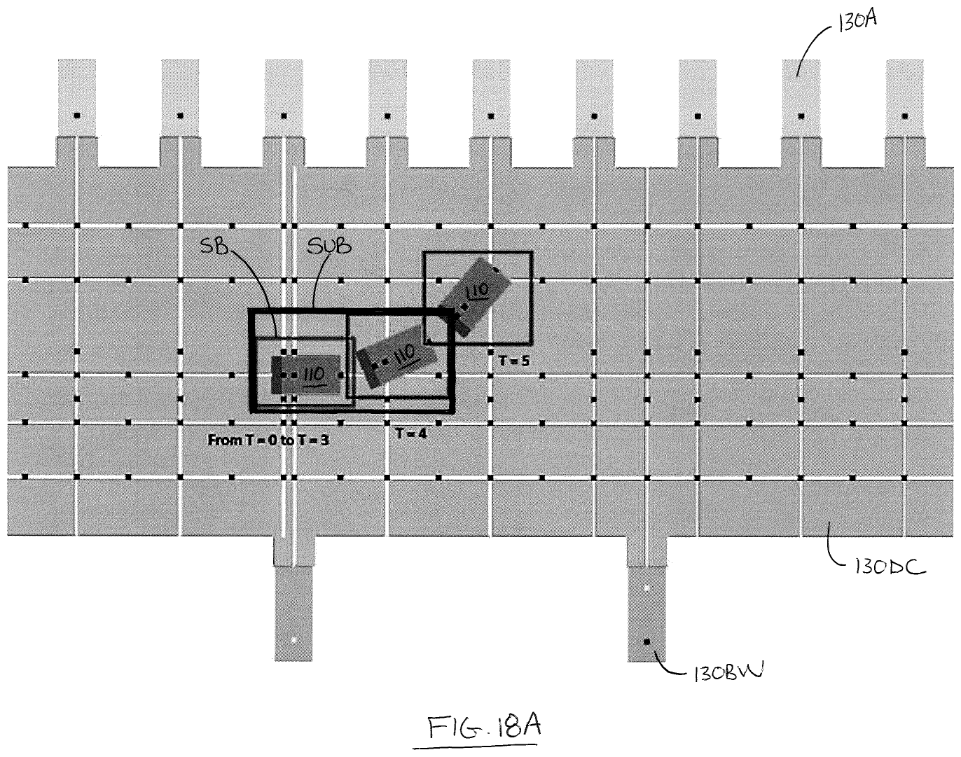

Referring to FIGS. 17 and 18A-18C startup occupancy determinations made by the bot route planner 120RP, 2500RP may depend on the data structure Time-Space-Indexer, which over approximates an autonomous guided bot's 110, 262 occupied region to a set of boxes BXA, BXB (see FIG. 17). As the occupied region of an autonomous guided bot 110, 262 is determined with the over approximation, two autonomous guided bots A, B (see FIG. 17) that are adjacent one another, but not colliding with one another, may be determined as colliding with each other (e.g., due to the over approximation). An example of this determination is illustrated in FIG. 17 were the autonomous guided bots A, B do not collide but their boxes BXA, BXB overlap one another indicating a collision due to the over approximation of the occupied regions of the respective autonomous guided bots A, B. The box over approximation is employed for determining the occupied region of an autonomous guided bot 110, 262, except for the initial occupied region of the autonomous guided bot 110, 262. For example, at conflict checking and collecting higher-priority route leg's occupancies, the bot route planner 120RP, 2500RP (such as the multi-agent path finding algorithm resolver 120P, 2500P or other portion of the bot route planner) is configured to ignore the spatial regions that the autonomous guided bot(s) 110, 262 occupy, and a data structure (referred to as startup occupancy) is employed to determine the autonomous guided bot(s) occupancy in the very beginning of its movement (where conflict checking is performed and exclusion intervals are determined for the startup occupancies).

Referring to FIG. 18A an exemplary startup occupancy determination will be described given a planned trajectory of an autonomous guided bot 110, 262. The startup occupancy includes the following values:

The start box SB. The start box SB is the box of the autonomous guided bot 110, 262 at its source pose (container bot 110 is illustrated for exemplary purposes only, noting the aspects disclosed herein are equally applicable to goods bot 262).

The startup box SUB. The startup box is the aggregate box of all the boxes at the following waypoints that intersect with the start box SB.

The trajectory start time. The trajectory start time is the time that the autonomous guided bot 110, 262 starts moving (T=3 in the example illustrated in FIG. 18A).

The startup duration. The startup duration is the first time that the box of the autonomous guided bot 110, 262 does not intersect with the start box (see the box corresponding to T=5 in the example illustrated in FIG. 18A).

Referring to FIG. 18B, the bot route planner 120RP, 2500RP (such as the multi-agent path finding algorithm resolver 120P, 2500P or other portion of the bot route planner) is configured to determine whether two route leg's trajectories collide at startup by (see FIG. 18B and the two bots A, B illustrated therein):

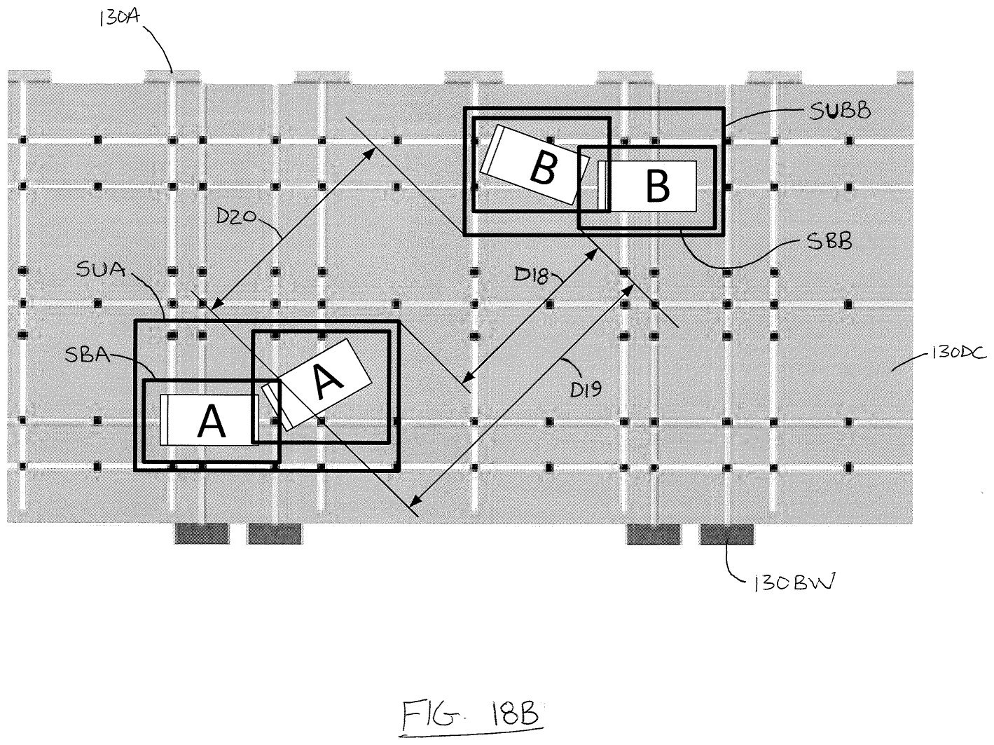

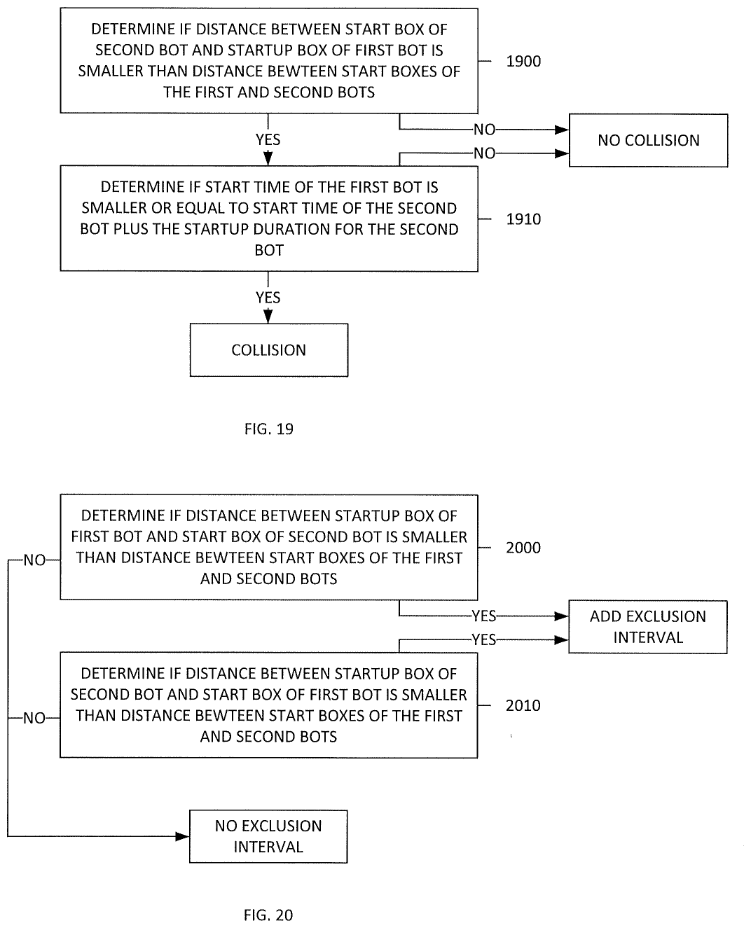

Determining (FIG. 19, Block 1900) whether the distance D18 between the start box SBB of autonomous guided bot B and the startup box SUBA for autonomous guided bot A is smaller than the distance D19 between the start box SBB of autonomous guided bot B and the start box SBA for autonomous guided bot A. Where, the result is true (i.e., D18 is smaller than D19), autonomous guided bot A's startup movement is getting closer to autonomous guided bot B (noting that where the distances D18 and D19 are equal, autonomous guided bot A is not getting closer to autonomous guided bot B); and

Determining (FIG. 19, Block 1910) whether autonomous guided bot A's start time is smaller or equal to autonomous guided bot B's start time plus the startup duration for autonomous guided bot B. Where the result is true (i.e., bot A's start time is smaller or equal to bot B's start time plus the startup duration) autonomous guided bot A has started moving before autonomous guided bot B fully leaves its start box SBB.

If the result of each of the two above-noted determinations for autonomous guided bot A is true, it is determined that autonomous guided bot A is moving towards autonomous guided bot B at startup, and autonomous guided bot B does not escape from autonomous guided bot B's start up movement (i.e., autonomous guided bot A collides with autonomous guided bot B during startup).

The same is determined for autonomous guided bot B. For example, the bot route planner 120RP, 2500RP:

Determines (FIG. 19, Block 1900) whether the distance D20 between the start box SBA of autonomous guided bot A and the startup box SUBB for autonomous guided bot B is smaller than the distance D19 between the start box SBB of autonomous guided bot B and the start box SBA for autonomous guided bot A. Where, the result is true (i.e., D20 is smaller than D19), autonomous guided bot B's startup movement is getting closer to autonomous guided bot A (noting that where the distances D20 and D19 are equal, autonomous guided bot B is not getting closer to autonomous guided bot A); and

Determines (FIG. 19, Block 1910) whether autonomous guided bot B's start time is smaller or equal to autonomous guided bot A's start time plus the startup duration for autonomous guided bot A. Where the result is true (i.e., bot B's start time is smaller or equal to bot A's start time plus the startup duration) autonomous guided bot B has started moving before autonomous guided bot A fully leaves its start box SBA.

If the result of each of the two above-noted determinations for autonomous guided bot B is true, it is determined that autonomous guided bot A is moving towards autonomous guided bot A at startup, and autonomous guided bot A does not escape from autonomous guided bot A's start up movement (i.e., autonomous guided bot B collides with autonomous guided bot A during startup).

If it is determined that either autonomous guided bot A collides with autonomous guided bot B during startup or autonomous guided bot B collides with autonomous guided bot A during startup, the two route legs collide.

Referring to FIGS. 1 and 18A-18B, the controller 120, 2500 (such as the multi-agent path finding algorithm resolver 120P, 2500P thereof) may be configured to determine or otherwise calculate startup exclusion intervals so that autonomous guided bots A, B may avoid each other at startup. For example, given the startup occupancy of autonomous guided bot A, the exclusion intervals for autonomous guided bot B to avoid the startup of autonomous guided bot A are determined as follows:

If the distance D18 between the startup box SUA for autonomous guided bot A and the start box SBB of autonomous guided bot B is smaller than the distance D19 between the start box SBA of autonomous guided bot A and the start box SBB of autonomous guided bot B (FIG. 20, Block 2000), an exclusion interval (bot A's start time-bot B's startup duration, infinity) is added. This means if autonomous guided bot A moves towards autonomous guided bot B, autonomous guided bot B should already finish its startup before autonomous guided bot A starts moving.

If the distance D20 between the startup box SUBB for autonomous guided bot B and the start box SBA of autonomous guided bot A is smaller than the distance D19 between the start box SBB of autonomous guided bot B and the start box SBA of autonomous guided bot A (FIG. 20, Block 2010), an exclusion interval (0, bot A's start time+bot B's startup duration) is added. This means if autonomous guided bot B moves towards autonomous guided bot A, autonomous guided bot B should start moving after autonomous guided bot A finishes its startup.

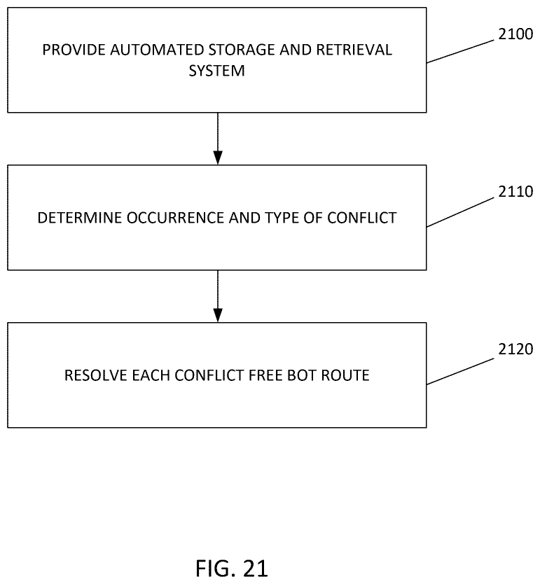

Referring to at least FIGS. 1, 2A-2D, 3, and 21, an exemplary method will be described in accordance with the present disclosure. The method includes providing the automated storage and retrieval system 100 (FIG. 21, Block 2100) as described herein. For example, the storage and retrieval system 100 includes: the storage array SA with storage locations 130S arrayed along aisles 130A and a non-deterministic deck or floor 130DC communicating with each aisle 130A; a plurality of autonomous guided bots 110, each configured for free ranging motion so as to traverse freely along bot paths (e.g., BPT-BPT3, sec FIGS. 4 and 5B, as described herein), including optimal paths, on the deck or floor 130DC so that each autonomous guided bot 110 accesses each storage location 130S in each aisle 130A from each location on the deck or floor 130DC and aisles 130A; and a controller (such as one or more of control server 120 and warehouse management system 2500 or other suitable controller) communicably connected to each autonomous guided bot 110 of the plurality of autonomous guided bots 110 so as to assign a series of tasks, or goals, to each autonomous guided bot 110, which series of tasks, or goals, includes at least one task, or goal, to at least one autonomous guided bot 110 moving the autonomous guided bot 110 from an initial location to a different final location via bot routes 499A-499C describing bot paths BPT-BPT3 (see FIG. 4).

The method also includes determining, with the multi-agent path finding algorithm resolver 120P, 2500P of the bot route planner 1200RP, 2500RP of the controller 120, 2500, for each bot route effecting the at least one task, or goal, occurrence and type of a conflict (FIG. 21, Block 2110) between autonomous guided bots 110 performing the series of tasks, or goals. The multi-agent path finding algorithm resolver 120P, 2500P resolves from the determination of occurrence and type of conflict, each conflict free bot route (FIG. 21, Block 2120) that determines the bot route respectively for each autonomous guided bot 110 performing the at least one task, or goal. The conflict free bot route is based on bot priority and precedence constraint between route legs describing, at least in part, the respective bot route of a common autonomous guided bot 110 performing the at least one task, or goal.

The method may also include one or more of the following, in any suitable combination thereof: the multi-agent path finding algorithm resolver 120P, 2500P resolves that the bot route is conflict free via a heuristic determination that each bot route leg, describing the bot route, is conflict free; the multi-agent path finding algorithm resolver 120P, 2500P effects the heuristic determination through application of priority conditions and precedence constraints between conflicting autonomous guided bots 110; the precedence constraints describe precedence between sequential successive tasks, or goals, in the series of tasks, or goals, of the at least one autonomous guided bot 110 with respect to at least another sequential successive task, or goal, in the series of tasks, or goals, of another autonomous guided bot 110 conflicting with the at least one autonomous guided bot 110; the heuristic determination resolves a dead-end conflict between the at least one autonomous guided bot 110, that has a terminus or goal of the bot route later than another autonomous guided bot 110, and at least one route leg of the another autonomous guided bot 110; the at least one autonomous guided bot 110 that has the terminus or goal of the bot route later than the another autonomous guided bot 110, forms a dead-end in an aisle 130A or driveway 130BW of the storage array SA, and the resolved bot route of the complete solution for the at least one autonomous guided bot 110 is dead-end free; the heuristic determination resolves an autonomous guided bot 110 idling conflict between the at least autonomous guided one bot 110 idling, in a pose intervening between the at least one task, or goal, and an immediately sequential task, or goal, in the series of tasks, or goals, and at least one route leg of another autonomous guided bot 110; the heuristic determination resolves an autonomous guided bot 110 idling conflict between the at least one autonomous guided bot idling 110, in a pose intervening between the at least one conflict free leg of the bot route and an immediately succeeding leg of the bot route, and at least one route leg of another autonomous guided bot 110; the heuristic determination seeks the earliest conflict between conflicting route legs of the at least one autonomous guided bot 110 with another autonomous guided bot 110; the multi-agent path finding algorithm resolver 120P, 2500P resolves the conflict free bot route and identifies a solution that is a complete solution with determination that each bot route leg describing the bot route in entirety is conflict free; the multi-agent path finding algorithm resolver 120P, 2500P resolves the conflict free bot route and identifies a solution that is a partial solution with determination that at least one bot route leg, describing the bot route at least in part, is conflict free, and that each route leg of the at least one conflict free route leg, describing the at least part of the bot route, is in sequentially successive order from an initial location, and each preceding route leg has precedence over the sequentially successive route leg; the controller 120, 2500 commands the at least one autonomous guided bot 110 to proceed along the resolved conflict free bot route based on one or more of the complete solution and the partial solution; based on the controller command, the at least one autonomous guided bot 110 proceeds along the at least one conflict free route leg of the partial solution, and the multi-agent path finding algorithm resolver 120P, 2500P continues the heuristic determination to complete the solution via best nodes of the heuristic; the type of conflict is a traverse bot conflict, an idle bot conflict, and a dead-end bot conflict; and the at least one task, or goal, is located in an aisle 130A or driveway 130BW of the storage array SA.

It is noted that most well studied multi-agent path finding algorithms aim to coordinate movement of bots that traverse under shelves/pods, where the autonomous vehicles can only perform rotate moves or one grid space forward moves at each discrete time step. Unlike the well-studied multi-agent path finding algorithms, the bot route planner 120RP, 2500RP described herein is configured to coordinate a group of high-speed bots in an obstacle-rich map where: the bots 110, 262 traverse through the storage structure at the high speeds described herein, such as 10 m/sec, which is about three times faster than most other warehouse bots (frequent replanning is effected to achieve high performance and collision free paths of the high speed bots, where the bot route planner 120RP, 2500RP generates a route plan in several hundreds of milliseconds (as described herein), and more particularly within 100 milliseconds; on each storage level 130L more than about 80% of structures are long and narrow aisles (which can easily lead to dead locks); and optimal solutions are favored to increase the overall throughput and reduce operation costs of the storage and retrieval system 100.

The multi-agent path finding algorithm resolver 120P, 2500P of the bot route planner 120RP, 2500RP, described herein, employs a state-of-the-art multi-agent algorithm (as described herein) tailored to the storage and retrieval system described herein, and engineering efforts to optimize the algorithm efficiency and heuristic designs.

The goal of the multi-agent path finding algorithm resolver 120P, 2500P of the bot route planner 120RP, 2500RP is to achieve higher throughput of the storage and retrieval system 100, which is measured by transactions per hour (TPH). This goal can be divided into three aspects with respect to the algorithm (noting the level structure, task assignment algorithm, and physical bot design remain unchanged). The three aspects are: high quality routes in happy paths; robustness to unhappy paths; and runtime efficiency.

Most of the time all bots 110, 262 run smoothly without significant communication delays, significant execution errors, control failures, or failure in other modules. This may be referred to as a happy path. Planning high-quality routes that can navigate the bots 110, 262, to finish their tasks sooner under happy paths is important because most of the time the storage and retrieval system operates under happy paths. To achieve a good happy-path performance, the bot route planner 120RP, 2500RP must smartly coordinate the routes of the bots 110, 262, including but not limited to: for each picking aisle 130A or driveway 130BW (the ordering of different bots 110, 262 moving in and moving out); and on the transfer deck 130DC, 130DG (which avenues of the deck are used by which bots 110, 262 at which time, and thus the deck space resource is fully leveraged).

The storage and retrieval system 100 will not always operate under happy paths because uncertainty is ubiquitous. There can be execution errors, communication delays, or module failures at some times. This operation may be referred to as unhappy paths. The unhappy paths can be grouped into two categories: unhappy paths that can be avoided beforehand (e.g., such as execution errors that are within certain bounds, communication delays that within certain bounds, and bot failures that are reported immediately); and unhappy paths that require collision avoidance system interventions and the bot route planner 120RP, 2500RP is tasked with recovering from these unhappy paths (e.g., a bot 110, 262 that is disconnected or uncontrollable and is reported after a relatively long time, which results in deadlock).

For unhappy paths that can be avoided beforehand, a subset of the error or delay bounds is considered in the bot route planner 120RP, 2500RP when planning routes. As such, these unhappy paths can be avoided without collision avoidance system interventions (see the time padding described herein, which is configured to accommodate these unhappy paths).

For unhappy paths that require collision avoidance system interventions, the bot route planner 120RP, 2500RP may be able to resolve the deadlocks (as described herein) under any situation.

With respect to runtime efficiency, the bot route planner 120RP, 2500RP is configured to plan routes fast (e.g., in several hundreds of milliseconds (as described herein), and more particularly within 100 milliseconds). Here, there are two aspects: each fundamental computation such as an occupancy calculation and an exclusion/safe interval calculation is optimized (as described herein); and the overall time from receiving a planning request to generating an executable plan is within several hundreds of milliseconds, and more particularly within 100 milliseconds.

As may be realized, the three goals noted above (i.e., high-quality routes in happy paths, robustness to unhappy paths, and runtime efficiency) may be related where: improving the efficiency of fundamental modules in the bot route planner 120RP, 2500RP can effect improving happy path route quality; and the best parameter for error and delays is found to achieve balance between the happy path route quality and a chance of falling into unhappy paths.

There may be trade-off between happy path route qualities and runtime efficiency. As the routing problem itself is an NP-hard problem, finding an optimal solution is computationally intractable. This means, where there is infinite runtime or infinite computational power, an aim for finding the optimal solution exits; however, in accordance with the present disclosure, optimality may be traded for efficiency which provides for bounding the bot route planner 120RP, 2500RP runtime to be within an allowable time limit (such as described herein).

Where the fundamental computation, such as an occupancy calculation, can be done in at higher speeds, the algorithm is allowed to perform more sophisticated reasoning. For example: directly adopt optimal or bounded suboptimal algorithms for a relatively small bot team; explore more solution candidates during search in a greedy search method; and planning more bots together to jointly optimize their joint paths under a certain priority relation. Here the bot route planner 120RP, 2500RP gives a solution within a limited time, and the less time the fundamental computation takes, the better the solution the bot route planner 120RP, 2500RP can generate.

There may also be a trade-off between happy path route quality and the chance of falling into an unhappy path. As described herein with respect to time padding, a conservative time padding for execution errors and communication delays reduces the change of falling into an unhappy path, where collision avoidance system interventions may not be needed. However, with the conservative parameters, bots 110, 262 will behave conservatively, resulting in poorer happy path route quality. The bot route planner 120RP, 2500RP is configured to find the best parameters that balance these two aspects.

It is also noted that if the bot route planner 120RP, 2500RP takes a significant amount of time to generate routes, bots 110, 262 will get actuated later and delayed, where an additional time padding may be imposed for this planning time. This planning time may fluctuate and upper bounds (which may be conservative) to the time padding may be imposed.

With respect to unhappy paths and runtime efficiency, it is noted that the longer runtime the bot route planner 120RP, 2500RP needs, the less chance the bot 110, 262 can adapt to unplanned events. For example, if a bot 110, 262 is reported to be malfunctioned and another bot 110, 262 can adjust the velocity to avoid this situation, the longer the planning takes, the less chance the bot 110, 262 can be successfully re-routed.

As described herein, the multi-agent path finding algorithm resolver 120P, 2500P of the bot route planner 120RP, 2500RP is configured with a priority-based search algorithm that determines a near-optimal solution to the problem of routing a forty bot fleet. The routing problem solved by the present disclosure is an NP-hard problem, to which it is hard to find a high-quality solution within a limited timeout (or runtime period). Even though the algorithm performs a systematic search towards finding a high-quality solution, the generated route plans may not be optimal. This is because the algorithm leverages factoring and a greedy search to trade solution quality for runtime efficiency.

The algorithm implicitly factors the solution space (i.e., all possible route plans) into multiple sub-spaces, and each sub-space is a subset of the solution space that is implied by a set of priority combinations. Every time the algorithm adds a priority decision, the corresponding sub-space shrinks and the route legs are replanned within this sub-space (see, e.g., the conflict resolution and single bot routing described herein). The algorithm optimally plans every route leg, but the solution for all the route legs may not be optimal. Replanning multiple autonomous guided bots 110, 262 together may improve the solution quality. For example if all autonomous guided bots 110, 262 are planned optimally together, an optimal solution may be provided, but such planning does not leverage factoring. Here, a meta-agent approach may be employed to improve the algorithmic completeness of the algorithm, e.g., at a cost of more computation.

At each expansion, the algorithm greedily chooses the best priority between a pair of route legs via evaluating their corresponding search nodes. Here, quality of the planned trajectories and quality of the unplanned trajectories are combined after adding this priority (see the search node evaluation described herein). In the node evaluation, the planned part can be evaluated substantially exactly, where the overall performance depends on the accuracy of evaluating the unplanned part.

Although the algorithm leverages factoring and trades optimality for runtime efficiency, it is a systematic search method after all, which performs intensive computation. The runtime efficiency should be optimized to meet the application need (see the computation time periods described herein, particularly the 100 m/sec time period).

It is noted that improving runtime efficiency of the algorithm may reduce the chance of falling into unhappy paths by increasing planning frequency and adopting additional reasoning modules to improve solution qualities. The task to improve runtime efficiency may be grouped into the following two categories: algorithm design and fundamental calculation and operation.

With respect to the algorithm design, to accelerate a search method, propagation and pruning are leveraged. Where it is known that a decision (e.g., priority, route) is necessary or infeasible, a decision may be made to prune that decision without invoking any calculation procedure. Here, rules may be leveraged to add obvious priorities. Note that the rule based priorities are added initially for planning but priorities may be added every time a new priority is added (e.g., in a manner similar to constraint propagation procedure in constraint optimization). Single route leg failure detection may detect a route leg that cannot succeed or even be partially planned, where in such a case single bot routing may be avoided. Single route leg failure detection can be achieved by collecting common occupancies of all possible trajectories and checking them against higher priority occupancies (the common occupancies may be pre-computed). A local search may be performed to repair schedules from a last (e.g., previous) planning cycle, where such search may clear invalid priorities and routes, keep useful priorities and routes, and continue search from there.

With respect to the fundamental calculation and operation, one or more of the following may be employed: computation hotspot-exclusion interval calculation; computation hotspot-trajectory occupancy calculation; parallelizing child node generation; and trajectory occupancy and exclusion interval caching.

The solution quality of the algorithm may be improved to increase throughput of the storage and retrieval system 100. For example, one or more of the following may be employed: enhance heuristics design; optimize single-bot travel patterns; improve the strategy to choose a next conflict to resolve (for example, conflicts with the earliest time stamp, more important conflicts, where “important” means two route legs that will more likely be higher priority than the other route legs because if these route legs are maintained with a higher priority throughout the search, they are less likely to be replanned and the current node evaluation may be effected with higher accuracy); and parameter tuning and uncertainty calculation, where there may be trade-off between happy path quality and robustness to unhappy paths (see the adaptive time padding and trajectory occupancy calculation described herein).

The heuristic design may also be configured to increase throughput. As described herein, the algorithm keeps planning route legs forward along the timeline until a conflict is detected. With detection of a conflict, the algorithm performs conflict resolution and picks the child node with the best evaluation. When evaluating a child node, both the planned trajectory (for successfully planned or partially planned route legs) and the unplanned part (for partially planned or failed route legs) are evaluated. This evaluation is a heuristic guide to the priority-based search algorithm.

The heuristic design described herein considers successfully planned, partially planned, or failed route legs. The heuristic design does not (but may) consider unplanned route legs and does not (but may) estimate the unplanned part of partially planned or failed route legs.

Here, when evaluating child nodes, the planned route legs are evaluated while the unplanned route legs are ignored. For example, if there are ten route legs and a conflict is found after planning the seventh route leg, the remaining three route legs have not been planned and will not be considered in node evaluation. Note that “unplanned route legs” are different from an “unplanned part of a partially planned route legs.” For example, a route leg that is likely to have higher priorities than several unplanned route legs may be assigned a lower priority. As a result, delaying this route leg will potentially delay other route legs that have not been planned now but will be finally planned. The heuristic design described herein is a trade-off for runtime efficiency, because it is computationally expensive to plan all route legs initially and replan all route legs every time a priority is specified.

In addition to ignoring unplanned route legs, when evaluating child nodes, a penalty is imposed on the unplanned part of partially planned or failed route legs. However, the imposed penalty may be an estimate and may not accurately represent which priority is better for the total sum of execution times. For example, even if they have the same trajectory sum for unplanned parts, they may differ in unresolved conflicts. The fewer unresolved conflicts, the more likely the child node will lead to better conflict-free plans after resolving all the conflicts.

The heuristic design may be modified to include observation where the replay is observed and the proper penalty weights are chosen for delayed route legs with certain factors (e.g., unresolved conflicts, subsequent same-bot route legs, etc.) to mimic optimal behaviors.

The heuristic design may be modified to solve a relaxed problem to estimate, where a more comprehensive but also more costly method is employed to obtain a more accurate estimation via solving relaxed routing problems of the unplanned route legs and unplanned parts of planned route legs. For example, one solution candidate is to ignore (i.e., relax) the on-deck conflicts but keep the resource conflicts, and model the routing problem as a scheduling problem. More specifically, this relaxed problem can be modeled as a disjunctive simple temporal network and perform pairwise conflict resolution and temporal propagation to effectively solve this relaxed problem.

Rule based priorities may also improve node evaluation. For example, the more priorities that are specified manually, the more accurate the evaluation is. For example, if three autonomous guided bots want to get out of a picking aisle 130A, and a priority decision is going to be made between one bot at the picking aisle 130A entrance and another bot that tries to pass the deck in front of this picking aisle 130A, based on information that delaying the bot at the picking aisle 130A entrance will delay three bots, a priority may be specified that the two or three bots in the picking aisle 130A leave the picking aisle 130A before the bot passes the picking aisle entrance. This may lead to increased overall throughput.

Referring also to FIG. 23, a comprehensive heuristics evaluation for high-quality priority decisions may be provided. Here, there may be a very large penalty for every task that fails planning. A sum of costs (SoC) may be defined as the sum of duration estimations of all the tasks (e.g., durations of planned tasks, duration estimation of unplanned tasks, and impacts of unresolved conflicts. Other requirements may also be incorporated, e.g., extra bonus penalty for prioritizing autonomous guided bots that alarm or need charge. In the Example illustrated in FIG. 23, task A4 of Bot A blocks the destination for bot B to complete task B3. Here, a penalty may be assigned to, for example, bot B adding at least a 15 second dealy/penalty.

To increase throughput a single-bot travel pattern may be optimized. The priority based search algorithm of the present disclosure employs a similar single-bot travel pattern as the TSRRouter-PP. In this travel pattern, a bot can directly move to the destination, or move the destination via an intermediate destination, and the bot can make no more than two turns on the transfer deck. If the bot is allowed to freely move in the map without these limitations, a better throughput may be achieved (e.g., search a route via an optimal single-bot travel). Here the following may be considered: leveraging safe interval path planning (SIPP); post processing priority-based schedules; providing unidirectional and bidirectional avenues on the transfer decks; and planning high-priority route legs in a less selfish way.

A comprehensive but costly method is to leverage safe interval path planning (SIPP), which is an A* variant that can find the optimal trajectory within the time-space space. However, being aware of any A* or its variants may introduce intractable computation overhead such that the A* or its variants will not be directly adopted but rather more paths will be enumerated (e.g., allowing more turns) or the travel pattern may be improved.

The priority-based schedules may be post-processed by employing a combinatorial scheduler, where if trajectories of the priority-based solution are discarded while keeping the priorities, a combinatorial scheduler can be called to reschedule all the route legs to refine.

Unidirectional and bidirectional avenues on the transfer decks may be provided in one or more regions of the transfer decks in an adaptive manner. For example, the traffic pattern of where the bots come from and go to may be analyzed. Based on the analysis the transfer decks may be divided into several regions, where some of the regions are unidirectional and some other regions are bidirectional.

Planning high-priority route legs in a less selfish way may also increase throughput. In the priority based search framework, if a route leg is assigned with a higher priority, the bot will act in a selfish way and only try to achieve its own goals as fast as possible. These high-priority route legs may be planned in a less selfish manner. For example, given a traffic pattern in a certain area that a lot of bots want to go to (such as from some driveway 130BW to other driveways 130BW in the same area of a lower part of the transfer deck), a higher-priority bot can be planned to favor an upper area of the transfer deck even if its own plan will be delayed for several seconds.

The bot route planner 120RP, 2500RP may be improved with by better understanding optimal scheduling behavior, where the priority based search heuristics is tuned to mimic optimal behaviors. Better understanding of traffic bottlenecks at the pickings aisles 130A or driveways 130BW (i.e., a queuing problem) and/or on the transfer deck (i.e., a typical traffic management problem) may effect the tuning of the priority based search heuristics, noting the bottlenecks may change depending on whether there are mixed inbound-outbound driveways 130BW. The heuristics may observe from replay and metrics, where metrics such as bot waiting times are observed. A replay of the bot route planner 120RP, 2500RP may be observed to remedy sub-optimal behavior. An optimal planner (such as a conflict-based search (CBS)) may be employed.

The priority based search framework of the present disclosure may be further optimized by one or more of: employing multi-agent path finding applications such as pipe routing and rail planning; making the priority base search algorithm more greedy; employing deep learning to quickly generate priorities; merge agents together and jointly plan them; employ priority and route decisions learned from previous planning cycles; and leverage the Shard system to scale.

Other search methods may also be considered including, but not limited to, explicit estimation conflict-based search (EECBS) (such as described in Li, Jiaoyang et al., “Eecbs: A bounded-suboptimal search for multi-agent path finding,” Proceedings of the AAAI Conference on Artificial Intelligence, Vol. 35, No. 14. 2021), and lazy constraints addition search for MAPF (LaCAM*) (such as described in Okumura, Keisuke, “Engineering LaCAM*: Towards Real-Time, Large-Scale, and Near Optimal Multi-Agent Pathfinding,” arXiv preprint arXiv: 2308.04292 (2023)). EECBS is a bounded suboptimal search method, which directly resolves conflicts by giving priorities of bots over visiting a conflicting area, which is a faster version of a conflict-based search MAPF algorithm.

The following are provided in accordance with the present disclosure and may be employed individually, in any combination with each other, and/or in any combination with the features described above.

An automated storage and retrieval system is provided and includes: a storage array with storage locations arrayed along aisles and a non-deterministic deck or floor communicating with each aisle; a plurality of autonomous guided bots, each configured for free ranging motion so as to traverse freely along bot paths, including optimal paths, on the deck or floor so that each autonomous guided bot accesses each storage location in each aisle from each location on the deck or floor and aisles; and a controller communicably connected to each autonomous guided bot of the plurality of autonomous guided bots so as to assign a series of tasks, or goals, to each autonomous guided bot, which series of tasks, or goals, includes at least one task, or goal, to at least one autonomous guided bot moving the autonomous guided bot from an initial location to a different final location via bot routes describing bot paths; wherein: the controller is configured with a bot route planner that has a multi-agent path finding algorithm resolver that determines, for each bot route effecting the at least one task, or goal, occurrence and type of a conflict between autonomous guided bots performing the series of tasks, or goals; from the determination of occurrence and type of conflict, the multi-agent path finding algorithm resolver is configured to resolve each conflict free bot route that determines the bot route respectively for each autonomous guided bot performing the at least one task, or goal; and the conflict free bot route is based on bot priority and precedence constraint between route legs describing, at least in part, the respective bot route of a common autonomous guided bot performing the at least one task, or goal.

The automated storage and retrieval system, in accordance with the present disclosure, may include one or more of, employed individually or in any suitable combination thereof: the multi-agent path finding algorithm resolver is configured to resolve that the bot route is conflict free via a heuristic determination that each bot route leg, describing the bot route, is conflict free; the multi-agent path finding algorithm resolver effects the heuristic determination through application of priority conditions and precedence constraints between conflicting autonomous guided bots; the precedence constraints describe precedence between sequential successive tasks, or goals, in the series of tasks, or goals, of the at least one autonomous guided bot with respect to at least another sequential successive task, or goal, in the series of tasks, or goals, of another autonomous guided bot conflicting with the at least one autonomous guided bot; the heuristic determination resolves a dead-end conflict between the at least one autonomous guided bot, that has a terminus or goal of the bot route later than another autonomous guided bot, and at least one route leg of the another autonomous guided bot; the at least one autonomous guided bot that has the terminus or goal of the bot route later than the another autonomous guided bot forms, a dead-end in an aisle or driveway of the storage array, and the resolved bot route of the complete solution for the at least one autonomous guided bot is dead-end free; the heuristic determination resolves an autonomous guided bot idling conflict between the at least autonomous guided one bot idling, in a pose intervening between the at least one task, or goal, and an immediately sequential task, or goal, in the series of tasks, or goals, and at least one route leg of another autonomous guided bot; the heuristic determination resolves an autonomous guided bot idling conflict between the at least one autonomous guided bot idling, in a pose intervening between the at least one conflict free leg of the bot route and an immediately succeeding leg of the bot route, and at least one route leg of another autonomous guided bot; the heuristic determination seeks the earliest conflict between conflicting route legs of the at least one autonomous guided bot with the other autonomous guided bot; the multi-agent path finding algorithm resolver is configured to resolve the conflict free bot route and identify a solution that is a complete solution with determination that each bot route leg describing the bot route in entirety is conflict free; the multi-agent path finding algorithm resolver is configured to resolve the conflict free bot route and identify a solution that is a partial solution with determination that at least one bot route leg, describing the bot route at least in part, is conflict free, and that each route leg of the at least one conflict free route leg, describing the at least part of the bot route, is in sequentially successive order from an initial location, and each preceding route leg has precedence over the sequentially successive route leg; the controller is configured to command the at least one autonomous guided bot to proceed along the resolved conflict free bot route based on one or more of the complete solution and the partial solution; based on the controller command, the at least one autonomous guided bot proceeds along the at least one conflict free route leg of the partial solution, and the multi-agent path finding algorithm resolver continues the heuristic determination to complete the solution via best nodes of the heuristic; the type of conflict is a traverse bot conflict, an idle bot conflict, and a dead-end bot conflict; and the at least one task, or goal, is located in an aisle or driveway of the storage array.

A method is provided and includes providing an automated storage and retrieval system that includes: a storage array with storage locations arrayed along aisles and a non-deterministic deck or floor communicating with each aisle; a plurality of autonomous guided bots, each configured for free ranging motion so as to traverse freely along bot paths, including optimal paths, on the deck or floor so that each autonomous guided bot accesses each storage location in each aisle from each location on the deck or floor and aisles; and a controller communicably connected to each autonomous guided bot of the plurality of autonomous guided bots so as to assign a series of tasks, or goals, to each autonomous guided bot, which series of tasks, or goals, includes at least one task, or goal, to at least one autonomous guided bot moving the autonomous guided bot from an initial location to a different final location via bot routes describing bot paths; determining, with a multi-agent path finding algorithm resolver of a bot route planner of the controller, for each bot route effecting the at least one task, or goal, occurrence and type of a conflict between autonomous guided bots performing the series of tasks, or goals; and resolving, with the multi-agent path finding algorithm resolver from the determination of occurrence and type of conflict, each conflict free bot route that determines the bot route respectively for each autonomous guided bot performing the at least one task, or goal; wherein the conflict free bot route is based on bot priority and precedence constraint between route legs describing, at least in part, the respective bot route of a common autonomous guided bot performing the at least one task, or goal.

The method, in accordance with the present disclosure, may include one or more of, employed individually or in any suitable combination thereof: the multi-agent path finding algorithm resolver resolves that the bot route is conflict free via a heuristic determination that each bot route leg, describing the bot route, is conflict free; the multi-agent path finding algorithm resolver effects the heuristic determination through application of priority conditions and precedence constraints between conflicting autonomous guided bots; the precedence constraints describe precedence between sequential successive tasks, or goals, in the series of tasks, or goals, of the at least one autonomous guided bot with respect to at least another sequential successive task, or goal, in the series of tasks, or goals, of another autonomous guided bot conflicting with the at least one autonomous guided bot; the heuristic determination resolves a dead-end conflict between the at least one autonomous guided bot, that has a terminus or goal of the bot route later than another autonomous guided bot, and at least one route leg of the another autonomous guided bot; the at least one autonomous guided bot that has the terminus or goal of the bot route later than the another autonomous guided bot, forms a dead-end in an aisle or driveway of the storage array, and the resolved bot route of the complete solution for the at least one autonomous guided bot is dead-end free; the heuristic determination resolves an autonomous guided bot idling conflict between the at least autonomous guided one bot idling, in a pose intervening between the at least one task, or goal, and an immediately sequential task, or goal, in the series of tasks, or goals, and at least one route leg of another autonomous guided bot; the heuristic determination resolves an autonomous guided bot idling conflict between the at least one autonomous guided bot idling, in a pose intervening between the at least one conflict free leg of the bot route and an immediately succeeding leg of the bot route, and at least one route leg of another autonomous guided bot; the heuristic determination seeks the earliest conflict between conflicting route legs of the at least one autonomous guided bot with another autonomous guided bot; the multi-agent path finding algorithm resolver resolves the conflict free bot route and identifies a solution that is a complete solution with determination that each bot route leg describing the bot route in entirety is conflict free; the multi-agent path finding algorithm resolver resolves the conflict free bot route and identifies a solution that is a partial solution with determination that at least one bot route leg, describing the bot route at least in part, is conflict free, and that each route leg of the at least one conflict free route leg, describing the at least part of the bot route, is in sequentially successive order from an initial location, and each preceding route leg has precedence over the sequentially successive route leg; the controller commanding the at least one autonomous guided bot to proceed along the resolved conflict free bot route based on one or more of the complete solution and the partial solution; based on the controller command, the at least one autonomous guided bot proceeds along the at least one conflict free route leg of the partial solution, and the multi-agent path finding algorithm resolver continues the heuristic determination to complete the solution via best nodes of the heuristic; the type of conflict is a traverse bot conflict, an idle bot conflict, and a dead-end bot conflict; and the at least one task, or goal, is located in an aisle or driveway of the storage array.

It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the present disclosure.

What is claimed is:

1. An automated storage and retrieval system comprising:
a storage array with storage locations arrayed along aisles and a non-deterministic deck or floor communicating with each aisle;
a plurality of autonomous guided bots, each configured for free ranging motion so as to traverse freely along bot paths, including optimal paths, on the deck or floor so that each autonomous guided bot accesses each storage location in each aisle from each location on the deck or floor and aisles; and
a controller communicably connected to each autonomous guided bot of the plurality of autonomous guided bots so as to assign a series of tasks, or goals, to each autonomous guided bot, which series of tasks, or goals, includes at least one task, or goal, to at least one autonomous guided bot moving the autonomous guided bot from an initial location to a different final location via bot routes describing bot paths;
wherein:
the controller is configured with a bot route planner that has a multi-agent path finding algorithm resolver that determines, for each bot route effecting the at least one task, or goal, occurrence and type of a conflict between autonomous guided bots performing the series of tasks, or goals;
from the determination of occurrence and type of conflict, the multi-agent path finding algorithm resolver is configured to resolve each conflict free bot route that determines the bot route respectively for each autonomous guided bot performing the at least one task, or goal; and
the conflict free bot route is based on bot priority and precedence constraint between route legs describing, at least in part, the respective bot route of a common autonomous guided bot performing the at least one task, or goal.

2. The automated storage and retrieval system of claim 1, wherein the multi-agent path finding algorithm resolver is configured to resolve that the bot route is conflict free via a heuristic determination that each bot route leg, describing the bot route, is conflict free.

3. The automated storage and retrieval system of claim 2, wherein the multi-agent path finding algorithm resolver effects the heuristic determination through application of priority conditions and precedence constraints between conflicting autonomous guided bots.

4. The automated storage and retrieval system of claim 3, wherein the precedence constraints describe precedence between sequential successive tasks, or goals, in the series of tasks, or goals, of the at least one autonomous guided bot with respect to at least another sequential successive task, or goal, in the series of tasks, or goals, of another autonomous guided bot conflicting with the at least one autonomous guided bot.

5. The automated storage and retrieval system of claim 2, wherein the heuristic determination resolves a dead-end conflict between the at least one autonomous guided bot, that has a terminus or goal of the bot route later than another autonomous guided bot, and at least one route leg of the another autonomous guided bot.

6. The automated storage and retrieval system of claim 5, wherein the at least one autonomous guided bot that has the terminus or goal of the bot route later than the another autonomous guided bot, forms a dead-end in an aisle or driveway of the storage array, and the resolved bot route of the complete solution for the at least one autonomous guided bot is dead-end free.

7. The automated storage and retrieval system of claim 2, wherein the heuristic determination resolves an autonomous guided bot idling conflict between the at least autonomous guided one bot idling, in a pose intervening between the at least one task, or goal, and an immediately sequential task, or goal, in the series of tasks, or goals, and at least one route leg of another autonomous guided bot.

8. The automated storage and retrieval system of claim 2, wherein the heuristic determination resolves an autonomous guided bot idling conflict between the at least one autonomous guided bot idling, in a pose intervening between the at least one conflict free leg of the bot route and an immediately succeeding leg of the bot route, and at least one route leg of another autonomous guided bot.

9. The automated storage and retrieval system of claim 2, wherein the heuristic determination seeks the earliest conflict between conflicting route legs of the at least one autonomous guided bot with another autonomous guided bot.

10. The automated storage and retrieval system of claim 1, wherein the multi-agent path finding algorithm resolver is configured to resolve the conflict free bot route and identify a solution that is a complete solution with determination that each bot route leg describing the bot route in entirety is conflict free.

11. The automated storage and retrieval system of claim 10, wherein the multi-agent path finding algorithm resolver is configured to resolve the conflict free bot route and identify a solution that is a partial solution with determination that at least one bot route leg, describing the bot route at least in part, is conflict free, and that each route leg of the at least one conflict free route leg, describing the at least part of the bot route, is in sequentially successive order from an initial location, and each preceding route leg has precedence over the sequentially successive route leg.

12. The automated storage and retrieval system of claim 11, wherein the controller is configured to command the at least one autonomous guided bot to proceed along the resolved conflict free bot route based on one or more of the complete solution and the partial solution.

13. The automated storage and retrieval system of claim 12, wherein, based on the controller command, the at least one autonomous guided bot proceeds along the at least one conflict free route leg of the partial solution, and the multi-agent path finding algorithm resolver continues the heuristic determination to complete the solution via best nodes of the heuristic.

14. The automated storage and retrieval system of claim 1, wherein the type of conflict is a traverse bot conflict, an idle bot conflict, and a dead-end bot conflict.

15. The automated storage and retrieval system of claim 1, wherein the at least one task, or goal, is located in an aisle or driveway of the storage array.

16. A method comprising:
providing an automated storage and retrieval system that includes:
a storage array with storage locations arrayed along aisles and a non-deterministic deck or floor communicating with each aisle;
a plurality of autonomous guided bots, each configured for free ranging motion so as to traverse freely along bot paths, including optimal paths, on the deck or floor so that each autonomous guided bot accesses each storage location in each aisle from each location on the deck or floor and aisles; and
a controller communicably connected to each autonomous guided bot of the plurality of autonomous guided bots so as to assign a series of tasks, or goals, to each autonomous guided bot, which series of tasks, or goals, includes at least one task, or goal, to at least one autonomous guided bot moving the autonomous guided bot from an initial location to a different final location via bot routes describing bot paths;
determining, with a multi-agent path finding algorithm resolver of a bot route planner of the controller, for each bot route effecting the at least one task, or goal, occurrence and type of a conflict between autonomous guided bots performing the series of tasks, or goals; and
resolving, with the multi-agent path finding algorithm resolver from the determination of occurrence and type of conflict, each conflict free bot route that determines the bot route respectively for each autonomous guided bot performing the at least one task, or goal;
wherein the conflict free bot route is based on bot priority and precedence constraint between route legs describing, at least in part, the respective bot route of a common autonomous guided bot performing the at least one task, or goal.

17. The method of claim 16, wherein the multi-agent path finding algorithm resolver resolves that the bot route is conflict free via a heuristic determination that each bot route leg, describing the bot route, is conflict free.

18. The method of claim 17, wherein the multi-agent path finding algorithm resolver effects the heuristic determination through application of priority conditions and precedence constraints between conflicting autonomous guided bots.

19. The method of claim 18, wherein the precedence constraints describe precedence between sequential successive tasks, or goals, in the series of tasks, or goals, of the at least one autonomous guided bot with respect to at least another sequential successive task, or goal, in the series of tasks, or goals, of another autonomous guided bot conflicting with the at least one autonomous guided bot.

20. The method of claim 17, wherein the heuristic determination resolves a dead-end conflict between the at least one autonomous guided bot, that has a terminus or goal of the bot route later than another autonomous guided bot, and at least one route leg of the another autonomous guided bot.

21. The method of claim 20, wherein the at least one autonomous guided bot that has the terminus or goal of the bot route later than the another autonomous guided bot, forms a dead-end in an aisle or driveway of the storage array, and the resolved bot route of the complete solution for the at least one autonomous guided bot is dead-end free.

22. The method of claim 17, wherein the heuristic determination resolves an autonomous guided bot idling conflict between the at least autonomous guided one bot idling, in a pose intervening between the at least one task, or goal, and an immediately sequential task, or goal, in the series of tasks, or goals, and at least one route leg of another autonomous guided bot.

23. The method of claim 17, wherein the heuristic determination resolves an autonomous guided bot idling conflict between the at least one autonomous guided bot idling, in a pose intervening between the at least one conflict free leg of the bot route and an immediately succeeding leg of the bot route, and at least one route leg of another autonomous guided bot.

24. The method of claim 17, wherein the heuristic determination seeks the earliest conflict between conflicting route legs of the at least one autonomous guided bot with another autonomous guided bot.

25. The method of claim 16, wherein the multi-agent path finding algorithm resolver resolves the conflict free bot route and identifies a solution that is a complete solution with determination that each bot route leg describing the bot route in entirety is conflict free.

26. The method of claim 25, wherein the multi-agent path finding algorithm resolver resolves the conflict free bot route and identifies a solution that is a partial solution with determination that at least one bot route leg, describing the bot route at least in part, is conflict free, and that each route leg of the at least one conflict free route leg, describing the at least part of the bot route, is in sequentially successive order from an initial location, and each preceding route leg has precedence over the sequentially successive route leg.

27. The method of claim 26, further comprising, with the controller, commanding the at least one autonomous guided bot to proceed along the resolved conflict free bot route based on one or more of the complete solution and the partial solution.

28. The method of claim 27, wherein, based on the controller command, the at least one autonomous guided bot proceeds along the at least one conflict free route leg of the partial solution, and the multi-agent path finding algorithm resolver continues the heuristic determination to complete the solution via best nodes of the heuristic.

29. The method of claim 16, wherein the type of conflict is a traverse bot conflict, an idle bot conflict, and a dead-end bot conflict.

30. The method of claim 16, wherein the at least one task, or goal, is located in an aisle or driveway of the storage array.
